(19) United States
(12) Patent Application Publication
(10) Pub. No.: US 2026/0235729 A1
(43) Pub. Date: Aug. 13, 2026

(54) ADAPTER INTERPOSED BETWEEN LIDAR DEVICE AND OPTICAL WINDOW AND LIDAR DEVICE INCLUDING SAME

(71) Applicant: SOS LAB Co., Ltd., Gwangju (KR)

(72) Inventors: Gyeonghwan SHIN, Gwangju (KR); Bumsik WON, Anyang-si Gyeonggi-do (KR)

(73) Assignee: SOS LAB Co., Ltd., Gwangju (KR)

(21) Appl. No.: 19/548,047

(22) Filed: Feb. 24, 2026

Related U.S. Application Data
(63) Continuation of application No. PCT/KR2024/012595, filed on Aug. 23, 2024.

(30) Foreign Application Priority Data
Aug. 24, 2023 (KR) 10-2023-0111375

(51) Int. Cl. G01S 7/481; G01S 7/4865; G01S 17/931

(52) U.S. Cl. CPC G01S 7/4813; G01S 7/4815; G01S 7/4817; G01S 7/4865; G01S 17/931

(57) ABSTRACT

A lidar device according to the present invention may comprise: a laser light-emitting element array including a plurality of laser light-emitting elements; a transmission optic assembly for steering laser output from the plurality of laser light-emitting elements; a detecting element array including a plurality of detecting elements; a reception optic assembly; and an adapter including a first optical path and a second optical path.

### CROSS-REFERENCE TO RELATED APPLICATIONS

This application is a continuation of International Application No. PCT/KR2024/012595 filed on Aug. 23, 2024, which claims priority to Korean Patent Application No. 10-2023-0111375 for Aug. 24, 2023, the entire contents of which are herein incorporated by reference.

### TECHNICAL FIELD

The present disclosure relates to an adapter interposed between a LiDAR device and an optical window, and a LiDAR device including the adapter and, more particularly, to an adapter and an adapter for solving problems that occur when a LiDAR is positioned in a space having an optical window on one side and a LiDAR device including the adapter.

### BACKGROUND ART

Recently, Light Detection and Ranging (LiDAR) has been attracting attention with growing interest in autonomous vehicles and unmanned vehicles. LiDAR is a device that acquires distance information about the surroundings using a laser, and is being applied not only to vehicles but also to various fields such as drones and aircraft due to its advantages of high precision, high resolution, and the capability to perceive objects in three dimensions.

Meanwhile, a solid-state LiDAR device is a device that can obtain distance information of the three-dimensional surrounding space without any mechanically moving components, and a laser output array can be used to implement the solid-state LiDAR device.

However, when a LiDAR device is used in actual industrial fields, the LiDAR device is often positioned in a space having an optical window that transmits light on one side for reasons of exterior design of a moving object or a facility, or is positioned in a space having an optical window that transmits light on one side for reasons such as protection of the LiDAR device.

In this case, due to lasers reflected from the optical window, an obstacle may occur in determining a distance value for a target located at a short distance, and a solution for resolving this is required.

### SUMMARY

### Technical Problem

An objective of the present disclosure is to provide a LiDAR device including an adapter to prevent interference in determining a distance value for a target located at a short distance due to lasers reflected from an optical window.

Another objective of the present disclosure is to provide an adapter interposed between a LiDAR device and an optical window to prevent interference in determining a distance value for a target located at a short distance due to lasers reflected from the optical window.

Objectives of the present disclosure are not limited to those described above and objectives not stated above will be clearly understood to those skilled in the art from the specification and the accompanying drawings.

### Technical Solution

According to an embodiment of the present invention, A LiDAR device, comprising: a laser emitting element array comprising a plurality of laser emitting elements; a transmission optical assembly configured to steer laser output from the plurality of laser emitting elements; a detecting element array comprising a plurality of detecting elements; a reception optical assembly, wherein the reception optical assembly is configured to focus light incident on the reception optical assembly onto the detecting element array, wherein the reception optical assembly is positioned to be spaced apart from the transmission optical assembly in a first-axis direction, and wherein a minimum distance between the reception optical assembly and the transmission optical assembly in the first-axis direction is a first distance; and an adapter comprising a first optical pathway and a second optical pathway, wherein a first aperture and a second aperture separated from the first aperture are positioned on a bottom side of the adapter, wherein a third aperture and a fourth aperture separated from the third aperture are positioned on a top side of the adapter, wherein the first optical pathway is a pathway from the first aperture to the third aperture, wherein the second optical pathway is a pathway from the second aperture to the fourth aperture, wherein the first optical pathway is surrounded by at least one sidewall such that the first optical pathway is separated from the second optical pathway, and wherein the second optical pathway is surrounded by at least one sidewall such that the second optical pathway is separated from the first optical pathway; wherein the transmission optical assembly is inserted into the first aperture such that the transmission optical assembly is mounted to the adapter, wherein the transmission optical assembly is inserted into the first aperture such that an optical axis of the transmission optical assembly passes through a center of the first aperture, wherein the reception optical assembly is inserted into the second aperture such that the reception optical assembly is mounted to the adapter, wherein the reception optical assembly is inserted into the second aperture such that an optical axis of the reception optical assembly passes through a center of the second aperture, a length of the third aperture in the first-axis direction and a length of the first aperture in the first-axis direction satisfy Relationship 1, and a length of the fourth aperture in the first-axis direction and a length of the second aperture in the first-axis direction satisfy Relationship 2, [Relationship 1] the length of the first aperture in the first-axis direction<the length of the third aperture in the first-axis direction≤(the length of the first aperture in the first-axis direction+the first distance), [Relationship 2] the length of the second aperture in the first-axis direction<the length of the fourth aperture in the first-axis direction≤(the length of the second aperture in the first-axis direction+the first distance).

According to another embodiment of the present invention, A LiDAR device, comprising: a laser emitting element array comprising a plurality of laser emitting elements; a transmission optical assembly configured to steer laser output from the plurality of laser emitting elements; a detecting element array comprising a plurality of detecting elements; a reception optical assembly, wherein the reception optical assembly is configured to focus light incident on the reception optical assembly onto the detecting element array, wherein the reception optical assembly is positioned to be spaced apart from the transmission optical assembly in a first-axis direction, and wherein a minimum distance between the reception optical assembly and the transmission optical assembly in the first-axis direction is a first distance—; and an adapter comprising a first optical pathway and a second optical pathway, wherein a first aperture and a second aperture separated from the first aperture are positioned on a bottom side of the adapter, wherein a third aperture and a fourth aperture separated from the third aperture are positioned on a top side of the adapter, wherein the first optical pathway is a pathway from the first aperture to the third aperture, wherein the second optical pathway is a pathway from the second aperture to the fourth aperture, wherein the first optical pathway is surrounded by at least one sidewall such that the first optical pathway is separated from the second optical pathway, and wherein the second optical pathway is surrounded by at least one sidewall such that the second optical pathway is separated from the first optical pathway; wherein the transmission optical assembly is inserted into the first aperture such that the transmission optical assembly is mounted to the adapter, wherein the reception optical assembly is inserted into the second aperture such that the reception optical assembly is mounted to the adapter, wherein, when a length of the third aperture in the first-axis direction is greater than a sum of a length of the first aperture in the first-axis direction and the first distance, a distance between an optical axis of the transmission optical assembly and a center of the third aperture is greater than a distance between the optical axis of the transmission optical assembly and a center of the first aperture, and wherein, when a length of the fourth aperture in the first-axis direction is greater than a sum of a length of the second aperture in the first-axis direction and the first distance, a distance between an optical axis of the reception optical assembly and a center of the fourth aperture is greater than a distance between the optical axis of the reception optical assembly and a center of the second aperture.

According to another embodiment of the present invention, An adapter disposed between a LiDAR device located in a space having an optical window on one side and the optical window, the adapter comprising: a bottom side on which a first aperture and a second aperture separated from the first aperture are positioned; a top side on which a third aperture and a fourth aperture separated from the third aperture are positioned; a first optical pathway that is a pathway from the first aperture to the third aperture; and a second optical pathway that is a pathway from the second aperture to the fourth aperture; wherein the first optical pathway is surrounded by at least one sidewall such that the first optical pathway is separated from the second optical pathway, wherein the second optical pathway is surrounded by at least one sidewall such that the second optical pathway is separated from the first optical pathway, wherein the second aperture is spaced apart from the first aperture in a first-axis direction, wherein a minimum distance between the first aperture and the second aperture in the first-axis direction is a first distance, and wherein, when a first virtual line passing through a center of the first aperture and a center of the third aperture is parallel to a second virtual line passing through a center of the second aperture and a center of the fourth aperture, a length of the third aperture in the first-axis direction and a length of the first aperture in the first-axis direction satisfy Relationship 1, and a length of the fourth aperture in the first-axis direction and a length of the second aperture in the first-axis direction satisfy Relationship 2. [Relationship 1] the length of the first aperture in the first-axis direction<the length of the third aperture in the first-axis direction≤(the length of the first aperture in the first-axis direction+the first distance), [Relationship 2] the length of the second aperture in the first-axis direction<the length of the fourth aperture in the first-axis direction≤(the length of the second aperture in the first-axis direction+the first distance).

According to another embodiment of the present invention, An adapter disposed between a LiDAR device located in a space having an optical window on one side and the optical window, the adapter comprising: a bottom side on which a first aperture and a second aperture separated from the first aperture are positioned; a top side on which a third aperture and a fourth aperture separated from the third aperture are positioned; a first optical pathway that is a pathway from the first aperture to the third aperture; and a second optical pathway that is a pathway from the second aperture to the fourth aperture; wherein the first optical pathway is surrounded by at least one sidewall such that the first optical pathway is separated from the second optical pathway, wherein the second optical pathway is surrounded by at least one sidewall such that the second optical pathway is separated from the first optical pathway, wherein the second aperture is spaced apart from the first aperture in a first-axis direction, wherein a minimum distance between the first aperture and the second aperture in the first-axis direction is a first distance, and wherein, when a length of the third aperture in the first-axis direction is greater than a sum of a length of the first aperture in the first-axis direction and the first distance and a length of the fourth aperture in the first-axis direction is greater than a sum of a length of the second aperture in the first-axis direction and the first distance, a distance between a center of the third aperture and a center of the fourth aperture is greater than a distance between a center of the first aperture and a center of the second aperture.

Objectives of the present disclosure are not limited to those described above and objectives not stated above will be clearly understood to those skilled in the art from the specification and the accompanying drawings.

### Advantageous Effects

According to an embodiment of the present disclosure, a LiDAR device including an adapter to prevent interference in determining a distance value for a target located at a short distance due to lasers reflected from an optical window may be provided.

According to an embodiment of the present disclosure, a LiDAR device including an adapter to prevent interference in determining a distance value for a target located at a short distance due to lasers reflected from an optical window may be provided.

According to an embodiment of the present disclosure, an adapter interposed between a LiDAR device and an optical window to prevent interference in determining a distance value for a target located at a short distance due to lasers reflected from the optical window may be provided.

According to an embodiment of the present disclosure, an adapter interposed between a LiDAR device and an optical window to prevent interference in determining a distance value for a target located at a short distance due to lasers reflected from the optical window may be provided.

Effects of the present disclosure are not limited to those described above and effects not stated above will be clearly understood to those skilled in the art from the specification and the accompanying drawings.

### DETAILED DESCRIPTION OF DRAWINGS

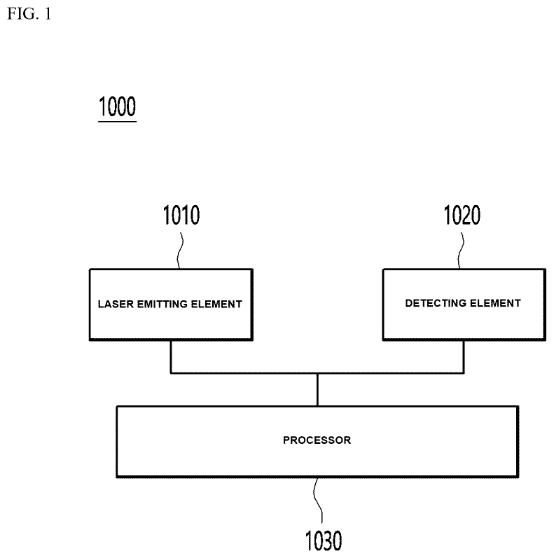

FIG. 1 is a diagram illustrating a LiDAR device disclosed by the present disclosure.

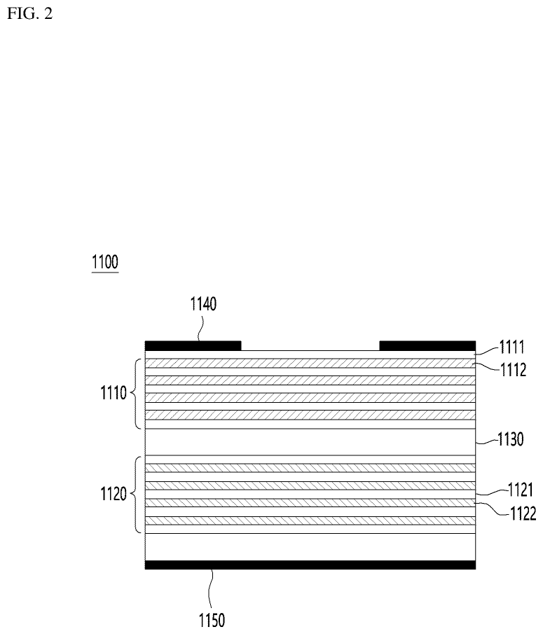

FIG. 2 is a diagram illustrating a VCSEL disclosed by the present disclosure.

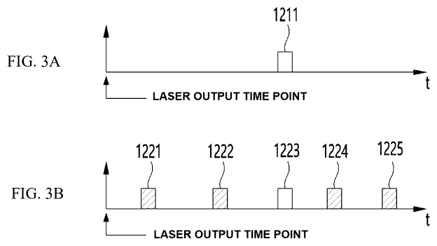

FIGS. 3A and 3B are diagrams illustrating limitations of a SPAD.

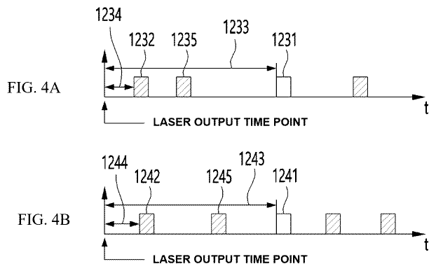

FIGS. 4A and 4B are diagrams illustrating an approach for determining a time-of-flight of a laser using an electrical signal output from a SPAD.

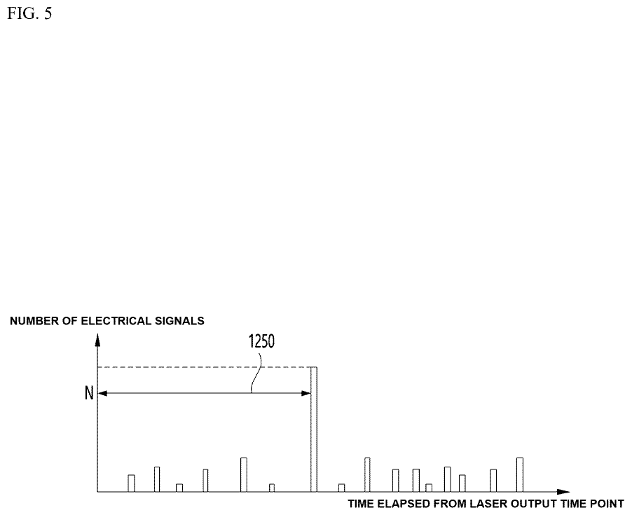

FIG. 5 is a diagram illustrating the number of electrical signals output after the same time has elapsed from each laser output time point when lasers are output multiple times from a LiDAR device.

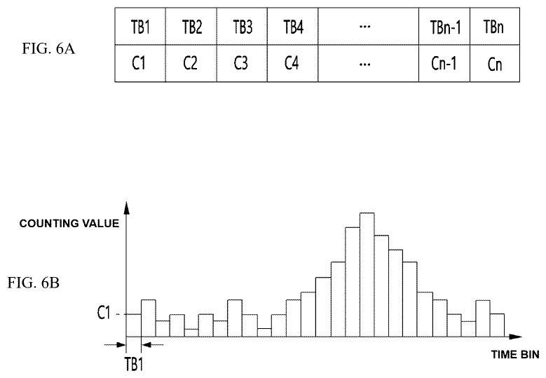

FIGS. 6A and 6B are diagrams illustrating a histogram disclosed in the present disclosure.

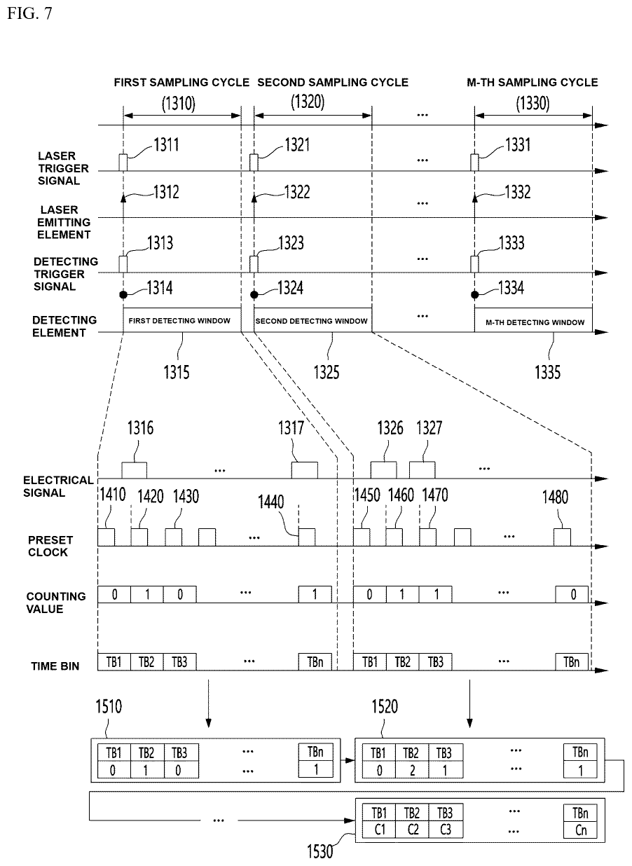

FIG. 7 is a diagram illustrating generation of a histogram in a LiDAR device disclosed in the present disclosure.

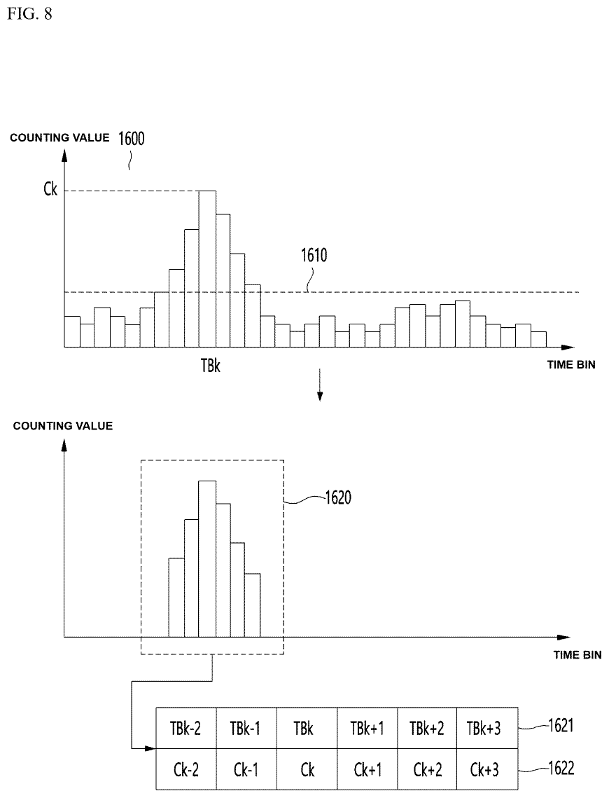

FIG. 8 is a diagram illustrating determination of an echo signal on the basis of a histogram in a LiDAR device.

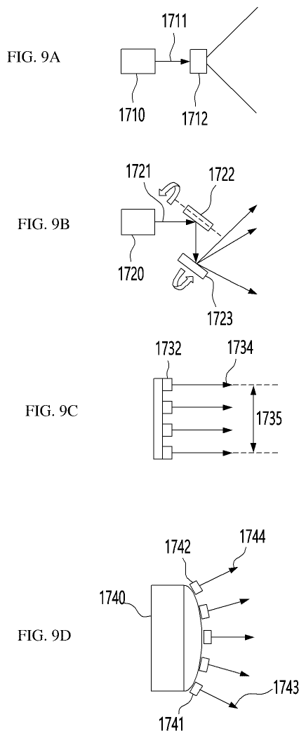

FIGS. 9A, 9B, 9C, and 9D are diagrams illustrating various examples for expanding a region within which a laser output from a LiDAR device is emitted.

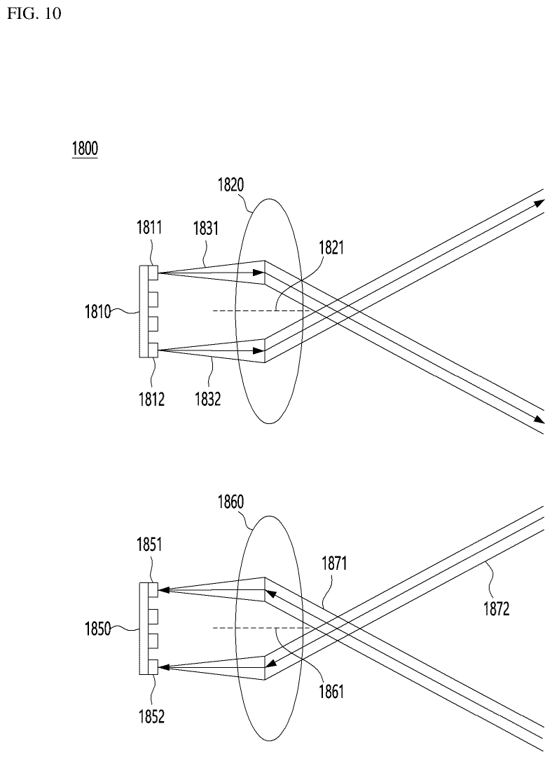

FIG. 10 is a diagram illustrating a LiDAR device disclosed by the present disclosure.

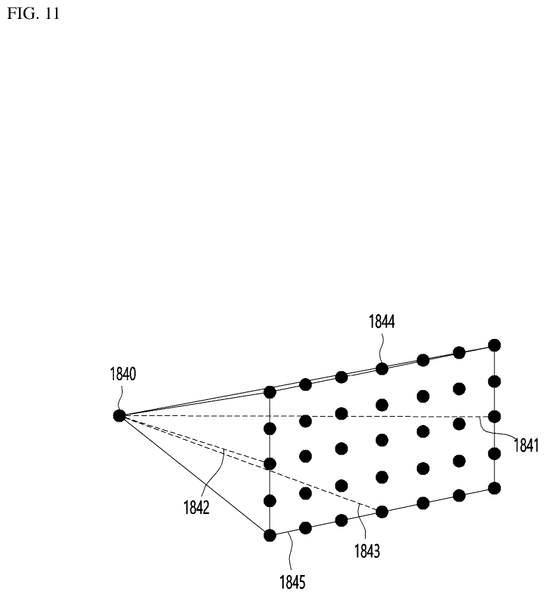

FIG. 11 is a diagram illustrating a laser emission region of a LiDAR device.

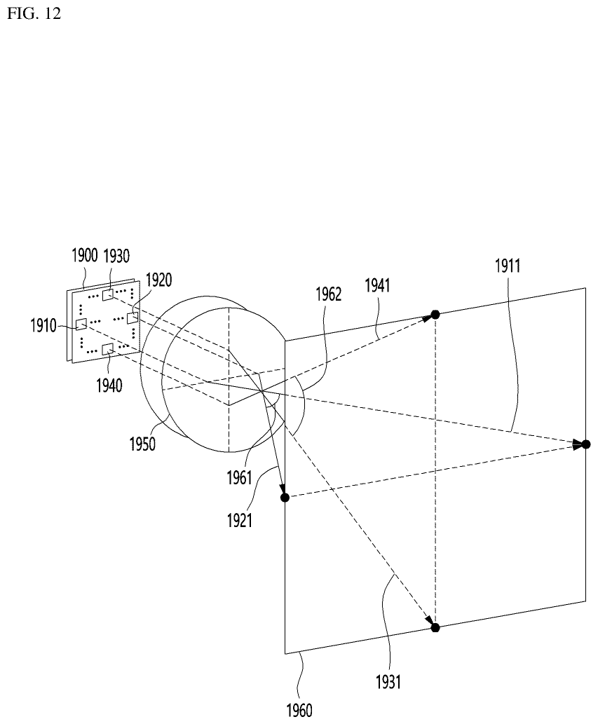

FIG. 12 is a diagram illustrating horizontal and vertical fields of view of a laser emission region of a solid-state LiDAR device.

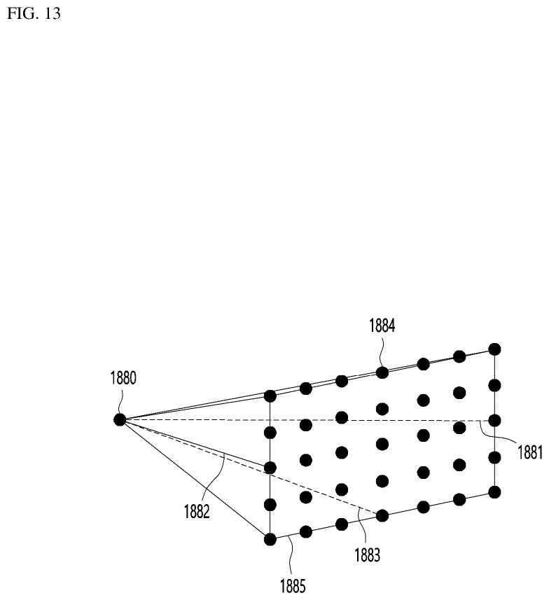

FIG. 13 is a diagram illustrating a light detection region of a LiDAR device.

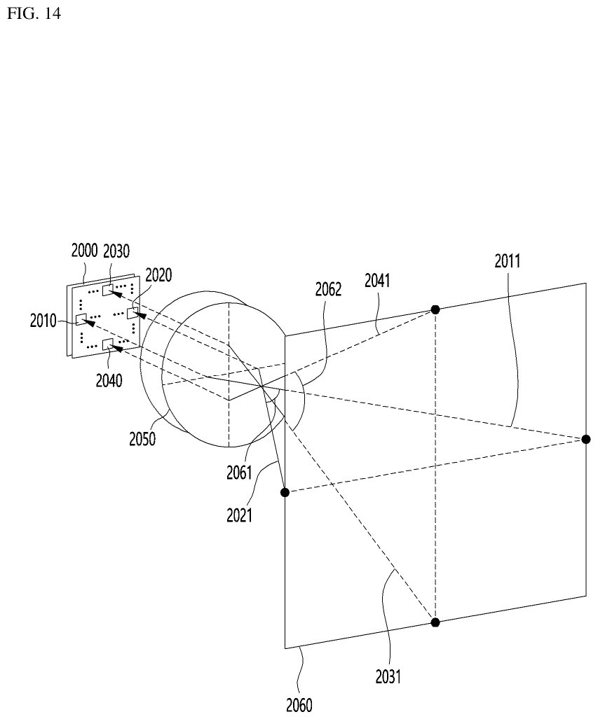

FIG. 14 is a diagram illustrating horizontal and vertical fields of view of a light detection region of a solid-state LiDAR device.

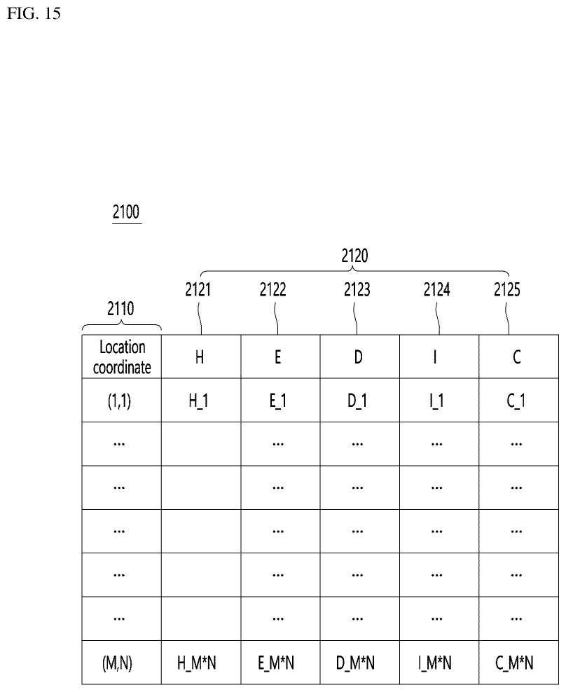

FIG. 15 is a diagram illustrating LiDAR data disclosed by the present disclosure.

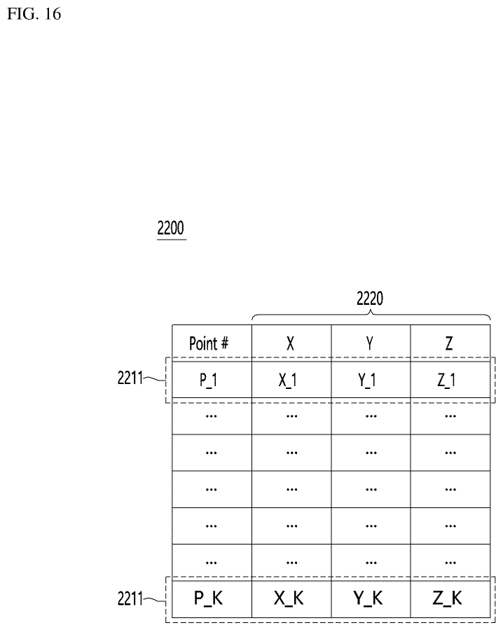

FIG. 16 is a diagram illustrating a point cloud disclosed by the present disclosure.

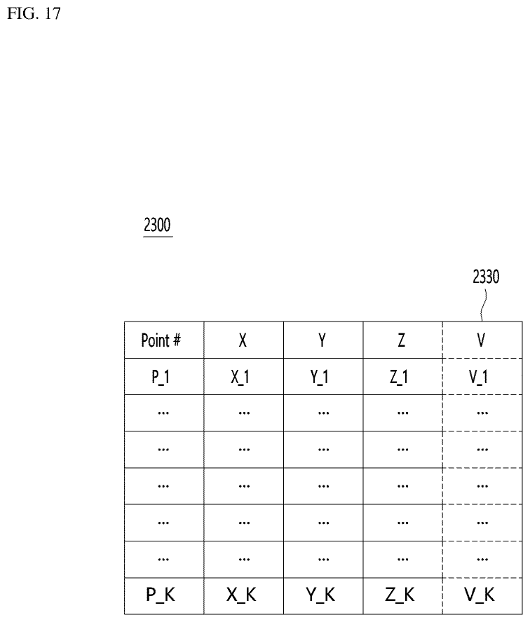

FIG. 17 is a diagram illustrating an enhanced point cloud disclosed by the present disclosure.

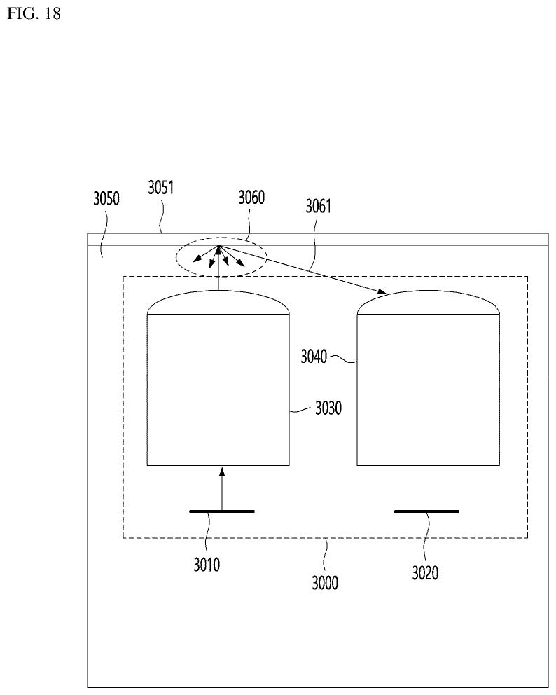

FIG. 18 is a diagram illustrating a problem that occurs when a LiDAR device is located in a space having an optical window on one side.

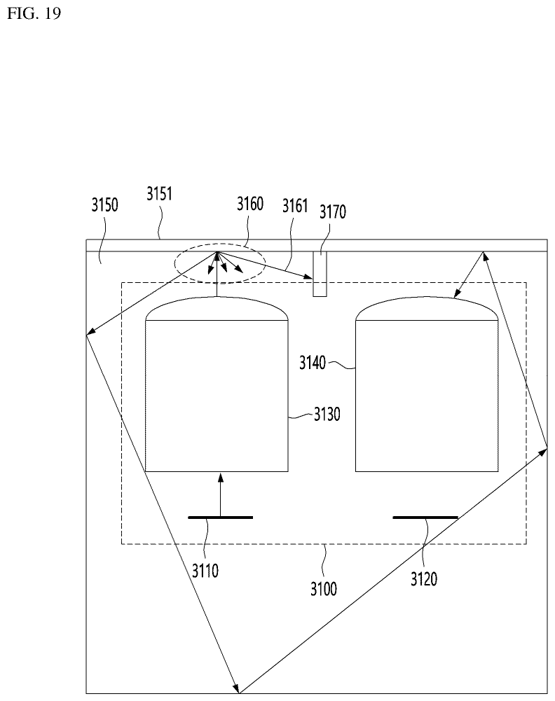

FIG. 19 is a diagram illustrating a scenario in which a blocking element is further provided between a transmission optical assembly and a reception optical assembly when a LiDAR device is located in a space having an optical window on one side.

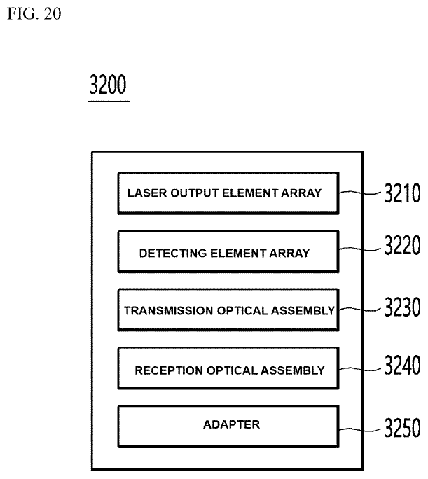

FIG. 20 is a block diagram illustrating a LiDAR device including an adapter according to an embodiment.

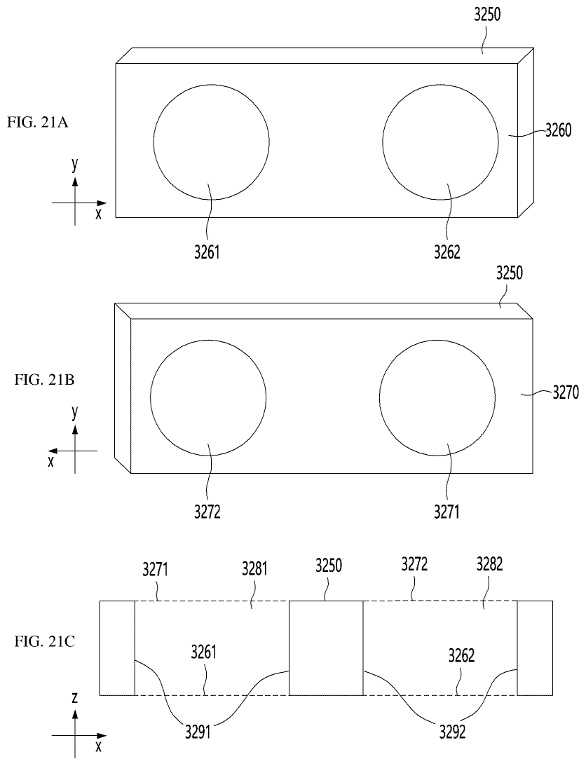

FIGS. 21A, 21B, and 21C are diagrams illustrating the structure of an adapter according to an embodiment.

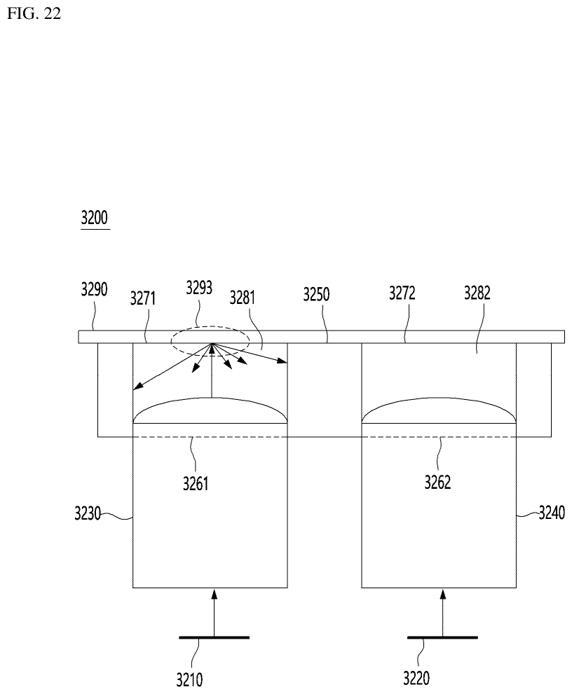

FIG. 22 is a diagram illustrating a LiDAR device including an adapter according to an embodiment.

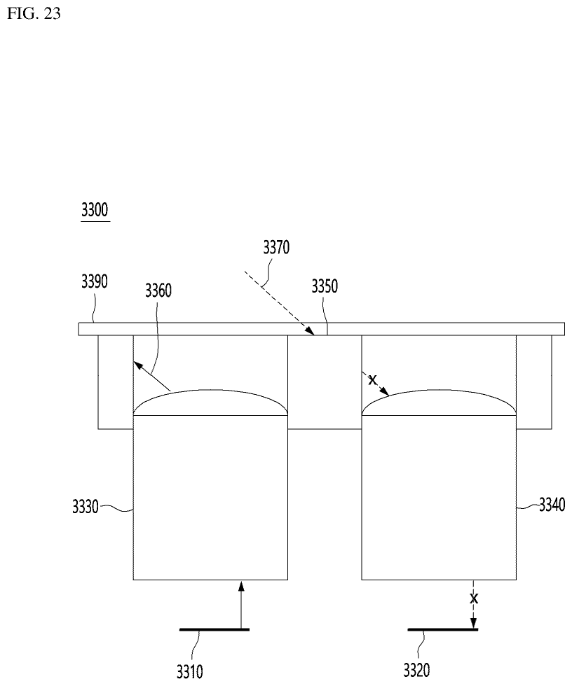

FIG. 23 is a diagram illustrating problems that may occur in a LiDAR device including an adapter according to an embodiment.

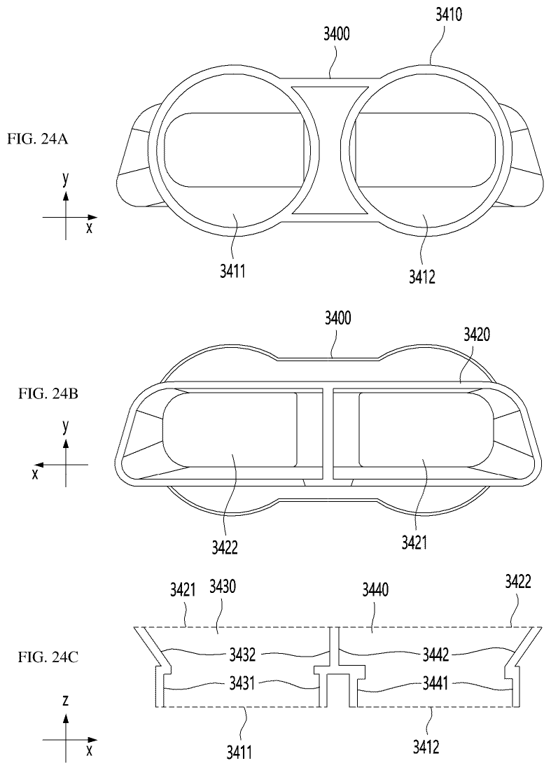

FIGS. 24A, 24B, 24C are diagrams illustrating the structure of an adapter according to an embodiment.

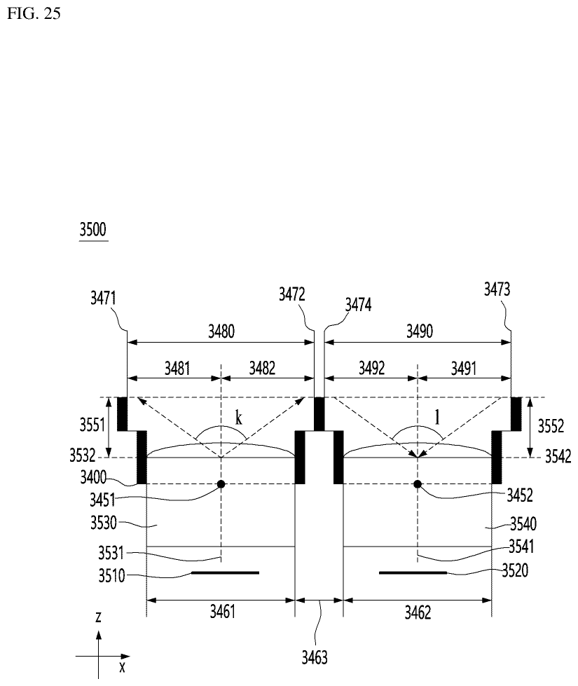

FIG. 25 is a diagram illustrating a LiDAR device including an adapter according to an embodiment.

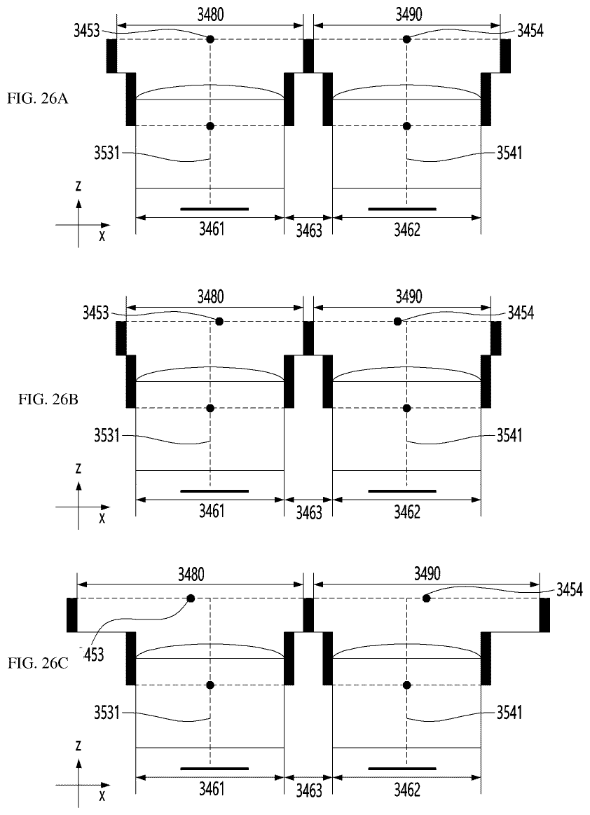

FIGS. 26A, 26B and 26C are diagrams illustrating preset relationships between the size of an aperture positioned on the top side of an adapter and the size of an aperture positioned on the bottom side of the adapter according to various embodiments.

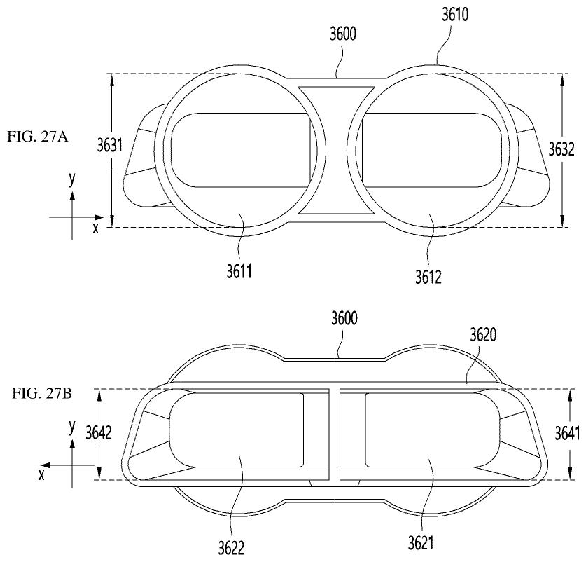

FIGS. 27A and 27B are diagrams illustrating various preset relationships between the sizes in a third-axis (y-axis) direction of apertures positioned on the top side of an adapter and the sizes in the third-axis (y-axis) direction of apertures positioned on the bottom side of the adapter according to an embodiment.

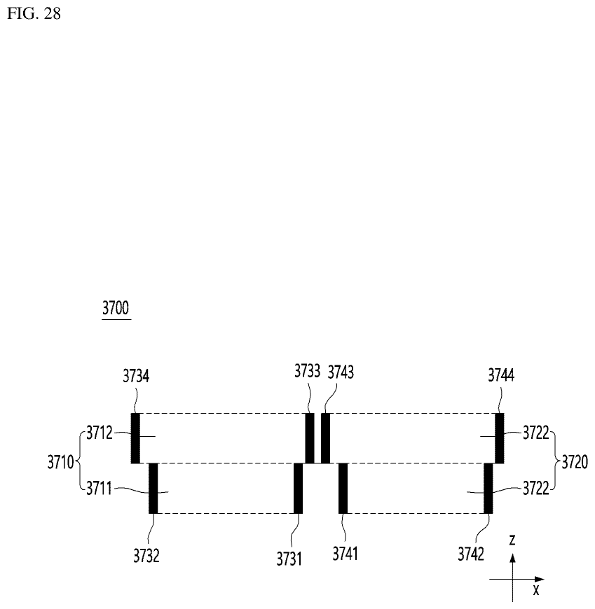

FIG. 28 is a diagram illustrating each sidewall of an adapter that is needed to describe various designs of sidewalls of the adapter.

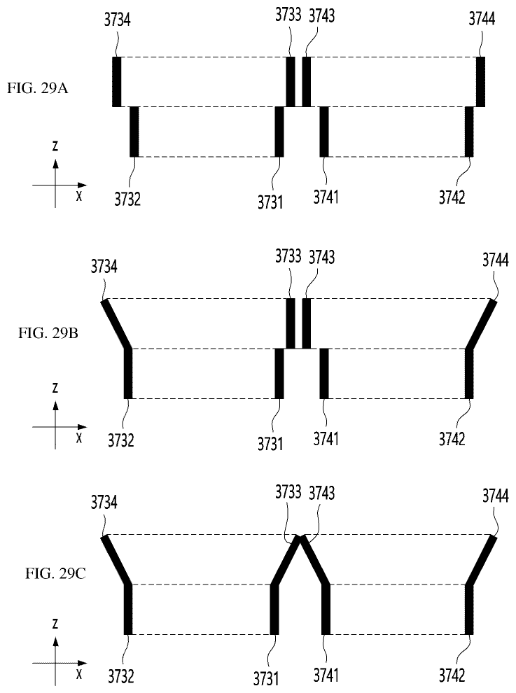

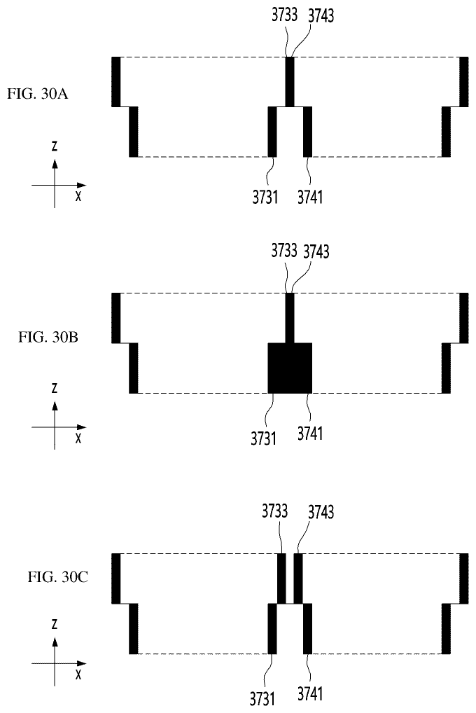

FIGS. 29A, 29B, 29C, 30A, 30B and 30C are diagrams illustrating various designs of sidewalls of an adapter according to an embodiment.

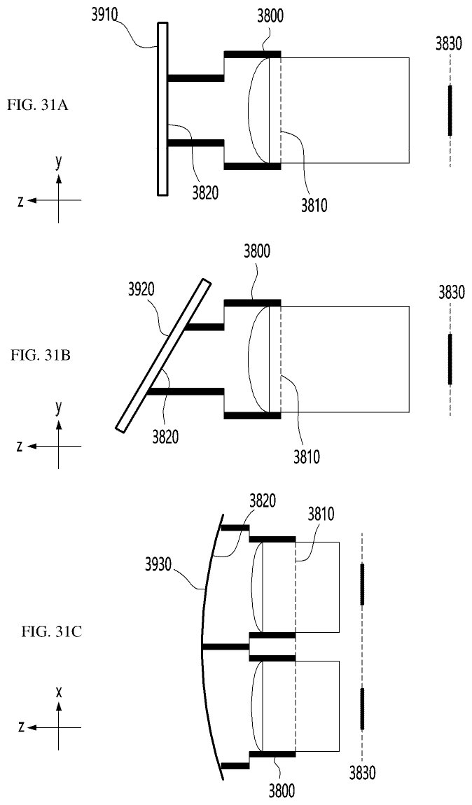

FIGS. 31A, 31B, and 31C are diagrams illustrating exemplary shapes of the top side of an adapter of a LiDAR device including the adapter according to an embodiment.

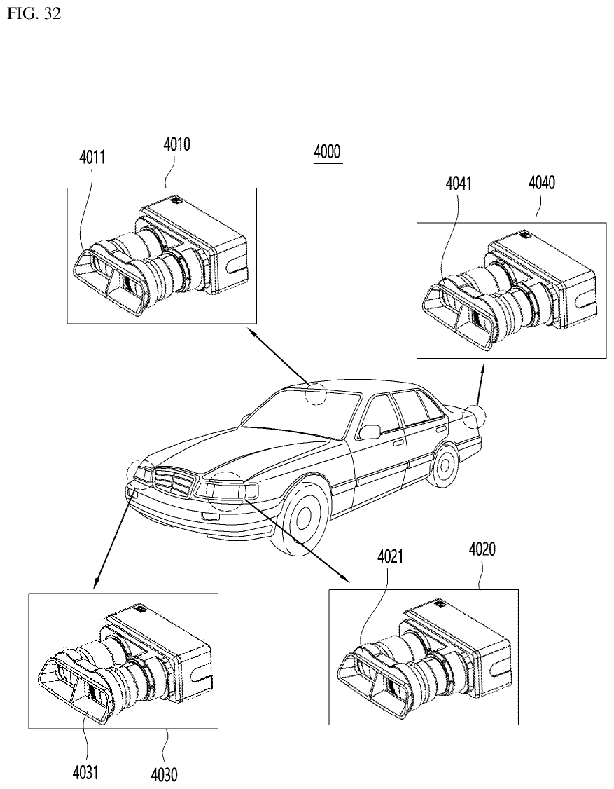

FIG. 32 is a diagram illustrating a LiDAR system according to an embodiment.

### DETAILED DESCRIPTION

Embodiments described herein are provided to clearly explain the spirit of the present disclosure to those skilled in the art, so the present disclosure is not limited to the embodiments described herein and the scope of the present disclosure should be construed as including changed or modified examples not departing from the spirit of the present disclosure.

Terminologies used herein were selected from general terminologies that are used at present as generally as possible in consideration of their functions herein, but may be changed, depending on the intention of those skilled in the art, precedents, advent of new technologies, or the like. However, when such specific terminologies are defined and used as certain meanings, the meanings of the terminologies will be specifically described. Therefore, the terminologies used herein should be construed on the basis of the substantial meanings of the terminologies and the entire specification, not simply the names of the terminologies.

The accompanying drawings of the present disclosure are provided for easy description of the present disclosure and the shapes illustrated in the drawings may be exaggerated to help understand the present disclosure, if necessary, so the present disclosure is not limited to the drawings of the present disclosure.

Elements or layers described in the specification that are referred to as being H onE another element or layer may include cases where there is an intermediate layer or element between them, not just immediately above the other element or layer.

Throughout the specification, the same reference numerals may generally refer to the same elements.

Numbers (e.g., first, second) used in the description of the present disclosure may be understood as identification symbols to discriminate one component from another component.

The suffixes “module” and “unit” used for components in the description of this specification are used or interchangeably mixed for ease of drafting the specification, and may not have distinct meanings or roles themselves.

When it is determined that detailed description of well-known configurations or functions related to the present disclosure may make the spirit of the present disclosure unclear, they are not described in detail, if necessary.

A LiDAR device, comprising: a laser emitting element array comprising a plurality of laser emitting elements; a transmission optical assembly configured to steer laser output from the plurality of laser emitting elements; a detecting element array comprising a plurality of detecting elements; a reception optical assembly, wherein the reception optical assembly is configured to focus light incident on the reception optical assembly onto the detecting element array, wherein the reception optical assembly is positioned to be spaced apart from the transmission optical assembly in a first-axis direction, and wherein a minimum distance between the reception optical assembly and the transmission optical assembly in the first-axis direction is a first distance; and an adapter comprising a first optical pathway and a second optical pathway, wherein a first aperture and a second aperture separated from the first aperture are positioned on a bottom side of the adapter, wherein a third aperture and a fourth aperture separated from the third aperture are positioned on a top side of the adapter, wherein the first optical pathway is a pathway from the first aperture to the third aperture, wherein the second optical pathway is a pathway from the second aperture to the fourth aperture, wherein the first optical pathway is surrounded by at least one sidewall such that the first optical pathway is separated from the second optical pathway, and wherein the second optical pathway is surrounded by at least one sidewall such that the second optical pathway is separated from the first optical pathway; wherein the transmission optical assembly is inserted into the first aperture such that the transmission optical assembly is mounted to the adapter, wherein the transmission optical assembly is inserted into the first aperture such that an optical axis of the transmission optical assembly passes through a center of the first aperture, wherein the reception optical assembly is inserted into the second aperture such that the reception optical assembly is mounted to the adapter, wherein the reception optical assembly is inserted into the second aperture such that an optical axis of the reception optical assembly passes through a center of the second aperture, a length of the third aperture in the first-axis direction and a length of the first aperture in the first-axis direction satisfy Relationship 1, and a length of the fourth aperture in the first-axis direction and a length of the second aperture in the first-axis direction satisfy Relationship 2, [Relationship 1] the length of the first aperture in the first-axis direction<the length of the third aperture in the first-axis direction≤(the length of the first aperture in the first-axis direction+the first distance), [Relationship 2] the length of the second aperture in the first-axis direction<the length of the fourth aperture in the first-axis direction≤(the length of the second aperture in the first-axis direction+the first distance).

wherein a direction from the bottom side of the adapter toward the top side of the adapter is defined as a second-axis direction, wherein, when a field of view of a laser irradiation region of the LiDAR device in the first-axis direction is k degrees, a length of the third aperture in the first-axis direction and a length from the bottom side of the adapter to the top side of the adapter in the second-axis direction satisfy Relationship 3, [Relationship 3](the length of the third aperture in the first-axis direction)/(2*(the length from the bottom side of the adapter to the top side of the adapter in the second-axis direction))>tan(k degrees/2).

wherein, when a field of view of a light detection region of the LiDAR device in the first-axis direction is 1 degrees, a length of the fourth aperture in the first-axis direction and a length from the bottom side of the adapter to the top side of the adapter in the second-axis direction satisfy Relationship 4, [Relationship 4](the length of the fourth aperture in the first-axis direction)/(2×(the length from the bottom side of the adapter to the top side of the adapter in the second-axis direction))>tan(1 degrees/2).

wherein the first optical pathway comprises a first hole surrounded by a first sidewall and a second hole surrounded by a second sidewall, and wherein the second optical pathway comprises a third hole surrounded by a third sidewall and a fourth hole surrounded by a fourth sidewall.

wherein the first hole is positioned closer to the bottom side of the adapter than the second hole, wherein the second hole is positioned closer to the top side of the adapter than the first hole, wherein the third hole is positioned closer to the bottom side of the adapter than the fourth hole, and wherein the fourth hole is positioned closer to the top side of the adapter than the third hole.

wherein the transmission optical assembly is inserted into the first hole, and wherein the reception optical assembly is inserted into the third hole.

wherein the second sidewall forms a first side surface adjacent to the fourth sidewall and a second side surface disposed to be opposite the first side surface, wherein the first side surface is parallel to an optical axis of the transmission optical assembly, and wherein the second side surface is not parallel to the optical axis of the transmission optical assembly.

wherein the first sidewall is physically separated from the third sidewall, and wherein the second sidewall is integrally formed with the fourth sidewall.

According to another embodiment of the present invention, A LiDAR device, comprising: a laser emitting element array comprising a plurality of laser emitting elements; a transmission optical assembly configured to steer laser output from the plurality of laser emitting elements; a detecting element array comprising a plurality of detecting elements; a reception optical assembly, wherein the reception optical assembly is configured to focus light incident on the reception optical assembly onto the detecting element array, wherein the reception optical assembly is positioned to be spaced apart from the transmission optical assembly in a first-axis direction, and wherein a minimum distance between the reception optical assembly and the transmission optical assembly in the first-axis direction is a first distance—; and an adapter comprising a first optical pathway and a second optical pathway, wherein a first aperture and a second aperture separated from the first aperture are positioned on a bottom side of the adapter, wherein a third aperture and a fourth aperture separated from the third aperture are positioned on a top side of the adapter, wherein the first optical pathway is a pathway from the first aperture to the third aperture, wherein the second optical pathway is a pathway from the second aperture to the fourth aperture, wherein the first optical pathway is surrounded by at least one sidewall such that the first optical pathway is separated from the second optical pathway, and wherein the second optical pathway is surrounded by at least one sidewall such that the second optical pathway is separated from the first optical pathway; wherein the transmission optical assembly is inserted into the first aperture such that the transmission optical assembly is mounted to the adapter, wherein the reception optical assembly is inserted into the second aperture such that the reception optical assembly is mounted to the adapter, wherein, when a length of the third aperture in the first-axis direction is greater than a sum of a length of the first aperture in the first-axis direction and the first distance, a distance between an optical axis of the transmission optical assembly and a center of the third aperture is greater than a distance between the optical axis of the transmission optical assembly and a center of the first aperture, and wherein, when a length of the fourth aperture in the first-axis direction is greater than a sum of a length of the second aperture in the first-axis direction and the first distance, a distance between an optical axis of the reception optical assembly and a center of the fourth aperture is greater than a distance between the optical axis of the reception optical assembly and a center of the second aperture.

wherein a direction from the bottom side of the adapter toward the top side of the adapter is defined as a second-axis direction, wherein, when a field of view of a laser irradiation region of the LiDAR device in the first-axis direction is k degrees, a length of the third aperture in the first-axis direction and a length from the bottom side of the adapter to the top side of the adapter in the second-axis direction satisfy Relationship 1, [Relationship 1](the length of the third aperture in the first-axis direction)/(2*(the length from the bottom side of the adapter to the top side of the adapter in the second-axis direction))>tan(k degrees/2).

wherein, when a field of view of a light detection region of the LiDAR device in the first-axis direction is 1 degrees, a length of the fourth aperture in the first-axis direction and a length from the bottom side of the adapter to the top side of the adapter in the second-axis direction satisfy Relationship 2, [Relationship 2](the length of the fourth aperture in the first-axis direction)/(2×(the length from the bottom side of the adapter to the top side of the adapter in the second-axis direction))>tan(1 degrees/2).

According to another embodiment of the present invention, An adapter disposed between a LiDAR device located in a space having an optical window on one side and the optical window, the adapter comprising: a bottom side on which a first aperture and a second aperture separated from the first aperture are positioned; a top side on which a third aperture and a fourth aperture separated from the third aperture are positioned; a first optical pathway that is a pathway from the first aperture to the third aperture; and a second optical pathway that is a pathway from the second aperture to the fourth aperture; wherein the first optical pathway is surrounded by at least one sidewall such that the first optical pathway is separated from the second optical pathway, wherein the second optical pathway is surrounded by at least one sidewall such that the second optical pathway is separated from the first optical pathway, wherein the second aperture is spaced apart from the first aperture in a first-axis direction, wherein a minimum distance between the first aperture and the second aperture in the first-axis direction is a first distance, and wherein, when a first virtual line passing through a center of the first aperture and a center of the third aperture is parallel to a second virtual line passing through a center of the second aperture and a center of the fourth aperture, a length of the third aperture in the first-axis direction and a length of the first aperture in the first-axis direction satisfy Relationship 1, and a length of the fourth aperture in the first-axis direction and a length of the second aperture in the first-axis direction satisfy Relationship 2. [Relationship 1] the length of the first aperture in the first-axis direction<the length of the third aperture in the first-axis direction≤(the length of the first aperture in the first-axis direction+the first distance) [Relationship 2] the length of the second aperture in the first-axis direction<the length of the fourth aperture in the first-axis direction≤(the length of the second aperture in the first-axis direction+the first distance).

wherein a shape of the top side of the adapter corresponds to a shape of the optical window.

wherein, when the optical window comprises a curvature, a curvature of the top side of the adapter is corresponds to the curvature of the optical window.

According to another embodiment of the present invention, An adapter disposed between a LiDAR device located in a space having an optical window on one side and the optical window, the adapter comprising: a bottom side on which a first aperture and a second aperture separated from the first aperture are positioned; a top side on which a third aperture and a fourth aperture separated from the third aperture are positioned; a first optical pathway that is a pathway from the first aperture to the third aperture; and a second optical pathway that is a pathway from the second aperture to the fourth aperture; wherein the first optical pathway is surrounded by at least one sidewall such that the first optical pathway is separated from the second optical pathway, wherein the second optical pathway is surrounded by at least one sidewall such that the second optical pathway is separated from the first optical pathway, wherein the second aperture is spaced apart from the first aperture in a first-axis direction, wherein a minimum distance between the first aperture and the second aperture in the first-axis direction is a first distance, and wherein, when a length of the third aperture in the first-axis direction is greater than a sum of a length of the first aperture in the first-axis direction and the first distance and a length of the fourth aperture in the first-axis direction is greater than a sum of a length of the second aperture in the first-axis direction and the first distance, a distance between a center of the third aperture and a center of the fourth aperture is greater than a distance between a center of the first aperture and a center of the second aperture.

wherein a shape of the top side of the adapter corresponds to a shape of the optical window.

wherein, when the optical window comprises a curvature, a curvature of the top side of the adapter corresponds to the curvature of the optical window.

According to another embodiment of the present invention, A LiDAR device, comprising: a laser emitting element array comprising a plurality of laser emitting elements; a transmission optical assembly configured to steer laser output from the plurality of laser emitting elements; a detecting element array comprising a plurality of detecting elements; a reception optical assembly, wherein the reception optical assembly is configured to focus light incident on the reception optical assembly onto the detecting element array, wherein the reception optical assembly is positioned to be spaced apart from the transmission optical assembly in a first-axis direction, and wherein a minimum distance between the reception optical assembly and the transmission optical assembly in the first-axis direction is a first distance; and an adapter comprising a first optical pathway, wherein a first aperture is positioned on a bottom side of the adapter, wherein a second aperture is positioned on a top side of the adapter, wherein the first optical pathway is a pathway from the first aperture to the second aperture, and wherein the first optical pathway is defined by at least one sidewall surrounding the first optical pathway; wherein the reception optical assembly is inserted into the first aperture such that the reception optical assembly is mounted to the adapter, wherein the reception optical assembly is inserted into the first aperture such that an optical axis of the reception optical assembly passes through a center of the first aperture, and wherein a length of the second aperture in the first-axis direction and a length of the first aperture in the first-axis direction satisfy a Relationship. [Relationship] the length of the first aperture in the first-axis direction<the length of the second aperture in the first-axis direction≤(the length of the first aperture in the first-axis direction+the first distance).

### I. LiDAR Device

### [Overview of LiDAR Device]

The present disclosure relates to a solid-state LiDAR.

A Light Detection and Ranging (LiDAR) device is a device for measuring a distance between the LiDAR device and a target using a laser.

More specifically, a LiDAR device is a device for measuring a distance between the LiDAR device and a target by outputting a laser and detecting a laser reflected from the target.

In general, in order to measure a distance from a LiDAR device to a target, a time-of-flight (TOF) of a flight path in which a laser output from the LiDAR device makes a round trip between the LiDAR device and the target is used.

Therefore, a LiDAR device comprises a laser emitting element for outputting a laser and a detecting element for detecting a received laser, and comprises at least one processor for determining a time interval between a time point at which a laser is output and a time point at which the laser is detected.

Hereinafter, the components included in a LiDAR device are described in more detail.

FIG. 1 is a diagram illustrating a LiDAR device disclosed by the present disclosure.

Referring to FIG. 1, a LiDAR device 1000 disclosed by the present disclosure may comprise a laser emitting element 1010.

### [Laser Emitting Element]

### Function of Laser Emitting Element

The laser emitting element 1010 is configured to generate and output (emit) a laser.

In this case, a laser generated and output from the laser emitting element 1010, which is light having monochromaticity, may be light of a specific wavelength.

In this case, the laser emitting element 1010 is configured to output a pulse laser when the LiDAR device 1000 disclosed in the present disclosure determines a distance to a target in a Direct TOF (Time-of-Flight) method that determines a time-of-flight on the basis of a flight start time and a flight end time of a laser. In this case, a pulse laser refers to a laser that is emitted for a short time, and emission duration of the pulse laser may generally be designed to be about 1 to 20 ns, but is not limited thereto.

### Types of Laser Emitting Element

The type of the laser emitting element 1010 may vary.

For example, the laser emitting element 1010 may be an edge-emitting laser (EEL) or may be a vertical cavity surface emitting laser (VCSEL), but is not limited thereto, and may be various types of elements configured to generate and output a laser.

In general, in the technical field of a solid-state LiDAR device, a VCSEL is used as the laser emitting element 1010.

Therefore, hereinafter, a VCSEL is described in more detail

FIG. 2 is a diagram illustrating a VCSEL disclosed by the present disclosure.

### Stacked Structure of VCSEL

The VCSEL 1100 may include an upper reflective layer 1110, a lower reflective layer 1120, an active layer 1130 interposed between the upper reflective layer 1110 and the lower reflective layer 1120, an upper electrode 1140 that is in contact with the upper reflective layer 1110, and a lower electrode 1150 that is in electrical contact the lower reflective layer 1120.

### Structural Features of Upper Reflective Layer

The upper reflective layer 1110 may be a distributed Bragg reflector (DBR). That is, the upper reflective layer 1110 may be a reflective layer having a multilayer structure in which two materials having different refractive indices are alternately stacked.

For example, the upper reflective layer 1110 may be a reflective layer having a multilayer structure in which a first material layer 1111 having a first refractive index and a second material layer 1112 having a second refractive index are alternately stacked.

In this case, the fact that a multilayer structure in which two materials having different refractive indices are alternately stacked can function as a reflective layer for light in a specific wavelength band may be physically explained by Fresnel reflection and constructive and destructive interference of light, and the reflectivity of the multilayer structure increases as the number of alternating stacks of the two materials having different refractive indices increases.

Further, the upper reflective layer 1110 may be doped as a specific type.

For example, the upper reflective layer 1110 may be doped as a p-type or an n-type.

In this case, the fact that the upper reflective layer 1110 is doped as a specific type means that all of the plurality of layers included in the multilayer structure of the upper reflective layer 1110 are doped as the specific type.

For example, when the doping type of the upper reflective layer 1110 is p-type, both the first material layer 1111 and the second material layer 1112 included in the upper reflective layer 1110 are doped as a p-type, and when the doping type of the upper reflective layer 1110 is n-type, both the first material layer 1111 and the second material layer 1112 included in the upper reflective layer 1110 are doped as an n-type.

### Structural Features of Lower Reflective Layer

The lower reflective layer 1120 may be a distributed Bragg reflector (DBR). That is, the lower reflective layer 1120 may be a reflective layer having a multilayer structure in which two materials having different refractive indices are alternately stacked.

For example, the lower reflective layer 1120 may be a reflective layer having a multilayer structure in which a third material layer 1121 having a third refractive index and a fourth material layer 1122 having a fourth refractive index are alternately stacked.

Further, the lower reflective layer 1120 may be doped as a specific type.

For example, the lower reflective layer 1120 may be doped as a p-type or an n-type.

In this case, the fact that the lower reflective layer 1120 is doped as a specific type means that all of the plurality of layers included in the multilayer structure of the lower reflective layer 1120 are doped as the specific type.

For example, when the doping type of the lower reflective layer 1120 is p-type, both the third material layer 1121 and the fourth material layer 1122 included in the lower reflective layer 1120 are doped as a p-type, and when the doping type of the lower reflective layer 1120 is n-type, both the third material layer 1121 and the fourth material layer 1122 included in the lower reflective layer 1120 are doped as an n-type.

### Relationship Between Upper Reflective Layer and Lower Reflective Layer

The upper reflective layer 1110 and the lower reflective layer 1120 of the VCSEL 1100 are doped as different types.

For example, when the doping type of the upper reflective layer 1110 of the VCSEL 1100 is p-type, the doping type of the lower reflective layer 1120 of the VCSEL 1100 is n-type, and when the doping type of the upper reflective layer 1110 of the VCSEL 1100 is n-type, the doping type of the lower reflective layer 1120 of the VCSEL 1100 is p-type.

Further, the reflectivities of the upper reflective layer 1110 and the lower reflective layer 1120 of the VCSEL 1100 are different from each other.

For example, the reflectivity of the upper reflective layer 1110 of the VCSEL 1100 may be higher than the reflectivity of the lower reflective layer 1120, and the reflectivity of the upper reflective layer 1110 may be lower than the reflectivity of the lower reflective layer 1120.

### Operation Principle of VCSEL

When a predetermined voltage is applied between the upper electrode 1140 and the lower electrode 1150 of the VCSEL 1100, electrons and holes in the upper reflective layer 1110 and the lower reflective layer 1120 move and combine in the active layer 1130, and accordingly, light is generated in the active layer 1130.

For example, when the doping type of the upper reflective layer 1110 of the VCSEL 1100 is p-type and the doping type of the lower reflective layer 1120 is n-type, and when a predetermined voltage is applied between the upper electrode 1140 and the lower electrode 1150 and the voltage applied to the upper electrode 1140 is higher than the voltage applied to the lower electrode 1150, the holes in the upper reflective layer 1110 move to the active layer 1130 and the electrons in the lower reflective layer 1120 move to the active layer 1130, whereby light is generated in the active layer 1130 by recombination of the holes and electrons.

Further, for example, when the doping type of the upper reflective layer 1110 of the VCSEL 1100 is n-type and the doping type of the lower reflective layer 1120 is p-type, and when a predetermined voltage is applied between the upper electrode 1140 and the lower electrode 1150 and the voltage applied to the lower electrode 1150 is higher than the voltage applied to the upper electrode 1140, the electrons in the upper reflective layer 1110 move to the active layer 1130 and the holes in the lower reflective layer 1120 move to the active layer 1130, whereby light is generated in the active layer 1130 by recombination of the holes and the electrons.

Further, light generated in the VCSEL 1100 is output in the direction in which the reflective layer having a lower reflectivity among the upper reflective layer 1110 and the lower reflective layer 1120 is positioned.

For example, light generated in the active layer 1130 of the VCSEL 1100 is incident on the upper reflective layer 1110 or the lower reflective layer 1120, and is alternately reflected by the upper reflective layer 1110 and the lower reflective layer 1120, and is output through the reflective layer having a lower reflectivity among the upper reflective layer 1110 and the lower reflective layer 1120.

Referring again to FIG. 1, the LiDAR device 1000 disclosed in the present disclosure may comprise a detecting element 1020.

### [Detecting Element]

### Function of Detecting Element

The detecting element 1020 is configured to generate an electrical signal in response to received light when light is received.

In this case, the electrical signal output from the detecting element 1020 may be an analog signal having a value corresponding to the intensity of received light, and may be a digital signal corresponding to whether light is received.

### Types of Detecting Element

Further, the type of the detecting element 1020 may vary.

For example, the detecting element 1020 may be a photo detector (PD), an avalanche photo diode (APD), a single photon avalanche diode (SPAD), or a silicon photomultiplier (SiPM), but is not limited thereto, and may be various types of elements configured to output an electrical signal corresponding to received light.

In general, in the technical field of a solid-state LiDAR device, a SPAD is used as the detecting element 1020.

Therefore, hereinafter, a SPAD is described in more detail.

### Operation of SPAD Outputting Electrical Signal in Response to Received Light by SPAD

A SPAD is a semiconductor-based light detector, and is a device in which, by applying a reverse bias voltage greater than a breakdown voltage, an avalanche breakdown occurs and a current flows even when a small amount of photons are absorbed, and it is also referred to as a Geiger-mode APD.

In this case, because an avalanche breakdown occurs in a SPAD even when a small amount of photons are absorbed, it is necessary to suppress an excessive current. Therefore, a SPAD requires a quenching circuit that suppresses continuous flow of a current to suppress an excessive current.

A quenching circuit is configured to reduce the magnitude of a voltage that is applied to a SPAD instantaneously after an avalanche breakdown occurs in the SPAD.

In this case, when the magnitude of the voltage that is applied to the SPAD is reduced by a quenching circuit, the flow of a current of the SPAD is interrupted.

Thereafter, even if photons reach the SPAD before the magnitude of the voltage that is applied to the SPAD is restored, no current flows in the SPAD.

That is, a SPAD operates through an avalanche breakdown phase according to absorption of a small amount of photons in a state where a reverse bias voltage greater than a breakdown voltage is applied, a quenching phase, and a recharge phase, and a certain magnitude of current flows in the avalanche breakdown phase, and in the quenching phase and the recharge phase, no current flows even if photons are absorbed.

Therefore, even though light is received during the quenching phase and the recharge phase, an electrical signal is not output in response to the received light, and this is typically referred to as dead time.

Such dead time may range from about several hundred ps to several μs depending on the materials forming a SPAD or the configuration of a quenching circuit.

### Advantages and Limitations of SPAD

Since a current flows in a SPAD even through a small amount of photons are absorbed, a SPAD has an advantage that even through only a small amount of photons return to a LiDAR device as a laser output from the LiDAR device is reflected from a target located at a long distance, it is easy to detect the laser.

However, a SPAD has a limitation that when an avalanche breakdown occurs, it outputs an electrical signal having a predetermined magnitude regardless of the number of absorbed photons, so it is impossible to know the intension of received light.

FIG. 3 is a diagram illustrating limitations of a SPAD.

More specifically, FIG. 3A is a diagram illustrating, over time, an electrical signal that is output from a SPAD for a predetermined time from a laser output time point after a laser is output from a LiDAR device in an ideal situation in which no external light such as sunlight is present, and FIG. 3B is a diagram illustrating, over time, electrical signals that are output from a SPAD for a predetermined time from a laser output time point after a laser is output from a LiDAR device in a situation in which external light such as sunlight is present.

First, since FIG. 3A assumes an ideal situation in which no external light such as sunlight is present, in the situation of FIG. 3A, after a laser is output from a LiDAR device, no photon is received by a SPAD until the laser output from the LiDAR device is reflected from a target and received by the LiDAR device.

Therefore, the state in which a reverse bias voltage greater than a breakdown voltage is applied to the SPAD is maintained until the laser output from the LiDAR device is reflected from the target and received by the LiDAR device, and, in this state, when photons included in the laser output from the LiDAR device are received by the SPAD, an avalanche breakdown occurs in the SPAD and a first electrical signal 1211 is output from the SPAD.

In this case, the time interval between the laser output time point at which the laser is output from the LiDAR device and the time point at which the first electrical signal 1211 is output may correspond to the time-of-flight of the laser output from the LiDAR device between the LiDAR device and the target.

Therefore, in an ideal situation in which no external light such as sunlight is present, as in FIG. 3A, it is not difficult to measure a distance between a LiDAR device and a target by using a SPAD.

However, the limitation of a SPAD is revealed in a situation in which external light such as sunlight is present, as in FIG. 3B.

Since FIG. 3B assumes a situation in which external light such as sunlight is present, in the situation of FIG. 3B, after a laser is output from a LiDAR device, photons caused by external light such as sunlight may be received by a SPAD both before and after the laser output from the LiDAR device is reflected from a target and received by the LiDAR device.

More specifically, even before a laser output from the LiDAR device is reflected from a target and returns to the LiDAR device, photons caused by external light such as sunlight are received by the SPAD, and, accordingly, an avalanche breakdown occurs in the SPAD and a second electrical signal 1221 is output from the SPAD. Thereafter, due to a quenching circuit of the SPAD, the magnitude of the voltage that is applied to the SPAD is instantaneously reduced, the flow of a current of the SPAD is interrupted, and no electrical signal is output from the SPAD until the voltage that applied to the SPAD is restored through a recharge phase. After the voltage that is applied to the SPAD is restored through the recharge phase, photons caused by external light such as sunlight are received by the SPAD before the laser output from the LiDAR device is reflected from the target and returns to the LiDAR device, and, accordingly, a third electrical signal 1222 is output from the SPAD. Thereafter, after the voltage that is applied to the SPAD is restored through the quenching phase and recharge phase described above, as the laser output from the LiDAR device is reflected from the target and returns to the LiDAR device, at least one photon included in the laser output from the LiDAR device is received by the SPAD, and, accordingly, a fourth electrical signal 1223 is output from the SPAD. Thereafter, photons caused by external light such as sunlight may be further received by the SPAD, and, accordingly, a fifth electrical signal 1224 and a sixth electrical signal 1225 are generated.

In this case, even if the number of photons of the laser output from the LiDAR device, reflected from the target, and received by the SPAD is greater than the number of photons caused by external light such as sunlight and received by the SPAD, the magnitudes of electrical signals that are output from the SPAD are identical as described above, so the magnitudes of the second to sixth electrical signals 1221 to 1225 are identical to one another.

Therefore, in the LiDAR device, it is impossible to determine which electrical signal among the second to sixth electrical signals 1221 to 1225 is an electrical signal caused by photons of the laser that is output from the LiDAR device, reflected from the target, and received by the SPAD.

Therefore, even if the time interval between the laser output time point at which a laser is output from the LiDAR device and the time point at which the fourth electrical signal 1223 is output corresponds to the time-of-flight of the laser output from the LiDAR device between the LiDAR device and the target, it is impossible to determine that the fourth electrical signal 1223 is an electrical signal caused by the photons of the laser output from the LiDAR device, reflected from the target, and received by the SPAD. Therefore, it is difficult to measure a distance between a LiDAR device and a target using a SPAD.

In FIG. 3B, only five electrical signals are briefly illustrated, but, in practice, hundreds of electrical signals may be output for a predetermined period after a laser is output from a LiDAR device, so it can be seen that it is more difficult to measure a distance between a LiDAR device and a target using a SPAD.

Therefore, a more advanced method may be required to measure a distance between a LiDAR device and a target using a SPAD.

[Approach and Histogram for Determining Time-of-Fight of Laser Using Electrical Signals Output from SPAD]

### Description of Approach

FIG. 4 is a diagram illustrating an approach for determining a time-of-flight of a laser using an electrical signal output from a SPAD.

More specifically, FIG. 4A is a diagram illustrating, over time, electrical signals that are output from a SPAD for a predetermined time from a laser output time point after a laser is output from a LiDAR device in a situation in which a target is located at a first distance from the LiDAR device, and FIG. 4B is a diagram illustrating, over time, electrical signals that are output from the SPAD for a predetermined time from a laser output time point after a laser is output from the LiDAR device at a different time point from FIG. 4A in a situation in which a target is located at the first distance from the LiDAR device.

In this case, both FIGS. 4A and 4B assume a situation is which external light such as sunlight is present.

Referring first to FIG. 4A, a plurality of electrical signals including a first electrical signal 1231, a second electrical signal 1232, and a third electrical signal 1235 is output from a SPAD for a predetermined time from a laser output time point at which a laser is output from a LiDAR device.

In this case, since the above-described matters may be applied regarding the output of electrical signals from a SPAD, redundant descriptions are omitted.

Further, in this case, the first electrical signal 1231 is an electrical signal generated as a laser output from the LiDAR device is reflected from a target and received by the SPAD, and the second electrical signal 1232 and the third electrical signal 1235 are electrical signals generated as photons caused by external light such as sunlight are received by the SPAD.

Referring to FIG. 4B, a plurality of electrical signals including a fourth electrical signal 1241, a fifth electrical signal 1242, and a sixth electrical signal 1245 is output from a SPAD for a predetermined time from a laser output time point at which a laser is output from a LiDAR device.

In this case, since the above-described matters may be applied regarding the output of electrical signals from a SPAD, redundant descriptions are omitted.

Further, in this case, the fourth electrical signal 1241 is an electrical signal generated as a laser output from the LiDAR device is reflected from a target and received by the SPAD, and the fifth electrical signal 1242, and the sixth electrical signal 1245 are electrical signals generated as photons caused by external light such as sunlight are received by the SPAD.

Referring again to FIGS. 4A and 4B, in FIG. 4A, a first time interval 1233, which is the time interval between the first electrical signal 1231 and the laser output time point, is identical to a second time interval 1243, which is the time interval between the fourth electrical signal 1241 and the laser output time point in FIG. 4B.

This is because, a target is located at the first distance from the LiDAR device in FIG. 4A and a target is also located at the first distance from the LiDAR device in FIG. 4B, the first time interval 1233 corresponds to the round-trip time-of-flight of the laser output from the LiDAR device between the LiDAR device and the target, and the second time interval 1243 also corresponds to the round-trip time-of-flight of the laser output from the LiDAR device between the LiDAR device and the target.

On the other hand, a third time interval 1232, which is the time interval between the second electrical signal 1232 and the laser output time point in FIG. 4A is different from a fourth time interval 1242, which is the time interval between the fifth electrical signal 1242 and the laser output time point in FIG. 4B.

This is because, although both the second electrical signal 1232 and the fifth electrical signal 1242 are electrical signals generated as photons caused by external light such as sunlight are received by the SPAD, the reception of photons caused by external light such as sunlight by the SPAD has no regularity and is random.

Therefore, similar to the situations described with reference to FIGS. 4A and 4B, when lasers are output N times from a LiDAR device in a situation in which a target is located at the first distance, the number of electrical signals that are output after a time interval identical to the first time interval 1233 and the second time interval 1243 from respective laser output time points may be N. On the other hand, the number of electrical signals that are output after a specific time interval different from the first time interval 1233 and the second time interval 1243 from respective laser output time points may be less than N, and this is described in more detail with reference to FIG. 5.

FIG. 5 is a diagram illustrating the number of electrical signals output after the same time has elapsed from each laser output time point when lasers are output multiple times from a LiDAR device.

Before describing FIG. 5, FIG. 5 assumes a situation in which lasers are output N times from a LiDAR device in a situation in which a target is located at the first distance, similar to the situations described with reference to FIGS. 4A and 4B.

Therefore, as described with reference to FIGS. 4A and 4B, when a target is located at the first distance from a LiDAR device, a laser output from the LiDAR device is received by a SPAD after a time interval identical to the first time interval 1233 and the second time interval 1243 from the laser output time point.

Therefore, when a target is located at the first distance from a LiDAR device and lasers are output N times from the LiDAR device, electrical signals that are generated from a SPAD as the lasers output from the LiDAR device are reflected from the target and return to the LiDAR device are generated after a time interval identical to the first time interval 1233 and the second time interval 1243 from respective laser output time points of the lasers output N times. In FIG. 5, the time interval identical to the first time interval 1233 and the second time interval 1243 is described as a fifth time interval 1250.

That is, referring to FIG. 5, when lasers are output N times from a LiDAR device, the number of electrical signals generated after the fifth time interval 1250 from respective laser output time points is N.

On the other hand, as described with reference to FIGS. 4A and 4B, since the reception of photons caused by external light such as sunlight by a SPAD has no regularity and is random, when lasers are output N times from a LiDAR device, the number of electrical signals generated after specific time intervals different from the fifth time interval 1250 from respective laser output time points is less than N.

Therefore, as described with reference to FIG. 5, when lasers are output multiple times from a LiDAR device and the numbers of electrical signals output after the same time elapsed from respective laser output time points are compared, a time interval in which the largest number of electrical signals are generated may be specified.

In this case, the time interval in which the largest number of electrical signals are generated corresponds to the round-trip time-of-flight of the laser output from the LiDAR device between the LiDAR device and the target.

Therefore, if the method described with reference to FIG. 5 is used, it becomes possible for a LiDAR device to measure a distance to a target using a SPAD.

Hereinafter, a histogram for utilizing the above-described approach is described in more detail.

### Histogram

FIG. 6 is a diagram illustrating a histogram disclosed in the present disclosure.

More specifically, FIG. 6A is a diagram for illustrating a data configuration of a histogram disclosed in the present disclosure and FIG. 6B is a diagram schematically illustrating the histogram disclosed in the present disclosure.

Referring to FIGS. 6A and 6B, the histogram is data composed of a preset number of time bins and counting values corresponding to the preset number of time bins, respectively.

That is, the histogram is data composed of N time bins that comprise a first time bin TB1 to an N-th time bin TBn, and N counting values that comprise a first counting value C1 corresponding to the first time bin TB1 to an N-th counting value Cn corresponding to the N-th time bin TBn.

In this case, each time bin of the histogram represents a time period after a specific time elapses from a laser output time point.

For example, the first time bin TB1 of the histogram represents a time period having duration of 2 ns after 0 seconds elapse from a reference time point corresponding to a laser output time point, and the second time bin TB2 represents a time period having duration of 2 ns after 2 ns elapse from the reference time point corresponding to the laser output time point.

Further, for example, when the histogram is generated on the basis of the case in which lasers are output m times and electrical signals are output from a SPAD for a predetermined time from respective m laser output time points, the first counting value C1 corresponding to the first time bin TB1 corresponds to the number of electrical signals generated from the SPAD within a time period having duration of 2 ns after 0 seconds elapse from each of the m laser output time points, and the second counting value C2 corresponding to the second time bin TB2 corresponds to the number of electrical signals generated from the SPAD within a time period having duration of 2 ns after 2 ns elapse from each of the m laser output time points.

Hereinafter, generation of the above-described histogram in a LiDAR device is described in more detail.

### [Generation of Histogram and Description of Histogram]

FIG. 7 is a diagram illustrating generation of a histogram in a LiDAR device disclosed in the present disclosure.

More specifically, FIG. 7 is a diagram illustrating a process of generating a histogram through M sampling cycles in a LiDAR device.

### Definition of Sampling Cycle

As described above with reference to FIG. 3, electrical signals output from a SPAD for a predetermined time from a laser output time point after a laser is output once from a LiDAR device are difficult to distinguish between electrical signals resulting from photons of the laser reflected from a target and received by the SPAD and electrical signals resulting from photons received by the SPAD due to external light such as sunlight.

Therefore, as described above with reference to FIGS. 4 and 5, in order to measure a distance between a LiDAR device and a target using a SPAD, the LiDAR device needs to perform an operation of outputting lasers multiple times and detecting electrical signals output from the SPAD for a predetermined time from respective laser output time points.

That is, in order to measure a distance between a LiDAR device and a target using a SPAD, the LiDAR device needs to repeatedly perform a series of operations of outputting a laser and detecting an electrical signal output from a detecting element for a predetermined time from a time point corresponding to the laser output time point multiple times.

Therefore, a series of operations of outputting a laser of a LiDAR device and detecting an electrical signal output from a detecting element for a predetermined time from a time point corresponding to the laser output time point may be defined as a unit operation cycle, and, for the convenience of description in the present specification, the above-described unit operation cycle is defined as a sampling cycle.

That is, in the present specification, a period in which a series of operations of outputting a laser using a laser emitting element and detecting an electrical signal output from a detecting element for a predetermined time from a time point corresponding to the laser output time point are performed is defined as a sampling cycle.

Further, in this case, for the convenience of description, in the present specification, a predetermined time period for detecting an electrical signal that is output from a detecting element may be described using a term [symbol] detecting window [symbol] .

### Operation of LiDAR Device in Sampling Cycle

In one sampling cycle, a LiDAR device can generate a laser trigger signal for operating a laser emitting element, and the laser emitting element of the LiDAR device outputs a laser in response to a laser trigger signal.

For example, referring to FIG. 7, in a first sampling cycle 1310, a LiDAR device can generate a first laser trigger signal 1311, and a laser emitting element outputs a first laser 1312 in response to the first laser trigger signal 1311.

Further, for example, in a second sampling cycle 1320, the LiDAR device can generate a second laser trigger signal 1321, and the laser emitting element outputs a second laser 1322 in response to the second laser trigger signal 1321.

Further, for example, in an M-th sampling cycle 1330, the LiDAR device can generate an M-th laser trigger signal 1331, and the laser emitting element outputs an M-th laser 1332 in response to the M-th laser trigger signal 1331.

Further, in one sampling cycle, a LiDAR device can generate a detecting trigger signal for setting a sampling reference time point of a detecting element, and an electrical signal output from the detecting element of the LiDAR device is detected during a detecting window from the sampling reference time point set in response to the detecting trigger signal.

For example, referring to FIG. 7, in the first sampling cycle 1310, the LiDAR device can generate a first detecting trigger signal 1313, and an electrical signal output from the detecting element of the LiDAR device is detected during a first detecting window 1315 from a first sampling reference time point 1314 set in response to the first detecting trigger signal 1313.

Further, for example, in the second sampling cycle 1320, the LiDAR device can generate a second detecting trigger signal 1323, and an electrical signal output from the detecting element of the LiDAR device is detected during a second detecting window 1325 from a second sampling reference time point 1324 set in response to the second detecting trigger signal 1323.

Further, for example, in an M-th sampling cycle 1330, the LiDAR device can generate an M-th detecting trigger signal 1333, and an electrical signal output from the detecting element of the LiDAR device is detected during a third detecting window 1335 from an M-th sampling reference time point 1334 set in response to the M-th detecting trigger signal 1333.

In this case, the laser trigger signal and the detecting trigger signal may be synchronized with each other, and the meaning that a laser trigger signal and a detecting trigger signal are synchronized with each other may be that the laser trigger signal and the detecting trigger signal are generated at the same time point, that a time interval between generation time points of the laser trigger signal and the detecting trigger signal is maintained constant, or that the time interval between generation time points of the laser trigger signal and the detecting trigger signal is maintained within a preset time interval.

Therefore, in one sampling cycle, since a laser trigger signal and a detecting trigger signal are synchronized with each other, a laser output time point and a sampling reference time point may be synchronized with each other.

For example, in the first sampling cycle 1310, the first laser trigger signal 1311 and the first detecting trigger signal 1313 may be synchronized with each other, in the second sampling cycle 1320, the second laser trigger signal 1321 and the second detecting trigger signal 1323 may be synchronized with each other, and in the M-th sampling cycle 1330, the M-th laser trigger signal 1331 and the M-th detecting trigger signal 1333 may be synchronized with each other.

Detection of Electrical Signal Output from Detecting Element in Sampling Cycle and Generation of Histogram

As described above, in one sampling cycle, an electrical signal output from a detecting element of the LiDAR device is detected during a detecting window from a sampling reference time point set in response to a detecting trigger signal.

Hereinafter, detection of an electrical signal output from a detecting element of a LiDAR device during a detecting window is described through exemplary situations during the first detecting window 1315 and the second detecting window 1325.

Referring again to FIG. 7, for example, a first electrical signal 1316 and a second electrical signal 1317 are output from a detecting element of a LiDAR device during the first detecting window 1315, and a third electrical signal 1326 and a fourth electrical signal 1327 are output from the detecting element of the LiDAR device during the second detecting window 1325.

In this case, in one sampling cycle, an electrical signal output from the detecting element of the LiDAR device is detected during a detecting window from the sampling reference time point, and at each determination time point corresponding to a preset clock, whether an electrical signal has been output from the detecting element is determined, and a counting value is generated on the basis of the determination result. In this case, the determination time point corresponding to the preset clock may be a rising edge of the preset clock.

For example, during the first detecting window 1315, whether an electrical signal has been output from the detecting element is determined at a first determination time point corresponding to a first clock 1410 from a first sampling reference time point 1314, and since an electrical signal is not detected at the first determination time point, a counting value of 0 is generated.

Further, for example, during the first detecting window 1315, whether an electrical signal has been output from the detecting element is determined at a second determination time point corresponding to a second clock 1420 from the first sampling reference time point 1314, and since an electrical signal is detected at the second determination time point, a counting value of 1 is generated.

Further, for example, during the first detecting window 1315, whether an electrical signal has been output from the detecting element is determined at a third determination time point corresponding to a third clock 1430 from the first sampling reference time point 1314, and since an electrical signal is not detected at the third determination time point, a counting value of 0 is generated.

Further, for example, during the first detecting window 1315, whether an electrical signal has been output from the detecting element is determined at a fourth determination time point corresponding to an N-th clock 1440 from the first sampling reference time point 1314, and since an electrical signal is detected at the fourth determination time point, a counting value of 1 is generated.

Further, for example, during the second detecting window 1325, whether an electrical signal has been output from the detecting element is determined at a fifth determination time point corresponding to a first clock 1450 from the second sampling reference time point 1324, and since an electrical signal is not detected at the fifth determination time point, a counting value of 0 is generated. In this case, the first clock 1450 from the second sampling reference time point 1324 may be an (N+1)-th clock from the first sampling reference time point 1314, or may be an (N+1+k)-th clock (in this case, k may correspond to the number of clocks corresponding to the time interval between the first sampling cycle 1310 and the second sampling cycle 1320)

Further, for example, during the second detecting window 1325, whether an electrical signal has been output from the detecting element is determined at a sixth determination time point corresponding to a second clock 1460 from the second sampling reference time point 1324, and since an electrical signal is detected at the sixth determination time point, a counting value of 1 is generated.

Further, for example, during the second detecting window 1325, whether an electrical signal has been output from the detecting element is determined at a seventh determination time point corresponding to a third clock 1470 from the second sampling reference time point 1324, and since an electrical signal is detected at the seventh determination time point, a counting value of 1 is generated.

Further, for example, during the second detecting window 1325, whether an electrical signal has been output from the detecting element is determined at an eighth determination time point corresponding to an N-th clock 1480 from the second sampling reference time point 1324, and since an electrical signal is detected at the eighth determination time point, a counting value of 0 is generated.

Further, in one sampling cycle, a counting value generated at each determination time point is assigned to a time bin set in accordance with the time interval between a sampling reference time point and the determination time point. In this case, each time bin may represent a time period after a specific time elapses from the sampling reference time point, and for example, a first time bin TB1 may represent a time period having duration of 2 ns after 0 seconds elapse from the sampling reference time point, a second time bin TB2 may represent a time period having duration of 2 ns after 2 ns elapse from the sampling reference time point, a third time bin TB3 may represent a time period having duration of 2 ns after 4 ns elapse from the sampling reference time point, and an N-th time bin TBn may represent a time period having duration of 2 ns after 2*(N [symbol] 1) ns elapse from the sampling reference time point.

For example, during the first detecting window 1315, a counting value generated at the first determination time point corresponding to the first clock 1410 from the first sampling reference time point 1314 is assigned to a first time bin corresponding to the first clock 1410 from the first sampling reference time point 1314. It may be understood that a counting value generated during a first detecting window 1315 at a first determination time point corresponding to a first clock 1410 from the first sampling reference time point 1314 is assigned to a first time bin TB1 indicating a time duration between the first sampling reference time point 1314 and the first clock 1410.

Further, for example, a counting value generated at the second determination time point corresponding to the second clock 1420 from the first sampling reference time point 1314 during the first detecting window 1315 is assigned to the second time bin TB2 corresponding to the second clock 1420 from the first sampling reference time point 1314.

Further, for example, a counting value generated at the third determination time point corresponding to the third clock 1430 from the first sampling reference time point 1314 during the first detecting window 1315 is assigned to the third time bin TB3 corresponding to the third clock 1430 from the first sampling reference time point 1314.

Further, for example, a counting value generated at the fourth determination time point corresponding to the N-th clock 1440 from the first sampling reference time point 1314 during the first detecting window 1315 is assigned to the N-th time bin TBn corresponding to the N-th clock 1440 from the first sampling reference time point 1314.

In this case, first data 1510 shows data generated as counting values created at respective determination time points during the first detecting window 1315 of the first sampling cycle 1310 are assigned to time bins corresponding to the respective determination time points.

As illustrated in FIG. 7, in the first data 1510, a counting value of 0 corresponds to the first time bin TB1, a counting value of 1 corresponds to the second time bin TB2, a counting value of 0 corresponds to the third time bin TB3, and a counting value of 1 corresponds to the N-th time bin TBn.

Again, an explanation returns to the example in which, in one sampling cycle, a counting value generated at each determination time point is assigned to a time bin set in accordance with the time interval between a sampling reference time point and the determination time point.

For example, a counting value generated at the fifth determination time point corresponding to the first clock 1450 from the second sampling reference time point 1324 during the second detecting window 1325 is assigned to or accumulated in a first time bin corresponding to the first clock 1450 from the second sampling reference time point 1324. In this case, the first clock 1450 from the second sampling reference time point 1324 is a physically different clock from the first clock 1410 from the first sampling reference time point 1314 described above. However, since the time interval between the second sampling reference time point 1324 and the first clock 1450 is the same as the time interval between the first sampling reference time point 1314 and the first clock 1410, the time bin corresponding to the first clock 1450 from the second sampling reference time point 1324 and the time bin corresponding to the first clock 1410 from the first sampling reference time point 1314 are identical to each other, as the first time bin TB1.

That is, a counting value of 0 generated through the second sampling cycle 1320 is accumulated in the first time bin TB1 to which a counting value of 0 has been assigned through the first sampling cycle 1310.

Accordingly, a counting value of 0 corresponds to the first time bin TB1 of the second data 1520 acquired through the first sampling cycle 1310 and the second sampling cycle 1320.

Further, for example, a counting value generated at the sixth determination time point corresponding to the second clock 1460 from the second sampling reference time point 1324 during the second detecting window 1325 is assigned to or accumulated in a second time bin corresponding to the second clock 1460 from the second sampling reference time point 1324.

That is, a counting value of 1 generated through the second sampling cycle 1320 is accumulated in the second time bin TB2 to which a counting value of 1 has been assigned through the first sampling cycle 1310.

Accordingly, a counting value of 2 corresponds to the second time bin TB2 of the second data 1520 acquired through the first sampling cycle 1310 and the second sampling cycle 1320.

Further, for example, a counting value generated at the seventh determination time point corresponding to the third clock 1470 from the second sampling reference time point 1324 during the second detecting window 1325 is assigned to or accumulated in the third time bin corresponding to the third clock 1470 from the second sampling reference time point 1324.

That is, a counting value of 1 generated through the second sampling cycle 1320 is assigned to or accumulated in the third time bin TB3 to which a counting value of 0 has been assigned through the first sampling cycle 1310.

Accordingly, a counting value of 1 corresponds to the third time bin TB3 of the second data 1520 acquired through the first sampling cycle 1310 and the second sampling cycle 1320.

Further, for example, a counting value generated at the eighth determination time point corresponding to the N-th clock 1480 from the second sampling reference time point 1324 during the second detecting window 1325 is assigned to or accumulated in the N-th time bin corresponding to the N-th clock 1480 from the second sampling reference time point 1324.

That is, a counting value of 0 generated through the second sampling cycle 1320 is accumulated in the N-th time bin TBn to which a counting value of 1 has been assigned through the first sampling cycle 1310.

Accordingly, a counting value of 1 corresponds to the N-th time bin TBn of the second data 1520 acquired through the first sampling cycle 1310 and the second sampling cycle 1320.

In the above descriptions, assigning a counting value may be storing the counting value in a memory corresponding to a time bin, and accumulating a counting value may be adding a generated counting value to a counting value stored in a memory corresponding to a time bin.

Although the above descriptions have been explained through the first sampling cycle 1310 and the second sampling cycle 1320, the above-described operations may be performed for all of the first to M-th sampling cycles 1310 to 1330 in order to generate a histogram through M sampling cycles, and accordingly, a histogram 1530 generated through the first to M-th sampling cycles 1310 to 1330 may be acquired.

In this case, the histogram 1530 comprises N time bins including first to N-th time bins (TB1 to TBn) and first to N-th counting values (C1 to Cn) corresponding to the respective N time bins.

Further, in this case, respective counting values corresponding to respective time bins may correspond to the number of determination time points, at which an electrical signal output from a detecting element is detected, among determination time points corresponding to respective time bins through the M sampling cycles, and may correspond to the sum of counting values generated at the determination time points corresponding to the time bins, respectively.

### Relationship Between Length of Time Bin Length and Distance Resolution of LiDAR Device

As described above, when measuring a distance between a LiDAR device and a target using the histogram generated as described above, a time bin length, which is the length of a time interval represented by a time bin, affects a distance resolution of the LiDAR device.

This is because electrical signals generated during the length of the time interval corresponding to the length of a time bin are determined to have been generated after the same time interval from a laser output time point.

Describing with reference to a specific example, assuming that a specific time bin represents a time interval having duration of 2 ns from 300 ns after a reference time point corresponding to a laser output time point, the cases in which electrical signals have been output from a SPAD at 300 ns, 301 ns, and 302 ns from the reference time point are determined to be cases in which the electrical signals have been generated after the same time interval from the reference time point.

This is explained in more detail using a situation in which a first target is located at a distance of 15 m from a LiDAR device, a situation in which a second target is located at a distance of 15.05 m, and a situation in which a third target is located at a distance of 15.10 m.

In the situation in which a first target is located 15 m from a LiDAR device, when a laser is output from the LiDAR device, an electrical signal is generated 300 ns after a reference time point corresponding to the laser output time point.

Further, in the situation in which a second target is located 15.05 m from a LiDAR device, when a laser is output from the LiDAR device, an electrical signal is generated 301 ns after a reference time point corresponding to the laser output time point.

Further, in the situation in which a third target is located 15.10 m from a LiDAR device, when a laser is output from the LiDAR device, an electrical signal is generated 302 ns after a reference time point corresponding to the laser output time point.

In this case, when the duration of a time bin is 2 ns, the first to third targets may be determined to be located at the same distance.

Therefore, when the duration of a time bin is 2 ns, the distance resolution of the LiDAR device becomes 0.1 m.

On the other hand, when the duration of a time bin is 10 ns, targets located from 15 m to 15.5 m from the LiDAR device are determined to be located at the same distance

Therefore, when the duration of a time bin is 10 ns, the distance resolution of the LiDAR device becomes 0.5 m.

### Exemplary Combination of Length of Time Bin, Number of Time Bins, and Number of Sampling Cycles

For the convenience of understanding, an exemplary combination of the length of a time bin, the number of time bins, and the number of sampling cycles is described.

In an exemplary LiDAR device, the length of a time bin is set to 2 ns and the number of time bins may be set to 500.

Therefore, in the exemplary LiDAR device, a time during which one sampling cycle is performed may become 1000 ns.

Further, in the exemplary LiDAR device, the number of sampling cycles may be set to 357.

In this case, a time required to generate one histogram through the 357 sampling cycles may be at least 357,000 ns.

Of course, the exemplary numerical values described above may be designed differently as needed.

### [Distance Measurement Between LiDAR Device and Target Using Histogram]

### Determination of Echo Signal

FIG. 8 is a diagram illustrating determination of an echo signal on the basis of a histogram in a LiDAR device.

In order to measure a distance between a LiDAR device and a target, an echo signal 1620 may be determined on the basis of a histogram 1600.

In this case, the echo signal 1620 comprises, as a portion of the histogram satisfying a predetermined criterion, a time bin group 1621 and a counting value group 1622 corresponding to the time bin group 1621.

In this case, various algorithms may be used to determine the echo signal 1620.

For example, the echo signal 1620 may be determined to be a counting value group equal to or greater than a preset threshold 1610 and a time bin group corresponding thereto.

Further, for example, the echo signal 1620 may be determined to be the largest counting value Ck among the counting values included in the histogram 1600, a time bin TBk to which the largest counting value Ck is assigned, adjacent time bins TBk [symbol] 2, TBk [symbol] 1, TBk+1, TBk+2, and TBk+3, and counting values Ck [symbol] 2, Ck [symbol] 1, Ck+1, Ck+2, and Ck+3 assigned thereto.

### Measurement of Distance to Target on the Basis of Echo Signal

In order to measure a distance between a LiDAR device and a target on the basis of an echo signal, a time value corresponding to the echo signal is determined, and this may be determined by various methods.

For example, a time value corresponding to the echo signal may be determined as a time value corresponding to a time bin to which the largest counting value among the counting values included in the echo signal is assigned, may be determined as a time value corresponding to a median of time bins to which counting values included in the echo signal are assigned, or may be determined as a time value corresponding to an average of time bins to which counting values included in the echo signal are assigned, but is not limited thereto and may be determined by various methods.

When a time value corresponding to an echo signal is determined, a distance between a LiDAR device and a target may be calculated through Relationship 1 below.

$$Distance = ( c \times time value corresponding to echo signal ) / 2 \qquad [ Relationship 1 ]$$

### Estimation of Reflection Intensity of Laser to Target Based on Echo Signal

The reflection intensity of a laser to a target may be estimated on the basis of an echo signal.

In this case, the reflection intensity of a laser to a target refers to an intensity of a laser that is output from a LiDAR device, reflected from a target, and returned to the LiDAR device.

Further, in this case, an intensity of a laser that is output from a LiDAR device, reflected from a target, and returned to the LiDAR device varies depending on an incident angle of the laser to the surface of the target and physical properties (surface characteristics, color, reflectivity, and the like) of the target.

The reason why the reflection intensity of a laser to a target may be estimated on the basis of an echo signal is that, as the intensity of a laser that is reflected from a target and returned to a LiDAR device increases, the probability that the laser is detected by a detecting element of the LiDAR device increases, and accordingly the counting values of the echo signal may increase.

In this case, in order to estimate the reflection intensity of a laser to a target on the basis of an echo signal, counting values included in the echo signal may be used in various ways.

For example, the reflection intensity of a laser to a target may be determined by the largest counting value among the counting values included in an echo signal, the sum of the counting values included in the echo signal, the width of the echo signal, an area of the echo signal, and the like, but is not limited thereto and may be determined in various ways.

In this case, an estimated reflection intensity of a laser to a target may be expressed, in this specification, using terms such as reflection intensity or intensity.

### [Processor]

### Function of Processor

Referring again to FIG. 1, a processor 1030 is configured to perform functions of controlling a laser emitting element 1010 and a detecting element 1020, generating the above-described histogram, determining an echo signal, measuring a distance between a LiDAR device and a target on the basis of the echo signal, estimating the reflection intensity of a laser to a target on the basis of the echo signal, and the like.

In this case, the processor 1030 may be implemented as a single processor, but is not limited thereto, and may be implemented through multiple processors embedded in respective components of a LiDAR device depending on functions.

For example, the processor 1030 may be configured such that a first processor embedded in the laser emitting element 1010 performs a function of controlling the laser emitting element, a second processor embedded in the detecting element 1020 performs a function of controlling the detecting element, generating a histogram, and determining an echo signal, and a third processor provided separately from the laser emitting element 1010 and the detecting element 1020 performs a function of measuring a distance between the LiDAR device and a target and estimating the reflection intensity of a laser to the target on the basis of an echo signal.

[Necessity of Configuring LiDAR Device to comprise Laser Emitting Element Array, Transmission Optical Assembly, Detecting Element Array, and Reception Optical Assembly]

### Necessity of Laser Emitting Element Array and Transmission Optical Assembly

As described above, since a LiDAR device is a device for measuring a distance between the LiDAR device and a target using a laser, a measurable area of the LiDAR device is related to a region within which a laser output from the LiDAR device is emitted.

That is, in order to expand a measurable area of a LiDAR device, it is necessary to expand a region within which a laser output from the LiDAR device is emitted.

FIG. 9 is a diagram illustrating various examples for expanding a region within which a laser output from a LiDAR device is emitted.

FIG. 9A is a diagram exemplarily illustrating a LiDAR device configured with a laser emitting element and a diffuser.

Referring to FIG. 9A, a laser 1711 output from a laser emitting element 1710 is diffused through a diffuser 1712, and accordingly, a region within which the laser is emitted is expanded.

In this case, since the laser 1711 output from the laser emitting element 1710 is diffused while passing through the diffuser 1712, photon density per unit area rapidly decreases as a distance increases.

Therefore, when a LiDAR device is configured as in FIG. 9A, the amount of photons that are reflected from a target located at a long distance from the LiDAR device decreases, and accordingly, the amount of photons returning to the LiDAR device also decreases.

As a result, configuring a LiDAR device as in FIG. 9A decreases a measurable distance of the LiDAR device.

FIG. 9B is a diagram exemplarily illustrating a LiDAR device configured with a laser emitting element and rotary mirrors.

Referring to FIG. 9B, a laser 1721 output from a laser emitting element 1720 is directed to the outside of the LiDAR device by a first rotary mirror 1722 rotating about a first rotation axis and a second rotary mirror 1723 rotating about a second rotation axis perpendicular to the first rotation axis.

In this case, as rotation angles of the first rotary mirror 1722 and the second rotary mirror 1723 are changed, the direction in which the laser 1721 output from the laser emitting element 1720 is directed to the outside is changed.

That is, the direction in which the laser 1721 is directed is determined in accordance with the rotation angles of the first rotary mirror 1722 and the second rotary mirror 1723 at a time point at which the laser 1721 is output.

Therefore, when the first rotary mirror 1722 and the second rotary mirror 1723 are rotated while lasers 1721 are output multiple times from the laser emitting element 1720 over time, the direction in which the lasers 1721 output from the laser emitting element 1720 are directed to the outside is changed over time, and the region within which the lasers are emitted is expanded.

However, when a LiDAR device is configured as in FIG. 9B, the size of the LiDAR device increases due to the volumes of the rotary mirrors, power is consumed for rotation operations of the rotary mirrors, and a durability degradation problem occurs due to rotation of the rotary mirrors.

That is, as described with reference to FIGS. 9A and 9B, expanding a region within which a laser is emitted using a single laser emitting element 1720 has clear limitations.

Therefore, expanding a region within which a laser is emitted using a laser emitting element array may be a useful solution compared to the configurations of the LiDAR devices described with reference to FIGS. 9A and 9B.

FIG. 9C is a diagram exemplarily illustrating a region within which a laser of a LiDAR device configured with a laser emitting element array is emitted.

Referring to FIG. 9C, a first laser 1733 output from a first laser emitting element 1731 included in a laser emitting element array 1730 and a second laser 1734 output from a second laser emitting element 1732 are output in parallel in the same direction while being spaced apart by a first distance 1735.

In this case, the first distance 1735 corresponds to the size (the length or the width) of the laser emitting element array 1730.

Therefore, when a LiDAR device is configured as in FIG. 9C, a region within which a laser is emitted is expanded by an amount corresponding to the size of the laser emitting element array 1730.

However, in this case, since the propagation directions of the first laser 1733 and the second laser 1734 are parallel, the degree of expansion of the region within which the laser is emitted is insignificant.

Therefore, in order to more greatly expand a region within which a laser is emitted using the laser emitting element array 1730, it is necessary to configure lasers output from a plurality of laser emitting elements included in the laser emitting element array 1730 to be output in different directions.

Hereinafter, an exemplary LiDAR device configured such that lasers output from a plurality of laser emitting elements included in a laser emitting element array 1730 are output in different directions is described with reference to FIG. 9D.

Further, FIG. 9D is a diagram exemplarily illustrating a LiDAR device configured with a laser emitting element array arranged on a curved surface.

Referring to FIG. 9D, a first laser emitting element 1741 included in a laser emitting element array 1740 faces a first direction and outputs a first laser 1743 in the first direction, and a second laser emitting element 1742 faces a second direction and outputs a second laser 1744 in the second direction.

That is, when a LiDAR device is configured as in FIG. 9D, lasers are output in different directions in accordance with the directions faced by respective laser emitting elements included in the laser emitting element array 1740, and accordingly, a region within which a laser from the LiDAR device is emitted is expanded.

However, when a LiDAR device is configured as in FIG. 9D, it is necessary to individually align the directions of the laser emitting elements in order for lasers to be output in desired directions, which causes excessive time and cost.

Further, in this case, it is difficult to collimate lasers output from the plurality of laser emitting elements included in the laser emitting element array 1740, and thus photon density per unit area decreases as the distance increases.

Therefore, unlike the LiDAR devices described with reference to FIGS. 9C and 9D, although a laser emitting element array is used, the configuration of a transmission optical assembly for steering and collimating the lasers that are output from respective laser emitting elements included in a laser emitting element array is required.

### Necessity of Detecting Element Array and Reception Optical Assembly

As described above, since a LiDAR device is a device for measuring a distance between the LiDAR device and a target using a laser, a measurable region of the LiDAR device is related to a region in which a light can be detected.

Further, since a LiDAR device uses that a laser output from the LiDAR device and reflected from a target is received by a detecting element, a reception optical assembly for focusing light received by the LiDAR device is needed to increase reception efficiency.

In this case, since light incident on a reception optical assembly from different directions may be focused onto different points, detecting elements need to be arranged at points at which light incident from different directions is focused in order to expand a region in which light can be detected, and thus it is necessary to configure a detecting element array.

### [LiDAR Device Including Laser Emitting Element Array, Transmission Optical Assembly, Detecting Element Array, and Reception Optical Assembly]

FIG. 10 is a diagram illustrating a LiDAR device disclosed by the present disclosure.

Referring to FIG. 10, a LiDAR device 1800 disclosed by the present disclosure may comprise a laser emitting element array 1810, a transmission optical assembly 1820, a detecting element array 1850, and a reception optical assembly 1860.

### Laser Emitting Element Array

### Definition of Laser Emitting Element Array

The laser emitting element array 1810 is defined as a configuration in which a plurality of laser emitting elements is arranged in array form.

In this case, the plurality of laser emitting elements included in the laser emitting element array 1810 may be arranged in array form in a single plane.

Further, in this case, the plurality of laser emitting elements included in the laser emitting element array 1810 may be implemented to share at least one substrate.

### Types of Laser Emitting Element Array

As described above, there may be various types of laser emitting elements.

Therefore, the type of the laser emitting element array 1810 in which a plurality of laser emitting elements is arranged in array form may also vary.

However, in the technical field of solid-state LiDAR devices, the laser emitting element array 1810 is typically implemented as a VCSEL array.

This is because, as described above, a VCSEL has a multilayer structure and outputs a laser in a direction in which multiple layers are stacked, and thus arranging them in array form in a single plane may be more advantageous.

### Transmission Optical Assembly

### Function of Transmission Optical Assembly

The transmission optical assembly 1820 is configured to collimate and steer lasers output from the laser emitting elements included in the laser emitting element array 1810 using phenomena such as refraction, diffraction, and reflection of light.

In this case, collimating a laser output from a laser emitting element may be defined as reducing the divergence angle of the laser output from the laser emitting element, but is not limited thereto and comprises a concept understood by those skilled in the art as the function of a collimating laser.

Further, in this case, steering a laser output from a laser emitting element may be defined as changing the propagation path of the laser output from the laser emitting element, but is not limited thereto and comprises a concept understood by those skilled in the art as the function of steering a laser.

When the transmission optical assembly 1820 is used in the LiDAR device 1800, since the lasers output from the laser emitting elements are collimated by the transmission optical assembly 1820, energy loss caused by long-distance flight of the lasers is reduced, which enables the LiDAR device to measure a distance to a target located farther away.

Further, when the transmission optical assembly 1820 is used in the LiDAR device 1800, since the lasers output from laser emitting elements are steered by the transmission optical assembly 1820, it enables the propagation path of the lasers to be changed to a direction different from the output direction of the lasers output from the laser emitting elements.

### Types of Optics Constituting Transmission Optical Assembly

Further, the transmission optical assembly 1820 is configured with a combination of one or more optics, and the types of the optics constituting the transmission optical assembly 1820 may vary.

For example, the types of the optics constituting the transmission optical assembly 1820 may comprise a lens, a prism, a micro lens, and a meta lens, but are not limited thereto, and various kinds of optics may be used.

Further, the types of the lenses constituting the transmission optical assembly 1820 may vary.

For example, the types of the lenses constituting the transmission optical assembly 1820 may comprise a convex lens, a concave lens, a biconvex lens, a plano-convex lens, a convex meniscus lens, a biconcave lens, a plano-concave lens, a concave meniscus lens, an equi-convex lens, or an equi-concave lens.

Further, for example, the types of the lenses constituting the transmission optical assembly 1820 may comprise a spherical lens, an aspherical lens, or a cylindrical lens.

Further, for example, the types the lenses constituting the transmission optical assembly 1820 may comprise a symmetric lens or an asymmetric lens.

Structure of Transmission Optical Assembly [symbol] Various Combinations

The transmission optical assembly 1820 may be configured as a combination of one or more optics, and in this case, may be implemented as a combination of various types of optics.

The transmission optical assembly 1820 may be implemented as a single lens.

For example, the transmission optical assembly 1820 may be implemented as one convex lens or one concave lens.

Further, the transmission optical assembly 1820 may be implemented as a compound lens composed of a plurality of lenses.

For example, the transmission optical assembly 1820 may be implemented as a compound lens composed of a combination of a plurality of convex lenses and a plurality of concave lenses.

Further, the transmission optical assembly 1820 may be implemented as a combination of a plurality of compound lenses.

For example, the transmission optical assembly 1820 may be implemented as a combination of a first compound lens that is a symmetric lens and a second compound lens that is an asymmetric lens.

Further, in addition to the above examples, the transmission optical assembly 1820 may be implemented as various combinations of various optics for collimating and steering lasers output from laser emitting elements.

Structure of Transmission Optical Assembly [symbol] Lens Layer Structure

When the transmission optical assembly 1820 is configured to include a compound lens, the compound lens may comprise a plurality of lens layers stacked along a common axis.

In this case, the plurality of lens layers may be arranged such that optical axes of the respective lens layers are aligned with the common axis, and the optical axis of each of the plurality of lens layers refers to a virtual axis passing through the center of each of the plurality of lens layers and perpendicular to the surface of each of the plurality of lens layers.

Further, in this case, an optical axis of the compound lens may correspond to a virtual axis with which the optical axis of each of plurality the lens layers included in the compound lens are aligned.

### Laser Emission Direction According to Relative Positional Relationship Between Transmission Optical Assembly and Laser Emitting Element

### Arrangement Relationship Between Transmission Optical Assembly and Laser Emitting Element

When laser emitting elements and a transmission optical assembly 1820 are used in the LiDAR device 1800, the laser emitting elements are arranged to output a laser toward the transmission optical assembly 1820.

For example, a first laser emitting element 1811 and a second laser emitting element 1812 included in the laser emitting element array 1810 are arranged to output a laser toward the transmission optical assembly 1820.

In this case, the laser emitting element may be arranged such that the laser output from the laser emitting element propagates parallel to an optical axis 1821 of the transmission optical assembly 1820.

For example, the first laser emitting element 1811 included in the laser emitting element array 1810 may be disposed such that a first laser 1831 output from the first laser emitting element 1811 propagates parallel to the optical axis 1821 of the transmission optical assembly 1820, and the second laser emitting element 1812 may be disposed such that a second laser 1832 output from the second laser emitting element 1812 propagates parallel to the optical axis 1821 of the transmission optical assembly 1820.

Of course, the fact that the lasers output from the laser emitting elements propagate parallel to the optical axis 1821 of the transmission optical assembly 1820 does not mean only that all light rays of the lasers output from the laser emitting elements propagate parallel to the optical axis 1821 of the transmission optical assembly 1820, but comprises a case in which at least some light rays of the light rays of the lasers output from the laser emitting elements propagate parallel to the optical axis 1821 of the transmission optical assembly 1820.

Laser Emission angle and Direction According to Relative Positional Relationship Between Transmission Optical Assembly and Laser Emitting Element

The laser output from a laser emitting element is collimated and steered as it passes through the transmission optical assembly 1820, whereby it can be directed in a specific direction.

For example, the first laser 1831 output from the first laser emitting element 1811 included in the laser emitting element array 1810 is collimated and steered as it passes through the transmission optical assembly 1820, and is directed in a first direction, and the second laser 1832 output from the second laser emitting element 1812 is collimated and steered as it passes through the transmission optical assembly 1820, and is directed in a second direction.

In this case, the direction in which a laser output from a laser emitting element is steered and directed by the transmission optical assembly 1820 may be changed in accordance with the relative positional relationship between the transmission optical assembly 1820 and the laser emitting element.

For example, when the transmission optical assembly 1820 is implemented as a symmetric lens, the angle between the propagation direction of a laser steered while passing through the transmission optical assembly 1820 and the optical axis 1821 of the transmission optical assembly 1820 may be changed in accordance with the distance between a laser emitting element positioned in the focal plane of the transmission optical assembly 1820 and the optical axis 1821 of the transmission optical assembly 1820.

More specifically, when the transmission optical assembly 1820 is implemented as a symmetric lens, as the distance between a laser emitting element positioned in the focal plane of the transmission optical assembly 1820 and the optical axis 1821 of the transmission optical assembly 1820 increases, the angle between the propagation direction of a laser steered while passing through the transmission optical assembly 1820 and the optical axis 1821 of the transmission optical assembly 1820 may increase.

Further, for example, when the transmission optical assembly 1820 is implemented as a symmetric lens, the propagation direction of a laser steered while passing through the transmission optical assembly 1820 may be changed in accordance with the direction in which a laser emitting element positioned in the focal plane of the transmission optical assembly 1820 is disposed with respect to the optical axis 1821 of the transmission optical assembly 1820.

Further, for example, when the transmission optical assembly 1820 is implemented as a cylindrical lens that steers a laser in a first-axis direction, the angle between the propagation direction of a laser steered while passing through the transmission optical assembly 1820 and the optical axis 1821 of the transmission optical assembly 1820 may be changed in accordance with the distance, in the first-axis direction, between a laser emitting element and the optical axis 1821 of the transmission optical assembly 1820.

As described above, since the propagation direction in which a laser output from a laser emitting element propagates through the transmission optical assembly 1820 may be determined in accordance with the relative positional relationship between the laser emitting element and the transmission optical assembly 1820, when a LiDAR device uses a plurality of laser emitting elements having different relative positional relationships with the transmission optical assembly 1820, the LiDAR device can output a plurality of lasers that propagate in different propagation directions through the transmission optical assembly 1820.

Therefore, using the laser emitting element array 1810 and the transmission optical assembly 1820 can make it possible to expand a region within which a laser is emitted.

### Relationship Between Laser Emitting Element Array and Transmission Optical Assembly

### Arrangement Relationship Between Transmission Optical Assembly and Laser Emitting Element Array

The laser emitting element array 1810 may be positioned in the focal plane of the transmission optical assembly 1820.

Of course, as needed, the laser emitting element array 1810 may be positioned to have a preset offset from the focal plane of the transmission optical assembly 1820, but, for the convenience of description, the explanation is based on the assumption that the laser emitting element array 1810 is positioned in the focal plane of the transmission optical assembly 1820.

Further, the laser emitting element array 1810 may be disposed such that a plurality of lasers output from the plurality of laser emitting elements of the laser emitting element array 1810 propagate parallel to the optical axis 1821 of the transmission optical assembly 1820.

Emission direction of Laser Output from Laser Emitting Element Array and Passing Through Transmission Optical Assembly

A plurality of lasers output from the plurality of laser emitting elements of the laser emitting element array 1810 may be collimated and steered as they pass through the transmission optical assembly 1820, whereby they may be directed in different directions.

In this case, the direction in which the laser output from each of the plurality of laser emitting elements of the laser emitting element array 1810 is steered and directed by the transmission optical assembly 1820 varies depending on the relative positional relationship between the transmission optical assembly 1820 and each of the plurality of laser emitting elements.

That is, the emission direction of a laser output from each of the plurality of laser emitting elements may be determined in accordance with the relative position between the transmission optical assembly 1820 and each of the plurality of laser emitting elements.

For example, a first direction in which the first laser 1831 output from the first laser emitting element 1811 included in the laser emitting element array 1810 is steered and directed by the transmission optical assembly 1820 is determined in accordance with the relative position between the optical axis 1821 of the transmission optical assembly 1820 and the first laser emitting element 1811.

For example, a second direction in which the second laser 1832 output from the second laser emitting element 1812 included in the laser emitting element array 1810 is steered and directed by the transmission optical assembly 1820 is determined in accordance with the relative position between the optical axis 1821 of the transmission optical assembly 1820 and the second laser emitting element 1812.

This may be described as a emitting angle or steering angle of the laser output from each of the plurality of laser emitting elements being determined in accordance with the relative position between the transmission optical assembly 1820 and each of the plurality of laser emitting elements.

### Laser Emission Region of LiDAR Device

In the present specification, a laser emission region of the LiDAR device 1800 is a concept intended to comprehensively describe a space in which a laser output from the LiDAR device 1800 can be directed.

In this case, the laser emission region of the LiDAR device 1800 may comprise not only a space in which a laser output from the LiDAR device 1800 is directed at one time point, but also a space in which a laser output from the LiDAR device 1800 can be directed over a predetermined time.

In order to describe a laser emission region of the LiDAR device in more detail, reference is made to FIG. 11.

FIG. 11 is a diagram illustrating a laser emission region of a LiDAR device.

More specifically, FIG. 11 is a diagram for explaining a laser emission region of a LiDAR device by briefly illustrating, for the convenience of description, that respective ones of a plurality of lasers output from a plurality of laser emitting elements of a laser emitting element array are steered while passing through a transmission optical assembly and are directed in different directions.

Referring to FIG. 11, respective ones of a plurality of lasers output from a plurality of laser emitting elements of a laser emitting element array of the LiDAR device 1840 are steered while passing through a transmission optical assembly and are directed in different directions.

That is, a first laser 1841 output from the LiDAR device 1840 is directed in a first direction as it is output from a first laser emitting element and passes through a transmission optical assembly, a second laser 1842 is directed in a second direction as it is output from a second laser emitting element and passes through the transmission optical assembly, a third laser 1843 is directed in a third direction as it is output from a third laser emitting element and passes through the transmission optical assembly, and a fourth laser 1844 is directed in a fourth direction as it is output from a fourth laser emitting element and passes through the transmission optical assembly.

In this case, referring again to FIG. 11, it can be seen that a plurality of lasers output from the LiDAR device 1840 are directed within a specific space, and expressing this differently, a set of spaces in which the plurality of lasers output from the LiDAR device 1840 are directed may be expressed as being defined as a specific space.

Therefore, in the present specification, a specific space in which a plurality of lasers output from the LiDAR device 1840 is directed is described as a laser emission region 1845.

That is, in the example illustrated in FIG. 11, a quadrangular pyramid space having the LiDAR device 1840 as its apex may be a laser emission region 1845.

In this case, referring again to FIG. 11, a specific space in which a plurality of lasers output from the LiDAR device 1840 is directed may be a space having a shape that spreads outward from the LiDAR device 1840 as an origin.

That is, a plurality of lasers output from the LiDAR device 1840 can be directed in different directions with the LiDAR device 1840 as a reference point, and, accordingly, a specific space in which the plurality of lasers output from the LiDAR device 1840 is directed may be a space having a shape that spreads outward from the LiDAR device 1840 as an origin.

Therefore, in order to mathematically describe the above-described laser emission region 1845 of the LiDAR device, a coordinate system having the LiDAR device 1840 as an origin may be effectively used.

For example, in order to mathematically describe the size of the above-described laser emission region 1845 of the LiDAR device, the angle between lasers directed to outermost positions on the coordinate system having the LiDAR device 1840 as an origin may be used.

More specifically, in order to mathematically describe the horizontal size of the laser emission region 1845, the angle between the direction in which the first laser 1841 is directed and the direction in which the second laser 1842 is directed on the coordinate system having the LiDAR device 1840 as an origin may be used. Further, in order to mathematically describe the vertical size of the laser emission region 1845, the angle between the direction in which a third laser 1843 is directed and the direction in which a fourth laser 1844 is directed on the coordinate system having the LiDAR device 1840 as the origin may be used.

In this case, in the present specification, an expression of the size of the laser emission region 1845 of the LiDAR device in terms of an angle is described as the field of view of the laser emission region 1845, and hereinafter, horizontal and vertical fields of view of a laser emission region of a solid-state LiDAR device are described in more detail.

Horizontal and Vertical Fields of View of Laser emission region of Solid-State LiDAR Device

FIG. 12 is a diagram illustrating horizontal and vertical fields of view of a laser emission region of a solid-state LiDAR device.

FIG. 12 illustrates only a laser emitting element array 1900 and a transmission optical assembly 1950 among the components of a solid-state LiDAR device for the convenience of description.

As described above, the laser emission region 1960 of the LiDAR device is defined as a region within which a laser output from the LiDAR device can be emitted.

Therefore, horizontal and vertical fields of view of the laser emission region 1960 of the LiDAR device refer to the range of angles in which lasers output from the LiDAR device can be directed, and may be defined by lasers directed to outermost positions.

In this case, in the solid-state LiDAR device including the laser emitting element array 1900 and the transmission optical assembly 1950, a region within which a laser output from each of a plurality of laser emitting elements can be emitted may be defined by a relative positional relationship with the transmission optical assembly 1950.

Therefore, in the solid-state LiDAR device including the laser emitting element array 1900 and the transmission optical assembly 1950, the horizontal field of view of the laser emission region 1960 may be defined by a first angle 1961 that is the angle between an emission direction of a first laser 1911 output from a first laser emitting element 1910 disposed at a first end among a plurality of laser emitting elements arranged in a central row after passing through the transmission optical assembly 1950, and an emission direction of a second laser 1921 output from a second laser emitting element 1920 disposed at a second end among a plurality of laser emitting elements arranged in a central row after passing through the transmission optical assembly 1950.

Further, in the solid-state LiDAR device including the laser emitting element array 1900 and the transmission optical assembly 1950, the vertical field of view of the laser emission region 1960 may be defined by a second angle 1962 that is the angle between an emission direction of a third laser 1931 output from a third laser emitting element 1930 disposed at a third end among a plurality of laser emitting elements arranged in a central column after passing through the transmission optical assembly 1950, and an emission direction of a fourth laser 1941 output from a fourth laser emitting element 1940 disposed at a fourth end among a plurality of laser emitting elements arranged in a central column after passing through the transmission optical assembly 1950.

### Detecting Element Array

### Definition of Detecting Element Array

The detecting element array 1850 is defined as a structure in which a plurality of detecting elements is arranged in array form.

In this case, the plurality of detecting elements included in the detecting element array 1850 may be arranged in array form in a single plane.

Further, in this case, the plurality of detecting elements included in the detecting element array 1850 may be implemented to share at least one substrate.

### Types of Detecting Element Array

The type of the detecting elements described above may vary.

Therefore, the type of the detecting element array 1810 in which a plurality of detecting elements is arranged in array form may also vary.

### Reception Optical Assembly

### Function of Reception Optical Assembly

A reception optical assembly 1860 is configured to focus light incident on the reception optical assembly 1860 onto a detecting element using phenomena such as refraction, diffraction, and reflection of light.

### Types of Optics Constituting Reception Optical Assembly

Further, the reception optical assembly 1860 is configured with a combination of one or more optics, and the types of the optics constituting the reception optical assembly 1860 may vary.

For example, the types of the optics constituting the reception optical assembly 1860 may comprise a lens, a prism, a micro lens, and a meta lens, but are not limited thereto, and various kinds of optics may be used.

Further, the types of the lenses constituting the reception optical assembly 1860 may vary.

For example, the types of the lenses constituting the reception optical assembly 1860 may comprise a convex lens, a concave lens, a biconvex lens, a plano-convex lens, a convex meniscus lens, a biconcave lens, a plano-concave lens, a concave meniscus lens, an equi-convex lens, or an equi-concave lens.

Further, for example, the types of the lenses constituting the reception optical assembly 1860 may comprise a spherical lens, an aspherical lens, or a cylindrical lens.

Further, for example, the types the lenses constituting the reception optical assembly 1860 may include a symmetric lens or an asymmetric lens.

Structure of Reception Optical Assembly [symbol] Various Combinations

The reception optical assembly 1860 may be configured as a combination of one or more optics, and in this case, may be implemented as a combination of various types of optics.

The reception optical assembly 1860 may be implemented as a single lens.

For example, the reception optical assembly 1860 may be implemented as one convex lens or one concave lens.

Further, the reception optical assembly 1860 may be implemented as a compound lens composed of a plurality of lenses.

For example, the reception optical assembly 1860 may be implemented as a compound lens composed of a combination of a plurality of convex lenses and a plurality of concave lenses.

Further, the reception optical assembly 1860 may be implemented as a combination of a plurality of compound lenses.

For example, the reception optical assembly 1860 may be implemented as a combination of a first compound lens that is a symmetric lens and a second compound lens that is an asymmetric lens.

Further, in addition to the above examples, the reception optical assembly 1860 may be implemented as various combinations of various optics for focusing light incident on the reception optical assembly onto a detecting element.

Further, the reception optical assembly 1860 may be implemented to include a band pass filter that passes only light in a specific wavelength band.

In this case, a transmission band of the band pass filter included in the reception optical assembly 1860 is provided to comprise a wavelength band of the laser that output from a laser emitting element.

In particular, implementing the reception optical assembly 1860 used in a LiDAR device to comprise a band pass filter enables significantly reducing external light that reaches a detecting element by blocking light in wavelength bands other than the wavelength band of the laser that is output from a laser emitting element and by selectively transmitting only light in the wavelength band of the laser that is output from the laser emitting element.

Structure of Reception Optical Assembly [symbol] Lens Layer Structure

When the reception optical assembly 1860 is configured to comprise a compound lens, the compound lens may comprise a plurality of lens layers stacked along a common axis.

In this case, the plurality of lens layers may be arranged such that optical axes of the respective lens layers are aligned with the common axis, and the optical axis of each of the plurality of lens layers refers to a virtual axis passing through the center and perpendicular to the surface of each lens layer.

Further, in this case, an optical axis of the compound lens may correspond to a virtual axis with which the optical axes of the lens layers included in the compound lens are aligned.

### Light Detection Direction According to Relative Positional Relationship Between Reception Optical Assembly and Detecting Element

### Arrangement Relationship Between Reception Optical Assembly and Detecting Element

When detecting elements and a reception optical assembly 1820 are used in the LiDAR device 1800, the detecting elements are positioned in the focal plane of the reception optical assembly 1860 and arranged in a direction facing the reception optical assembly 1860.

### Light Detection Angle and Direction According to Relative Positional Relationship Between Reception Optical Assembly and Detecting Element

Light incident on the reception optical assembly 1860 from a specific direction may be focused onto a detecting element.

In this case, the point at which the light incident on the reception optical assembly 1860 is focused by the reception optical assembly 1860 may vary depending on the direction of the light incident on the reception optical assembly 1860.

For example, light 1871 incident on the reception optical assembly 1860 from a first direction is focused by the reception optical assembly 1860 onto the point at which a first detecting element 1851 is positioned, and light 1872 incident on the reception optical assembly 1860 in a second direction is focused by the reception optical assembly 1860 onto the point at which a second detecting element 1852 is positioned.

That is, depending on the relative positional relationship between the reception optical assembly 1860 and a detecting element, the incident direction or angle of light incident on the reception optical assembly 1860 that can be focused onto the detecting element may be determined.

For example, when the reception optical assembly 1860 is implemented as a symmetric lens, the angle between the optical axis 1861 of the reception optical assembly 1860 and the incident direction of the light that can be focused onto the detecting element after passing through the reception optical assembly 1860 may be changed in accordance with the distance between the detecting element positioned in the focal plane of the reception optical assembly 1860 and the optical axis 1861 of the reception optical assembly 1860.

As a more specific example, when the reception optical assembly 1860 is implemented as a symmetric lens, as the distance between the detecting element positioned in the focal plane of the reception optical assembly 1860 and the optical axis 1861 of the reception optical assembly 1860 increases, the angle between the optical axis 1861 of the reception optical assembly 1860 and the incident direction of the light that can be focused onto the detecting element after passing through the reception optical assembly 1860 may increase.

Further, for example, when the reception optical assembly 1860 is implemented as a symmetric lens, the incident direction of light that can be focused onto a detecting element after passing through the reception optical assembly 1860 may be changed in accordance with the direction in which the detecting element positioned in the focal plane of the reception optical assembly 1861 is disposed with respect to the optical axis 1861 of the reception optical assembly 1860.

As described above, since the incident direction of the light that can be focused onto a detecting element after passing through the reception optical assembly 1860 may be determined in accordance with the relative positional relationship between the detecting element and the reception optical assembly 1860, when a LiDAR device uses a plurality of detecting elements of which the positional relationships with the reception optical assembly 1860 are different from one another, lights incident from different incident directions can pass through the reception optical assembly 1860 and be focused onto the respective detecting elements.

Therefore, using the detecting element array 1850 and the reception optical assembly 1860 makes it possible to expand the region in which light can be detected.

### Relationship Between Detecting Element Array and Reception Optical Assembly

### Positional Relationship Between Reception Optical Assembly and Detecting Element Array

The detecting element array 1850 may be positioned in a focal plane of the reception optical assembly 1860.

Of course, as needed, the detecting array 1850 may be positioned to have a preset offset from the focal plane of the reception optical assembly 1860, but, for the convenience of description, the explanation is based on the assumption that the detecting element array 1850 is positioned in the focal plane of the reception optical assembly 1860.

Incident Direction of Light That Can Be Focused onto Detecting Element Array after Passing through Reception Optical Assembly, with Respect to Reception Optical Assembly

Light incident on the reception optical assembly 1860 from different directions can pass through the reception optical assembly 1860 and can be focused onto each of a plurality of detecting elements of the detecting element array 1850.

In this case, the incident direction of light that can be focused onto each of the plurality of detecting elements, with respect to the reception optical assembly 1860, is changed in accordance with the relative positional relationship between the reception optical assembly 1860 and each of the plurality of detecting elements.

That is, depending on the relative position between the reception optical assembly 1860 and each of the plurality of detecting elements, the direction of light (incident direction to the reception optical assembly) that each of the plurality of detecting elements can detect may be determined.

For example, the incident direction of light that the first detecting element 1851 included in the detecting element array 1850 can detect, with respect to the reception optical assembly 1860, is determined in accordance with the relative position between the optical axis 1861 of the reception optical assembly 1860 and the first detecting element 1851.

Further, for example, the incident direction of light that the second detecting element 1852 included in the detecting element array 1850 can detect, with respect to the reception optical assembly 1860, is determined in accordance with the relative position between the optical axis 1861 of the reception optical assembly 1860 and the second detecting element 1852.

In other words, light incident on the reception optical assembly 1860 from a specific direction is focused onto a specific detecting element among a plurality of detecting elements, and which detecting element the light is focused onto depends on the direction of the light incident on the reception optical assembly 1860.

This may be described such that the incident direction or the incident angle of light that each of a plurality of detecting elements can detect, with respect to the reception optical assembly 1860, is determined in accordance with the relative position between the reception optical assembly 1860 and each of the plurality of detecting elements.

### Light Detection Region of LiDAR Device

In the present specification, a light detection region of the LiDAR device 1800 is a concept intended to comprehensively describe a space in which light can be detected by the LiDAR device 1800.

In this case, the light detection region of the LiDAR device 1800 may comprise not only a space in which light can be detected by the LiDAR device 1800 at one time point, but also a space in which light can be detected by the LiDAR device 1800 over a predetermined time.

In order to describe a light detection region of the LiDAR device in more detail, reference is made to FIG. 13.

FIG. 13 is a diagram illustrating a light detection region of a LiDAR device.

More specifically, FIG. 13 is a diagram for explaining a light detection region of a LiDAR device by briefly illustrating, for the convenience of description, that light incident on a reception optical assembly from different directions passes through the reception optical assembly and is focused onto each of a plurality of detecting elements of a detecting element array.

Referring to FIG. 13, light incident on the reception optical assembly of the LiDAR device 1880 from different directions passes through the reception optical assembly and is focused onto each of a plurality of detecting elements of the LiDAR device 1880.

That is, a first light 1881 incident on the LiDAR device 1880 from a first direction is focused onto a first detecting element as it passes through the reception optical assembly, a second light 1882 incident from a second direction is focused onto a second detecting element as it passes through the reception optical assembly, a third light 1883 incident from a third direction is focused onto a third detecting element as it passes through the reception optical assembly, and a fourth light 1884 incident from a fourth direction is focused onto a fourth detecting element as it passes through the reception optical assembly.

In this case, referring again to FIG. 13, lights that are focused onto the detecting element array of the LiDAR device 1880 may be understood as being incident on the LiDAR device 1880 within a specific space, and, in other words, a set of lights that is focused onto the detecting element array of the LiDAR device 1880 may be described as being defined as a specific space.

Therefore, in the present specification, a specific space in which lights that are focused onto the detecting element array of the LiDAR device 1880 are incident is described as a light detection region 1885.

That is, in the example illustrated in FIG. 13, a quadrangular pyramid space having the LiDAR device 1880 as its apex may be a light detection region 1845.

In this case, referring again to FIG. 13, a specific space in which lights that are focused onto the detecting element array of the LiDAR device 1880 are incident may be a space having a shape in which the lights converge toward the LiDAR device 1880 as an origin.

That is, lights that are focused onto the detecting element array of the LiDAR device 1880 can be incident on the LiDAR device 1880 from different directions, and accordingly, a specific space in which the lights that are focused onto the detecting element array of the LiDAR device 1880 are incident may be a space having a shape in which the lights converge toward the LiDAR device 1880 as an origin.

Therefore, in order to mathematically describe the above-described light detection region 1885 of the LiDAR device, a coordinate system having the LiDAR device 1880 as an origin may be effectively used.

For example, in order to mathematically describe the size of the above-described light detection region 1885 of the LiDAR device, the angle between lights incident at outermost positions and focused onto the detecting element array on the coordinate system having the LiDAR device 1880 as an origin may be used.

More specifically, in order to mathematically describe the horizontal size of the light detection region 1885, the angle between the direction in which a first light 1881 is incident and the direction in which the second light 1882 is incident on the coordinate system having the LiDAR device 1880 as an origin may be used. Further, in order to mathematically describe the vertical size of the light detection region 1885, the angle between the direction in which the third light 1883 is incident and the direction in which the fourth light 1884 is incident on the coordinate system having the LiDAR device 1880 as an origin may be used.

In this case, in the present specification, an expression of the size of the light detection region 1885 of the LiDAR device in terms of an angle is described as the field of view of the light detection region 1885, and hereinafter, horizontal and vertical fields of view of a light detection region of a solid-state LiDAR device are described in more detail.

### Horizontal and Vertical Fields of View of Light Detection Region of Solid-State LiDAR Device

FIG. 14 is a diagram illustrating horizontal and vertical fields of view of a light detection region of a solid-state LiDAR device.

FIG. 14 illustrates only a detecting element array 2000 and a reception optical assembly 2050 among the components of a solid-state LiDAR device for the convenience of description.

As described above, the laser emission region 2060 of the LiDAR device is defined as a region in which light can be detected by the LiDAR device.

Therefore, the horizontal and vertical fields of view of the light detection region 2060 represent ranges of angles in which light can be detected by the LiDAR device, and may be defined by outermost incident directions among incident directions of light that the LiDAR device can detect, with respect to a reception optical assembly.

In this case, in a solid-state LiDAR device including the detecting element array 2000 and the reception optical assembly 2050, the incident direction or the incident angle of light that each of a plurality of detecting elements can detect, with respect to the reception optical assembly 2050, may be defined by the relative positional relationship between the reception optical assembly 2050 and each of the plurality of detecting elements.

Accordingly, in the solid-state LiDAR device including the detecting element array 2000 and the reception optical assembly 2050, the horizontal field of view of the light detection region 2060 may be defined by a third angle 2061 that is the angle between a first incident direction of light 2011 that is focused onto a first detecting element 2010 disposed at a first end among a plurality of detecting elements arranged in a center row, with respect to the reception optical assembly 2050, and a second incident direction of light 2021 that is focused onto a second detecting element 2020 disposed at a second end, with respect to the reception optical assembly 2050.

Further, in the solid-state LiDAR device including the detecting element array 2000 and the reception optical assembly 2050, the vertical field of view of the light detection region 2060 may be defined by a fourth angle 2062 that is the angle between a third incident direction of light 2031 that is focused onto a third detecting element 2030 disposed at a third end among a plurality of detecting elements arranged in a center column, with respect to the reception optical assembly 2050, and a fourth incident direction of light that is focused onto a fourth detecting element 2040 disposed at a fourth end, with respect to the reception optical assembly 2050.

### Angle of View of LiDAR Device

As described above, since a LiDAR device is a device for measuring a distance between the LiDAR device and a target using a laser, a LiDAR device can measure a distance between the LiDAR device and a target only when the following conditions are satisfied.
i) a target is located in a region to which a laser output from the LiDAR device is directed
ii) a laser reflected from a target is received by a detecting element of a LiDAR device

Therefore, a measurable region of a LiDAR device becomes a region in which the above-described laser emission region of the LiDAR device and the above-described light detection region of the LiDAR device overlap with each other.

In this case, the field of view of the LiDAR device is a concept representing the measurable region of the LiDAR device as an angle with respect to a predetermined origin.

Further, in this case, in general, in manufacturing a LiDAR device, the LiDAR device is manufactured such that the laser emission region of the LiDAR device and the light detection region of the LiDAR device are aligned with each other at a predetermined distance.

Therefore, the field of view of the LiDAR device may be defined by vertical and horizontal fields of view of the laser emission region described above, and may also be defined by vertical and horizontal fields of view of the light detection region described above.

Although omitted in FIG. 10, the LiDAR device 1800 disclosed by the present disclosure may further comprise a band pass filter.

### Band Pass Filter

A band pass filter is configured to transmit only light in a specific wavelength band.

In this case, a transmission band of the band pass filter is configured to comprise the wavelength band of a laser that is output from a laser emitting element.

Further, in this case, the band pass filter may be positioned inside a reception optical assembly, and more specifically, may be positioned between a plurality of lenses constituting the reception optical assembly.

Further, in this case, the band pass filter may also be positioned outside the reception optical assembly, and may be positioned between the reception optical assembly and a detecting element array.

### [Optical Connection Between Laser Emitting Element Array and Detecting Element Array]

### Definition of Optical Connection

As described above, respective ones of a plurality of lasers output from a plurality of laser emitting elements of a laser emitting element array may be collimated and steered as passing through a transmission optical assembly to be directed in different directions, and light incident from different directions with respect to a reception optical assembly can pass through the reception optical assembly and be focused onto each of a plurality of detecting elements of a detecting element array.

In this case, a LiDAR device may be configured such that a laser output from a specific laser emitting element of a laser emitting element array is directed in a specific direction while passing through a transmission optical assembly, and when the laser is reflected from a target located at a predetermined distance from the LiDAR device, the laser is focused onto a specific detecting element of a detecting element array through a reception optical assembly.

In the present specification, the relationship between the specific laser emitting element and the specific detecting element described above is described as a relationship in which the specific laser emitting element and the specific detecting element are optically connected to each other.

That is, in the present specification, a laser emitting element and a detecting element are defined as being optically connected to each other when they have a relationship in which a laser emission direction and a light detecting direction, which are defined in accordance with the relationships among optical configurations of a LiDAR device, are matched with each other.

### Various Optical Connection Relationships Between Laser Emitting Element Array and Detecting Element Array

A LiDAR device may be configured such that a plurality of laser emitting elements of a laser emitting element array and a plurality of detecting elements of a detecting element array are optically connected to each other, and in this case, the optical connection relationships between the plurality of laser emitting elements and the plurality of detecting elements may be various.

For example, a LiDAR device may be configured such that one laser emitting element is optically connected with one detecting element.

That is, a LiDAR device may be configured such that each of a plurality of laser emitting elements of a laser emitting element array is optically connected to each of a plurality of detecting elements of a detecting element array.

As a more specific example of the configuration of a LiDAR device, when a plurality of laser emitting elements of a laser emitting element array is arranged in a two-dimensional array comprising M rows and N columns, and a plurality of detecting elements of a detecting element array is arranged in a two-dimensional array comprising M rows and N columns, the laser emitting element located at (X, Y) may be optically connected with the detecting element located at (X, Y).

Further, for example, a LiDAR device may be configured such that one laser emitting element is optically connected with a plurality of detecting elements.

That is, a LiDAR device may be configured such that each of a plurality of laser emitting elements of a laser emitting element array is optically connected with each of some groups of a plurality of detecting elements of a detecting element array.

As a more specific example of the configuration of a LiDAR device, when a plurality of laser emitting elements of a laser emitting element array is arranged in a two-dimensional array comprising M rows and N columns, and a plurality of detecting elements of a detecting element array is arranged in a two-dimensional array comprising 3M rows and 3N columns, one laser emitting element may be optically connected with nine detecting elements.

Further, for example, a LiDAR device may be configured such that a plurality of laser emitting elements is optically connected with one detecting element.

That is, a LiDAR device may be configured such that each of some groups of a plurality of laser emitting elements of a laser emitting element array is optically connected with each of a plurality of detecting elements of a detecting element array.

As a more specific example of the configuration of a LiDAR device, when a plurality of laser emitting elements of a laser emitting element array is arranged in a two-dimensional array including 3M rows and 3N columns, and a plurality of detecting elements of a detecting element array is arranged in a two-dimensional array including M rows and N columns, nine laser emitting elements may be optically connected with one detecting element

Further, for example, a LiDAR device may be configured such that a plurality of laser emitting elements is optically connected with a plurality of detecting elements.

That is, a LiDAR device may be configured such that each of some groups of a plurality of laser emitting elements of a laser emitting element array is optically connected with each of some groups of a plurality of detecting elements of a detecting element array.

As a more specific example of the configuration of a LiDAR device, when a plurality of laser emitting elements of a laser emitting element array is arranged in a two-dimensional array including A×M rows and B×N columns, and a plurality of detecting elements of a detecting element array is arranged in a two-dimensional array including C×M rows and D×N columns, A×B laser emitting elements may be optically connected with C×D detecting elements.

### [LiDAR Data]

### Definition of LiDAR Data

Through FIGS. 1 to 8, a process in which a histogram is generated through a series of operations of one laser emitting element and one detecting element that are optically connected with each other has been described, and further, through the generated histogram, how an echo signal is determined, how a distance to a target is estimated, and how a reflection intensity of a laser with respect to a target is estimated have been described in detail.

Meanwhile, it has been described that laser emitting elements may be provided in array form and detecting elements may also be provided in array form, and it has also been described in detail that, in this case, each of the laser emitting elements has its own unique orientation, and further, each of the detecting elements also has its own unique orientation, and at least one laser emitting element and at least one detecting element may be optically connected.

As a result, in a LiDAR in which laser emitting elements and detecting elements are both implemented in array form, a laser emitting element and a detecting element that are optically connected with each other may be conceptually defined as one laser-detector pair or one laser-detector set.

In the present specification, a set of a histogram, an echo signal, a distance, and/or a reflection intensity acquired by each laser-detector pair during a predetermined very short time is defined as LiDAR data.

In this case, when LiDAR data acquired by all laser-detector pairs are interpreted, information on a specific scene within the field of view of a LiDAR device (hereinafter, information on the specific scene obtained through analysis of LiDAR data may be referred to as frame information) may be acquired, and a temporal resolution of information on scenes within the field of view of the LiDAR device (for example, frames per second (fps)) may be controlled by controlling an LiDAR data acquisition cycle.

Hereinafter, LiDAR data is described in more detail.

### Configuration of LiDAR Data

FIG. 15 is a diagram illustrating LiDAR data disclosed by the present disclosure.

Referring to FIG. 15, LiDAR data 2100 disclosed through the present disclosure comprises a plurality of pixel position coordinates 2110 and at least one pixel value 2120 corresponding to the plurality of pixel position coordinates 2110.

In this case, LiDAR data 2100 disclosed through the present disclosure may be generated or output on a per-frame basis, and the following descriptions are made on the basis of LiDAR data 2100 of one frame.

Definition of Pixel and Relationship between Pixel and Detecting Element Array

As described above, in the present specification, LiDAR data 2100 is described as a set of pixel values corresponding to of a plurality of pixels, respectively. In general, a pixel is a concept used in the display field, and similarly to the concept used in the display field, pixels may be distinguished from each other by coordinate values corresponding to the respective pixels, and in the present specification, as the coordinates of pixels, coordinates that may be defined within a detecting element array of detecting elements used to acquire pixel values corresponding to the pixels are used.

For example, a first coordinate of a first detecting element is different from a second coordinate of a second detecting element.

In this case, one pixel value may be acquired from one detecting element (a single detecting device), but one pixel value may be acquired from a plurality of detecting elements. Hereinafter, for the convenience of description, whether a pixel value is acquired from one detecting element or from a plurality of detecting elements is not clearly distinguished.

### Pixel Position Coordinates

In general, a detecting element array may be implemented in grid form in which the coordinates of detecting elements have rows and columns, and in this case, the coordinates of one detecting element may be defined by a row number of the row to which the detecting element belongs and a column number of the column to which the detecting element belongs.

For example, in a detecting element array implemented in grid form including M rows and N columns, when a specific detecting element is disposed in an x-th row and a y-th column, the coordinates of the specific detecting element may be defined as (x, y), and pixel coordinates corresponding to a pixel value acquired from the specific detecting element may be used as (x, y).

Of course, in this case, as pixel coordinates, coordinate values converted on the basis of the coordinates of a detecting element may also be used. For example, when the position of a detecting element and the direction in which light received by the detecting element is incident on the above-described reception optical assembly are inverted with respect to each other by the reception optical assembly, the pixel position coordinates of a first pixel corresponding to a first detecting element located at (1, 1) in the detecting element array may be used as (M, N), and the pixel position coordinates of an M×N-th pixel corresponding to an M×N-th detecting element located at (M, N) in the detecting element array may be used as (1, 1).

### Pixel Value

Referring again to FIG. 15, at least one pixel value 2120 constituting the LiDAR data 2100 may comprise any one of a histogram 2121, an echo signal 2122, a distance 2123, a reflection intensity 2124, or a representative counting value 2125.

In this case, the histogram 2121 of a specific pixel of the LiDAR data 2100 may be generated on the basis of an electrical signal output from a detecting element corresponding to the specific pixel, and since the above-described matters may be applied regarding this, redundant descriptions are omitted.

Further, in this case, the echo signal 2122 of the specific pixel of the LiDAR data 2100 may be generated on the basis of the histogram for the detecting element corresponding to the specific pixel, and since the above-described matters may be applied regarding this, redundant descriptions are omitted.

Further, in this case, the distance 2123 of the specific pixel of the LiDAR data 2100 may be measured on the basis of the echo signal generated on the basis of the histogram for the detecting element corresponding to the specific pixel, and since the above-described matters may be applied regarding this, redundant descriptions are omitted.

Further, in this case, the reflection intensity 2124 of the specific pixel of the LiDAR data 2100 may be estimated on the basis of the echo signal generated on the basis of the histogram for the detecting element corresponding to the specific pixel, and since the above-described matters may be applied regarding this, redundant descriptions are omitted.

Further, in this case, the representative counting value 2125 of the specific pixel of the LiDAR data 2100 may be generated on the basis of the histogram for the detecting element corresponding to the specific pixel, and may be estimated on the basis of the echo signal generated on the basis of the histogram.

For example, the representative counting value 2125 may be acquired as a maximum counting value and an average counting value, or the like among counting values included in the histogram or the echo signal.

### Specific Examples of LiDAR Data (Types of LiDAR Data)

The LiDAR data 2100 may be distinguished depending on what the above-described pixel value is.

For example, when the pixel value 2120 is a distance, LiDAR data may be referred to as a distance map or a depth map.

Further, as another example, when the pixel value 2120 is a reflection intensity, LiDAR data may be referred to as a reflection intensity map or an intensity map.

Further, as another example, when the pixel value 2120 is an echo signal, LiDAR data may be referred to as an echo signal map.

Further, as another example, when the pixel value 2120 is a counting value, LiDAR data may be referred to as a counting value map.

Further, the LiDAR data 2100 may be variously distinguished in accordance with the above-described pixel values in addition to the above-described examples.

Hereinafter, frame information that can be obtained from LiDAR data is described in more detail.

### [Frame Information]

### Definition of Frame Information

As described above, a LiDAR device outputs a laser around the LiDAR device and detects a laser reflected from a target, thereby measuring a distance to the target located around the LiDAR device. Therefore, in the LiDAR device, distances to points at which a target is located can be measured.

Accordingly, in the present specification, frame information, which is a set of data regarding points at which a target whose distance is measured by the LiDAR device is located, and is described as information about a specific scene within the field of view of the LiDAR device that is obtained through analysis of LiDAR data, and the like.

### Types of Frame Information

Frame information comprises a point cloud that is a set of position coordinates regarding points at which a target, whose distance is measured by the LiDAR device, is located, and comprises an enhanced point cloud that further comprises information related to the points in addition to the position coordinates.

Of course, the point cloud and the enhanced point cloud are concepts that are separated for the convenience of description, and in the present specification, data that further comprises information related to points in addition to position coordinates may be expressed as a point cloud.

Hereinafter, a point cloud and an enhanced point cloud are described in greater detail.

### Point Cloud

### Point Data of a Point Cloud

FIG. 16 is a diagram illustrating a point cloud disclosed by the present disclosure.

As described above, a point cloud 2200, which is one type of frame information, refers to a set of position coordinates regarding points at which a target, whose distance is measured by the LiDAR device, is located.

Accordingly, in the present specification, data regarding each point of the point cloud 2200 is described as point data.

Accordingly, the point cloud 2200 illustrated in FIG. 16 may be described as including first point data 2211 regarding a first point and K-th point data 2212 regarding a K-th point.

### Position Coordinates of Point Data

As illustrated in FIG. 16, each point data of the point cloud 2200 includes position coordinates 2220.

In this case, the position coordinates 2200 of the point data are generally represented using a coordinate system based on an optical origin of a LiDAR device.

For example, in FIG. 16, the position coordinates 2220 of each point data of the point cloud 2200 are represented using a Cartesian coordinate system based on an optical origin of a LiDAR device.

Of course, the coordinate system used to represent the position coordinates 2200 of the point data may be a cylindrical coordinate system, a spherical coordinate system, and the like, and may be various other coordinate systems in addition to the Cartesian coordinate system illustrated in FIG. 16.

### Relationship Between Point Cloud and LiDAR Data

As described above, the point cloud 2200 is one type of frame information, and the frame information is information about a specific scene within the field of view of a LiDAR device obtained through analysis of LiDAR data, and the like.

Therefore, the point cloud 2200 may be acquired on the basis of LiDAR data.

More specifically, the point cloud 2200 may be acquired on the basis of pixels in which a target is detected among the pixels included in LiDAR data.

In this case, the pixels in which a target is detected may refer to pixels having a distance value as a pixel value, and having a distance value may mean that a distance to a target has been measured.

Further, in this case, position coordinates 2220 of each point data included in the point cloud 2200 may be acquired on the basis of pixel coordinates of pixels included in LiDAR data and corresponding distance values.

More specifically, the point cloud 2200 may be acquired by specifying pixels in which a target is detected among the pixels included in LiDAR data, and acquiring the point cloud using pixel coordinates of the specified pixels and corresponding distance values.

Hereinafter, a process of acquiring position coordinates 2220 of point data on the basis of LiDAR data is described in more detail.

As described above, each laser-detector set has its own unique orientation, and accordingly, a distance value of a pixel corresponding to a laser-detector set may represent a distance to a target located in the unique orientation of the laser-detector set.

Therefore, a LiDAR device can store information on directions corresponding to respective pixel position coordinates of LiDAR data.

For example, the first pixel position coordinates (1,1) and a first direction vector (θ_1, φ_1) may be matched and stored, and the K-th pixel location coordinate (M,N) and a K-th direction vector (θ_M, φ_N) may be matched and stored.

Accordingly, the position coordinates 2220 of point data included in the point cloud 2200 may be acquired on the basis of the pixel coordinates of pixels included in LiDAR data, direction information matched and stored with respective pixel coordinates, and distance values corresponding to the direction information.

For example, a first position coordinate (X_1, Y_1, Z_1) of the first point data 2211 may be acquired on the basis of a first direction vector (θ_1, φ1) matched and stored with (1, 1) that are the position coordinates of a first pixel corresponding to the first point data, and a first distance value R_1 corresponding to the first pixel.

Further, when a point cloud is acquired on the basis of pixels in which a target is detected among the pixels in LiDAR data, the number of pixels included in the LiDAR data and the number of point data included in the point cloud may differ from each other.

That is, this may be because the number of the pixels included in LiDAR data corresponds to the number of the detecting elements in a detecting element array regardless of whether a pixel value is acquired or whether a distance is measured, whereas the number of the point data included in a point cloud may be acquired on the basis of pixels in which a distance value is acquired among the pixels included in the LiDAR data.

### Enhanced Point Cloud

### Enhanced Point Cloud and Enhanced Point Data

FIG. 17 is a diagram illustrating an enhanced point cloud disclosed by the present disclosure.

As described above, an enhanced point cloud 2300, which is one type of frame information, refers to a set of position coordinates regarding points at which a target, whose distance is measured by the LiDAR device, is located, and information related to the points.

Accordingly, in the present specification, data including position coordinates for each point of the enhanced point cloud 2300 and information related to the points matched thereto is described as enhanced point data.

In this case, since the above-described matters regarding the position coordinates of the point data may be applied to the position coordinates of enhanced point data, redundant descriptions are omitted.

Further, in this case, information related to a point is described as a point value 2330.

Therefore, each enhanced point data included in the enhanced point cloud 2300 comprises position coordinates and a point value 2330 matched to the position coordinates.

In this case, the point value 2330 included in the enhanced point data may be one as illustrated in FIG. 17, but is not limited thereto and may be plural.

Hereinafter, point values 2330 included in enhanced point data are described in more detail.

### Point Value of Enhanced Point Data

A point value 2330 of enhanced point data may be acquired on the basis of LiDAR data.

For example, the point value 2330 of enhanced point data may be used as pixel values of a plurality of pixels of LiDAR data.

As a more specific example, the point value 2330 of enhanced point data may be any one of a histogram, an echo signal, a distance, a reflection intensity, or a representative counting value of a corresponding pixel.

Further, for example, the point value 2330 of enhanced point data may be a value obtained by processing pixel values of a plurality of pixels of LiDAR data.

As a more specific example, the point value 2330 of enhanced point data may be a value obtained by performing processing, such as assigning a weight to any one of a histogram, an echo signal, a distance, a reflection intensity, or a representative counting value of a corresponding pixel.

As another more specific example, the point value 2330 of enhanced point data may be a value obtained by adjusting any one of a histogram, an echo signal, a distance, a reflection intensity, or a representative counting value of a corresponding pixel in consideration of pixel values of surrounding pixels.

Further, the point value 2330 of enhanced point data may be acquired on the basis of a point cloud.

For example, the point value 2330 of enhanced point data may be a normal vector value with respect to a virtual plane calculated in consideration of the position coordinates of corresponding point data and the position coordinates of surrounding point data.

Further, for example, the point value 2330 of enhanced point data may be a value obtained by adjusting the position coordinates of corresponding point data in consideration of the position coordinates of surrounding point data.

### [Operation Timing of LiDAR Device for Generating LiDAR Data]

### Histogram Acquisition Period

It has already been described above that pixel values of corresponding pixels are acquired by an operation of a laser-detector pair (a plurality of sampling cycles).

In the present specification, a period in which a histogram is acquired by performing a plurality of sampling cycles for one laser-detector pair is described as a histogram acquisition period.

Of course, the histogram acquisition period may be expressed as a distance acquisition period, a pixel value acquisition period, or the like but hereinafter is expressed as a histogram acquisition period in order to clarify the description.

In this case, the lengths of histogram acquisition periods of all laser-detector pairs may be identical, but are not limited thereto, and the lengths of histogram acquisition periods of some laser-detector pairs may be different.

### Necessity of Operation Timing Control of LiDAR Device

As described above, LiDAR data is a set of pixel values acquired by respective laser-detector pairs during a predetermined very short time, and frame information is information about a specific scene obtained through analysis of LiDAR data, and the like.

Accordingly, LiDAR data or frame information is acquired after undergoing the histogram acquisition periods for all laser-detector pairs. Of course, LiDAR data or frame information in which only a portion of an entire scene is specified as a specific scene may be acquired using the pixels for some laser-detector pairs; however, for the convenience of description, LiDAR data or frame information is described under the assumption that it is acquired after undergoing the histogram acquisition periods for all laser-detector pairs.

In this case, the operation timings of all laser-detector pairs may be related to a frame rate, interference, a measurable distance, eye safety, and the like, and thus may become strategic design matters of a LiDAR device.

### Various Examples of Operation Timing of LiDAR Device

According to a first example of operation timing of a LiDAR device, the histogram acquisition periods for all laser-detector pairs are different from each other.

This means that, after the histogram acquisition period for one laser-detector pair elapses, an operation for histogram acquisition for another laser-detector pair is performed.

However, in this case, the histogram acquisition periods for all laser-detector pairs may partially overlap each other.

Further, according to the first example of operation timing of a LiDAR device, an arrangement of the histogram acquisition periods for all laser-detector pairs may follow a preset order.

Of course, an arrangement of the histogram acquisition periods for all laser-detector pairs may be randomly determined.

Further, according to the first example of operation timing of a LiDAR device, arrangements of the histogram acquisition periods for all laser-detector pairs for acquiring LiDAR data of each frame may be identical to each other.

For example, an arrangement of the histogram acquisition periods for all laser-detector pairs for acquiring first LiDAR data of a first frame may be identical to an arrangement of histogram acquisition periods for all laser-detector pairs for acquiring second LiDAR data of a second frame.

Of course, arrangements of the histogram acquisition periods for all laser-detector pairs for acquiring LiDAR data of each frame may be different from each other.

For example, the arrangement of the histogram acquisition periods for all laser-detector pairs for acquiring the first LiDAR data of the first frame may be different from the arrangement of the histogram acquisition periods for all laser-detector pairs for acquiring the second LiDAR data of the second frame.

Further, according to a second example of operation timing of a LiDAR device, the histogram acquisition periods for the laser-detector pairs of a partial group among all laser-detector pairs are identical to each other, but are different from the histogram acquisition periods for the laser-detector pairs of another group.

This means that, after the histogram acquisition periods for the laser-detector pairs of a partial group elapses, an operation for histogram acquisition for the laser-detector pairs of another group of is performed.

However, in this case, the fact that the histogram acquisition periods for the laser-detector pairs of a partial group are identical to each other comprises not only that the laser-detector pairs of the partial group operate at a physically completely identical timing, but also that the laser-detector pairs of the partial group operate at timings that are physically slightly different but substantially identical.

In this case, the laser-detector pairs of a partial group may be various.

For example, the laser-detector pairs of a partial group may comprise laser-detector pairs arranged in a single row.

Further, for example, the laser-detector pairs of a partial group may comprise laser-detector pairs arranged in a single column.

Further, for example, the laser-detector pairs of a partial group may comprise laser-detector pairs arranged in two or more rows.

Further, for example, the laser-detector pairs of a partial group may include laser-detector pairs arranged in two or more columns.

Further, in addition to the examples described above, the laser-detector pairs of a partial group may be variously grouped.

However, hereinafter, for the convenience of description, it is assumed and described that the laser-detector pairs of a partial group include laser-detector pairs arranged in a single row.

Further, according to the second example of operation timing of a LiDAR device, an arrangement of the histogram acquisition periods for the laser-detector pairs of all groups may follow a preset order.

Of course, an arrangement of the histogram acquisition periods for the laser-detector pairs of all groups may be randomly determined.

Further, according to the second example of operation timing of a LiDAR device, arrangements of the histogram acquisition periods for the laser-detector pairs of all groups for acquiring LiDAR data of each frame may be identical to each other.

For example, an arrangement of the histogram acquisition periods for the laser-detector pairs of all groups for acquiring first LiDAR data of a first frame may be identical to an arrangement of histogram acquisition periods for the laser-detector pairs of all groups for acquiring second LiDAR data of a second frame.

Of course, arrangements of the histogram acquisition periods for the laser-detector pairs of all groups for acquiring LiDAR data of each frame may be different from each other.

For example, the arrangement of the histogram acquisition periods for the laser-detector pairs of all groups for acquiring the first LiDAR data of the first frame may be different from the arrangement of histogram acquisition periods for the laser-detector pairs of all groups for acquiring the second LiDAR data of the second frame.

Further, according to a third example of operation timing of a LiDAR device, the histogram acquisition periods for all laser-detector pairs are identical each other.

This means that operations for histogram acquisition for all laser-detector pairs are performed simultaneously.

However, in this case, that the operations for histogram acquisition for all laser-detector pairs are performed simultaneously comprises not only that all laser-detector pairs operate at a physically completely identical timing, but also that all laser-detector pairs operate at timings that are physically slightly different but substantially identical.

### II. Problems Occurring in LiDAR Device Located in Space Having Optical Window on One Side

### [Reason Why LiDAR Device Is Located in Space Having Optical Window on One Side]

As described above, a LiDAR device is a device for measuring a distance between the LiDAR device and a target using a laser.

Such a LiDAR device is used to measure distances to targets located around in various industrial fields, such as autonomous vehicles, unmanned mobile objects, drones, industrial facilities, and security facilities.

when a LiDAR device is used in actual industrial fields, the LiDAR device is often positioned in a space having an optical window that transmits light on one side for reasons of exterior design of a moving object or a facility, or is positioned in a space having an optical window that transmits light on one side for reasons such as protection of the LiDAR device.

### [Problems Occurring When LiDAR Device Is Located in Space Having Optical Window on One Side]

Reception Issue of Laser Reflected from Optical Window (Back-Beam Issue)

FIG. 18 is a diagram illustrating a problem that occurs when a LiDAR device is located in a space having an optical window on one side.

For the convenience of description, FIG. 18 illustrates a LiDAR device 3000 and a space 3050 having an optical window 3051 on one side.

In this case, the LiDAR device 3000 includes a laser output element array 3010, a transmission optical assembly 3030, a detecting element array 3020, and a reception optical assembly 3040, and since the above-described matters may be applied regarding each configuration, redundant descriptions are omitted.

Referring again to FIG. 18, lasers output from the laser output element array 3010 included in the LiDAR device 3000 and steered by the transmission optical assembly may be reflected from or scattered by the optical window 3051.

This is because, even if the optical window 3051 is configured to transmit light, the optical window 3051 cannot transmit 100% of incident light because it is made of a material, and thus it inevitably reflects or scatters at least a portion of incident light.

Referring again to FIG. 18, a portion 3061 of lasers 3060 reflected from the optical window 3051 may reach a reception optical assembly 3040.

In this case, among the lasers that reach the reception optical assembly 3040, some may be delivered to the detecting element array 3020.

As lasers are delivered to a detecting element array 3020, an electrical signal is output from the detecting element array 3020, and a counting value on a histogram is generated on the basis of the electrical signal output from the detecting element array 3020.

In this case, since the above-described matters may be applied to the output of an electrical signal from the detecting element array 3020 and the generation of a counting value on the histogram, redundant descriptions are omitted.

However, when a target is located at a short distance from the LiDAR device 3000, a counting value generated by lasers reflected from the target and a counting value generated by lasers reflected from the optical window 3051 are positioned at identical or similar time bins on the histogram.

That is, when a target is located at a short distance from the LiDAR device 3000, it may be difficult to distinguish whether a counting value on a histogram is a counting value caused by lasers reflected from the target or a counting value caused by lasers reflected from the optical window 3051.

Therefore, as in the situation described with reference to FIG. 18, the lasers reflected from the optical window 3051 reach the reception optical assembly 3040 and are delivered to the detecting element array 3020 interferes with determining a distance value for a target located at a short distance.

### Reason Why Installing Blocking Element Does Not Solve Problems

In order to solve the above-described problems, adding a blocking element between a transmission optical assembly and a reception optical assembly of a LiDAR device may be considered.

However, adding a blocking element between a transmission optical assembly and a reception optical assembly is unlikely to serve as an solution for solving the above-described problems, and this is described in more detail with reference to FIG. 19.

FIG. 19 is a diagram illustrating a scenario in which a blocking element is further provided between a transmission optical assembly and a reception optical assembly when a LiDAR device is located in a space having an optical window on one side.

For the convenience of description, FIG. 19 illustrates a LiDAR device 3100 and a space 3151 having an optical window 3150 on one side.

In this case, the LiDAR device 3100 comprises a laser output element array 3110, a transmission optical assembly 3130, a detecting element array 3120, and a reception optical assembly 3140, and since the above-described matters may be applied regarding each configuration, redundant descriptions are omitted.

Referring again to FIG. 19, lasers output from the laser output element array 3110 comprised in the LiDAR device 3100 and steered by the transmission optical assembly may be reflected from the optical window 3151.

This is because, even if the optical window 3151 is configured to transmit light, the optical window 3151 cannot transmit 100% of incident light because it is made of a material, and thus it inevitably reflects at least a portion of incident light.

Referring again to FIG. 19, a portion 3161 of lasers 3160 reflected from the optical window 3151 is reflected toward the reception optical assembly 3140, but is blocked by a blocking element 3170 and thus does not reach the reception optical assembly 3140.

However, another portion 3162 of the lasers 3160 reflected from the optical window 3151 may be reflected from sidewalls constituting the space 3150 and eventually reach the reception optical assembly 3140.

In this case, among the lasers that reach the reception optical assembly 3140, some may be delivered to the detecting element array 3120.

Therefore, the same problem as the problem occurring when a LiDAR device is located in a space having an optical window on one side, described above with reference to FIG. 18, still occurs.

That is, a blocking element 3170 positioned between the transmission optical assembly 3130 and the reception optical assembly 3140 can block lasers reflected from the optical window 3151 toward the reception optical assembly 3140, but cannot block lasers reflected from the sidewalls constituting the space 3150 and reaching the reception optical assembly 3140, and thus is unlikely to serve as a solution to the above-described problem.

Hereinafter, an adapter for solving the above-described problems and a LiDAR device including the adapter are described in more detail.

### III. LiDAR Device Including Adapter According to One Embodiment

### [Configuration of LiDAR Device Including Adapter]

FIG. 20 is a block diagram illustrating a LiDAR device equipped with an adapter according to an embodiment.

Referring to FIG. 20, a LiDAR device 3200 including an adapter according to an embodiment includes a laser output element array 3210, a detecting element array 3220, a transmission optical assembly 3230, a reception optical assembly 3240, and an adapter 3250.

In this case, since the above-described matters may be applied regarding the laser output element array 3210, the detecting element array 3220, the transmission optical assembly 3230, and the reception optical assembly 3240, redundant descriptions are omitted.

Further, in this case, the adapter 3250 is described in more detail below.

### [Adapter]

### Function of Adapter

The adapter 3250 is configured to separate, when the LiDAR device 3200 is located in a space having an optical window on one side, an optical path from the transmission optical assembly 3230 of the LiDAR device 3200 to the optical window and an optical path from the optical window to the reception optical assembly 3240 of the LiDAR device 3200.

The structure of the adapter 3250 is described in more detail with reference to FIG. 21.

FIG. 21 is a diagram illustrating the structure of an adapter according to an embodiment.

### Structure of Bottom Side of Adapter

FIG. 21A is a diagram illustrating the structure of the bottom side of an adapter according to an embodiment.

Referring to FIG. 21A, a bottom side 3260 of an adapter 3250 according to an embodiment comprises a first aperture 3261 and a second aperture 3262.

### Definition of Aperture

In this case, the above-described aperture may mean a space surrounded and defined by a side surface, and may comprise a concept commonly understood as an aperture.

### Relationship Between Shape and Size of Aperture and Shape and Size of Optical Assembly

Further, in this case, the shape and size of the first aperture 3261 correspond to the shape and size of a cross-section of the transmission optical assembly 3230 of the LiDAR device 3200.

For example, when the shape of the cross-section of the transmission optical assembly 3230 is circular, the shape of the first aperture 3261 may be circular, and when the shape of the cross-section of the transmission optical assembly 3230 is rectangular, the shape of the first aperture 3261 may be rectangular.

Further, for example, when the shape of the cross-section of the transmission optical assembly 3230 is circular, the diameter of the first aperture 3261 and the diameter of the shape of the cross-section of the transmission optical assembly 3230 may correspond to each other.

Accordingly, the first aperture 3261 allows the transmission optical assembly 3230 to be inserted, and allows at least a portion of the transmission optical assembly 3230 to come into close contact with the side surface surrounding the first aperture 3261.

As described above, the transmission optical assembly 3230 being inserted through the first aperture 3261 and being in close contact with the side surface surrounding the first aperture 3261 prevents light from escaping between the first aperture 3261 and the transmission optical assembly 3230.

In this case, a cross-section of the transmission optical assembly 3230 means a cross-section obtained by cutting the transmission optical assembly 3230 by a virtual plane perpendicular to the optical axis of the transmission optical assembly 3230.

Further, in this case, the shape and size of the second aperture 3262 correspond to the shape and size of a cross-section of the reception optical assembly 3240 of a LiDAR device 3200.

For example, when the shape of the cross-section of the reception optical assembly 3240 is circular, the shape of the second aperture 3262 may be circular, and when the shape of the cross-section of the reception optical assembly 3240 is rectangular, the shape of the second aperture 3262 may be rectangular.

Further, for example, when the shape of the cross-section of the reception optical assembly 3240 is circular, the diameter of the second aperture 3262 and the diameter of the shape of the cross-section of the reception optical assembly 3240 may correspond to each other.

Accordingly, the second aperture 3262 allows the reception optical assembly 3240 to be inserted, and allows at least a portion of the reception optical assembly 3240 to come into close contact with the side surface surrounding the second aperture 3262.

As described above, the reception optical assembly 3240 being inserted through the second aperture 3262 and being in close contact with the side surface surrounding the second aperture 3262 prevents light from escaping between the second aperture 3262 and the reception optical assembly 3240.

In this case, a cross-section of the reception optical assembly 3240 means a cross-section obtained by cutting the reception optical assembly 3240 by a virtual plane perpendicular to the optical axis of the reception optical assembly 3240.

### Relationship Between Distance Between First and Second Apertures and Distance Between Optical Axes of Transmission and Reception Optical Assemblies

Further, in this case, the distance between the center of the first aperture 3161 and the center of the second aperture 3262 corresponds to the distance between the optical axis of the transmission optical assembly 3230 and the optical axis of the reception optical assembly 3240 of the LiDAR device 3200.

For example, the distance in a direction along the x-axis between the center of the first aperture 3161 and the center of the second aperture 3262 corresponds to the distance in a direction along the x-axis between the optical axis of the transmission optical assembly 3230 and the optical axis of the reception optical assembly 3240 of the LiDAR device 3200.

Further, in this case, the minimum distance between the first aperture 3161 and the second aperture 3162 corresponds to the minimum distance between the transmission optical assembly 3230 and the reception optical assembly 3240 of the LiDAR device 3200.

For example, the minimum distance in the x-axis direction between the first aperture 3161 and the second aperture 3162 corresponds to the minimum distance in the x-axis direction between the transmission optical assembly 3230 and the reception optical assembly 3240 of the LiDAR device 3200.

### Structure of Top Side of Adapter

FIG. 21B is a diagram illustrating the structure of the top side of an adapter according to an embodiment.

More specifically, FIG. 21B is a diagram illustrating an adapter obtained by rotating the adapter illustrated in FIG. 21A by 180 degrees about the y-axis.

Referring to FIG. 21B, a top side 3270 of an adapter 3250 according to an embodiment comprises a third aperture 3271 and a fourth aperture 3272.

In this case, the above-described aperture may mean a space surrounded and defined by a side surface, and may comprise a concept commonly understood as an aperture.

Further, in this case, as illustrated in FIG. 21, the shape of the third aperture 3271 may correspond to the shape of the first aperture 3261, but is not limited thereto, and may have various shapes different from the shape of the first aperture 3261.

Further, in this case, as illustrated in FIG. 21, the shape of the fourth aperture 3272 may correspond to the shape of the second aperture 3262, but is not limited thereto, and may have various shapes different from the shape of the second aperture 3262.

In this case, as illustrated in FIG. 21, the size of the third aperture 3271 may correspond to the size of the first aperture 3261, but is not limited thereto, and may be different from the size of the first aperture 3261.

Further, in this case, as illustrated in FIG. 21, the size of the fourth aperture 3272 may correspond to the size of the second aperture 3262, but is not limited thereto, and may be different from the size of the second aperture 3262.

Further, in this case, as illustrated in FIG. 21, the distance between the center of the third aperture 3171 and the center of the fourth aperture 3272 may correspond to the distance between the center of the first aperture 3161 and the center of the second aperture 3262, but is not limited thereto, and may be different from the distance between the center of the first aperture 3161 and the center of the second aperture 3262.

Further, in this case, as illustrated in FIG. 21, the minimum distance between the third aperture 3171 and the fourth aperture 3172 may correspond to the minimum distance between the first aperture 3161 and the second aperture 3162, but is not limited thereto, and may be different from the minimum distance between the first aperture 3161 and the second aperture 3162.

### Structure of First Optical Pathway and Second Optical Pathway of Adapter

FIG. 21C is a diagram illustrating a first optical pathway and a second optical pathway of an adapter according to an embodiment.

More specifically, FIG. 21C is a diagram illustrating a cross-section of an adapter obtained by rotating the adapter illustrated in FIG. 21A by 90 degrees about the x-axis such that the bottom side of the adapter is positioned below and the top side is positioned above.

Referring to FIG. 21C, an adapter 3250 according to an embodiment may include a first optical pathway 3281 and a second optical pathway 3282.

In this case, the above-described optical pathway may refer to a space surrounded and defined by at least one side surface, through which light enters and exits, and may comprise a concept commonly understood as an optical pathway.

For example, the first optical pathway 3281 may be a space surrounded by a first sidewall 3291 forming a first side surface and may be a pathway through which light enters through an inlet and exits through an outlet.

Further, for example, the second optical pathway 3282 may be a space surrounded by a second sidewall 3292 forming a second side surface and may be a pathway through which light enters through an inlet and exits through an outlet.

In this case, at least one sidewall surrounding the first optical pathway 3281 does not allow light that has entered the first optical pathway 3281 of the adapter 3250 to exit to any portions other than the inlet or the outlet of the first optical pathway 3281, and does not allow light to enter the first optical pathway 3281 through any portions other than the inlet or the outlet of the first optical pathway 3281.

Further, in this case, at least one sidewall surrounding the second optical pathway 3282 does not allow light that has entered the second optical pathway 3282 of the adapter 3250 to exit to any portions other than the inlet or the outlet of the second optical pathway 3282, and does not allow light to enter the second optical pathway 3282 through any portions other than the inlet or the outlet of the second optical pathway 3282.

Therefore, the first optical pathway 3281 of the adapter 3250 is surrounded by at least one sidewall and is separated from the second optical pathway 3282, and the second optical pathway 3282 of the adapter 3250 is surrounded by at least one sidewall and is separated from the first optical pathway 3281.

In this case, the first aperture 3261 of the adapter 3250 can function as the inlet of the first optical pathway 3281, and the third aperture 3271 can function as the outlet of the first optical pathway 3281.

Further, the second aperture 3262 of the adapter 3250 can function as the outlet of the second optical pathway 3282, and the fourth aperture 3272 can function as the inlet of the second optical pathway 3282.

Therefore, light entering the first optical pathway 3281 of the adapter 3250 can enter only through the first aperture 3261 or the third aperture 3271, and light exiting from the first optical pathway 3281 can exit only through the first aperture 3261 or the third aperture 3271.

Further, light entering the second optical pathway 3282 of the adapter 3250 can enter only through the second aperture 3262 or the fourth aperture 3272, and light exiting from the second optical pathway 3282 can exit only through the second aperture 3262 or the fourth aperture 3272.

In this case, the inlet and the outlet of the optical pathways of the adapter 3250 are described on the basis of the direction of a laser when the LiDAR device 3200 including the adapter 3250 operates, merely for the convenience of description, and do not mean that light cannot exit through the inlet of the optical pathways or cannot enter through the outlet of the optical pathways.

### Material of Adapter

The adapter 3250 according to an embodiment is positioned such that one end thereof contacts an optical window, and thus may be made of a flexible material to be able to adapt to the curved surface of the optical window.

For example, the adapter 3250 may be provided as rubber, but is not limited thereto.

Further, the adapter 3250 according to an embodiment is made of a material that does not transmit light.

For example, the adapter 3250 according to an embodiment may be made of a material that absorbs or scatters light.

### [Mounting Structure Between Transmission and Reception Optical Assemblies and Adapter]

FIG. 22 is a diagram illustrating a LiDAR device including an adapter according to an embodiment.

In this case, for the convenience of description, FIG. 22 illustrates a LiDAR device 3200 and an optical window 3290 together.

Referring to FIG. 22, a LiDAR device 3200 including an adapter according to an embodiment includes a laser output element array 3210, a detecting element array 3220, a transmission optical assembly 3230, a reception optical assembly 3240, and an adapter 3250.

In this case, since the above-described matters may be applied regarding the laser output element array 3210, the detecting element array 3220, the transmission optical assembly 3230, the reception optical assembly 3240, and the adapter 3250, redundant descriptions are omitted.

Referring again to FIG. 22, the transmission optical assembly 3230 is inserted into the first aperture 3261 of the adapter 3250, and the reception optical assembly 3240 is inserted into the second aperture 3262 of the adapter 3250.

Accordingly, the first optical pathway 3281 of the adapter 3250 is used as a transmission pathway of the LiDAR device 3200, and the second optical pathway 3282 of the adapter 3250 is used as a reception pathway of the LiDAR device 3200.

In this case, the transmission pathway of the LiDAR device 3200 may refer to a pathway through which lasers output from the laser output element array 3210 of the LiDAR device 3200 and steered through the transmission optical assembly 3230 pass.

Further, in this case, the reception pathway of the LiDAR device 3200 may refer to a pathway through which light incident on the reception optical assembly 3240 of the LiDAR device 3200 and delivered to the detecting element array 3220 passes.

Further, since the first optical pathway 3281 of the adapter 3250 is used as a transmission pathway of the LiDAR device 3200, the first aperture 3261 of the adapter 3250 functions as an inlet of the transmission pathway, and the third aperture 3271 functions as an outlet of the transmission pathway.

Further, since the second optical pathway 3282 of the adapter 3250 is used as a reception pathway of the LiDAR device 3200, the second aperture 3262 of the adapter 3250 functions as an outlet of the reception pathway, and the fourth aperture 3272 functions as an inlet of the reception pathway.

As described above, light entering the first optical pathway 3281 of the adapter 3250 can enter only through the first aperture 3261 or the third aperture 3271, and light exiting from the first optical pathway 3281 can exit only through the first aperture 3261 or the third aperture 3271.

In this situation, since the transmission optical assembly 3230 is inserted into the first aperture 3261 and is in close contact with the side surface surrounding the first aperture 3261, entry and exit of light between the first aperture 3261 and the transmission optical assembly 3230 are blocked.

Therefore, lasers output from the laser output element array 3210 and steered through the transmission optical assembly 3230 can enter the first optical pathway 3281 through the first aperture 3261 and then can exit from the first optical pathway 3281 only through the third aperture 3271.

Further, as described above, light entering the second optical pathway 3282 of the adapter 3250 can enter only through the second aperture 3262 or the fourth aperture 3272, and light exiting from the second optical pathway 3282 can exit only through the second aperture 3262 or the fourth aperture 3272.

In this situation, since the reception optical assembly 3240 is inserted into the second aperture 3262 and is in close contact with the side surface surrounding the second aperture 3262, entry and exit of light between the second aperture 3262 and the reception optical assembly 3240 are blocked.

Therefore, light entering the second optical pathway 3282 and delivered to the reception optical assembly 3240 can enter only through the fourth aperture 3272.

As a result, since lasers output from the laser output element array 3210 and steered through the transmission optical assembly 3230 cannot enter the second optical pathway 3282 through the fourth aperture 3272 and be delivered to the reception optical assembly 3240 before exiting through the third aperture 3271, the transmission pathway and the reception pathway are separated from each other.

### [Reason Why Above-Described Problems Are Solved When LiDAR Device Including Adapter is Located in Space Having Optical Window on One Side]

Referring again to FIGS. 20 to 22, the first aperture 3261 and the second aperture 3262 positioned on the bottom side 3260 of the adapter 3250 are physically separated, and as the transmission optical assembly 3230 of the LiDAR device 3200 is inserted into the first aperture 3261 and the reception optical assembly 3240 of the LiDAR device 3200 is inserted into the second aperture 3262, the inlet of the transmission pathway and the outlet of the reception pathway are separated.

Further, referring to FIGS. 20 to 22, since the third aperture 3271 and the fourth aperture 3272 positioned on the top side 3270 of the adapter 3250 are physically separated, the outlet of the transmission pathway and the inlet of the reception pathway are separated.

Further, referring to FIGS. 20 to 22, since the third aperture 3271 is disposed in close contact with the optical window 3290, lasers output from the laser output element array 3210 of the LiDAR device 3200 can exit to the outside only through the region of the optical window 3290 corresponding to the third aperture 3271.

That is, even though lasers are reflected from the optical window 3290, the lasers reflected from the optical window 3290 are not allowed to exit to any portions other than the region of the optical window 3290 corresponding to the third aperture 3271 for the following reasons.
(i) At least one sidewall surrounding the first optical pathway 3281 does not allow lasers to exit to any portions other than the first aperture 3261 and the third aperture 3271.
(ii) Since the transmission optical assembly 3230 is inserted into the first aperture 3261 and is in close contact with the side surface surrounding the first aperture 3261, lasers are not allowed to exit between the first aperture 3261 and the transmission optical assembly 3230.

Further, referring to FIGS. 20 to 22, since the fourth aperture 3272 is disposed in close contact with the optical window 3290, light reaching the reception optical assembly 3240 of the LiDAR device 3200 enters only through the region of the optical window 3290 corresponding to the fourth aperture 3272.

That is, light is not allowed to enter the second optical pathway 3282 and reach the reception optical assembly 3240 through any portions other than the region of the optical window 3290 corresponding to the fourth aperture 3272 for the following reasons.
(i) At least one sidewall surrounding the second optical pathway 3282 does not allow light to enter any portions other than the second aperture 3262 and the fourth aperture 3272.
(ii) Since the reception optical assembly 3240 is inserted into the second aperture 3262 and is in close contact with the side surface surrounding the second aperture 3262, light is not allowed to enter between the second aperture 3262 and the reception optical assembly 3240.

As a result, lasers reflected from the optical window 3290 are not allowed to exit to any portions other than the region of the optical window 3290 corresponding to the third aperture 3271, and light is not allowed to enter the second optical pathway 3282 through any portions other than the region of the optical window 3290 corresponding to the fourth aperture 3272 and reach the reception optical assembly 3240, so that the transmission pathway and the reception pathway are completely separated from each other.

Such complete separation of the transmission pathway and the reception pathway enables prevention of lasers steered by the transmission optical assembly from being delivered to the reception optical assembly after being reflected from the optical window.

That is, the adapter 3250 according to an embodiment solves the above-described problems by blocking lasers output from the LiDAR device 3200 and reflected from the optical window 3290 from reaching the reception optical assembly when the LiDAR device 3200 is located in a space having the optical window 3290 on one side.

### Modified Embodiments

In the above, an adapter 3250 including both a first optical pathway 3281 and a second optical pathway 3282 has been described.

However, in order to solve the same problems, an adapter including only one optical pathway may also be considered, and this is described in more detail below.

### Adapter Including Only Optical Pathway for Reception Optical Assembly

The bottom side of an adapter A according to a modified embodiment includes an aperture A, and the top side comprises an aperture B.

In this case, the shape and size of the aperture A correspond to the shape and size of a cross section of the reception optical assembly 3240.

Therefore, when the reception optical assembly 3240 is inserted into the aperture A, light escaping between the aperture A and the reception optical assembly 3240 is blocked.

Further, the adapter A comprises an optical pathway A, and the optical pathway A is surrounded and defined by a side surface A, and the aperture A and the aperture B function as an inlet or an outlet of the optical pathway A.

In this case, the side surface A surrounding the optical pathway A does not allow light to enter the optical pathway A through any portions other than the inlet or the outlet of the optical pathway A.

Therefore, light entering the optical pathway A of the adapter A can enter only through the aperture A or the aperture B.

In this situation, since the reception optical assembly 3240 is inserted into the aperture A and is in close contact with the side surface A surrounding the aperture A, entry and exit of light between the aperture A and the reception optical assembly 3240 is blocked.

Therefore, light entering the optical pathway A and delivered to the reception optical assembly 3240 can enter only through the aperture B.

In this case, since the aperture B is disposed in close contact with the optical window 3290, light reaching the reception optical assembly 3240 enters only through the region of the optical window 3290 corresponding to the aperture B.

As a result, since light is not allowed to enter the optical pathway A and reach the reception optical assembly 3240 through any portions other than the region of the optical window 3290 corresponding to the aperture B, the reception pathway is completely separated from any portions other than the region of the optical window 3290 corresponding to the aperture B.

Such complete separation of the reception pathway enables prevention of lasers steered by the transmission optical assembly from being delivered to the reception optical assembly after being reflected from the optical window.

### Adapter Including Only Optical Pathway for Transmission Optical Assembly

The bottom side of an adapter B according to a modified embodiment includes an aperture C, and the top side comprises an aperture D.

In this case, the shape and size of the aperture C correspond to the shape and size of a cross section of the transmission optical assembly 3230.

Therefore, when the transmission optical assembly 3230 is inserted into the aperture C, entry and exit of light between the aperture C and the transmission optical assembly 3230 is blocked.

Further, the adapter B comprises an optical pathway B, and the optical pathway B is surrounded and defined by a side surface B, and the aperture C and the aperture D function as an inlet or an outlet of the optical pathway B.

In this case, the side surface B surrounding the optical pathway B does not allow light to exit from the optical pathway B through any portions other than the inlet or the outlet of the optical pathway B.

Therefore, light exiting from the optical pathway B of the adapter B can exit only through the aperture C or the aperture D.

In this situation, since the transmission optical assembly 3230 is inserted into the aperture C and is in close contact with the side surface C surrounding the aperture C, entry and exit of light between the aperture C and the transmission optical assembly 3230 is blocked.

Therefore, lasers output from the laser output element array 3210 and steered through the transmission optical assembly 3230 can enter the optical pathway B through the aperture C and then exit only through the aperture D.

In this case, since the aperture D is disposed in close contact with the optical window 3290, lasers output from the laser output element array 3210 of the LiDAR device 3200 can exit to the outside only through the region of the optical window 3290 corresponding to the aperture D.

As a result, since lasers reflected from the optical window 3290 are not allowed to exit to any portions other than the region of the optical window 3290 corresponding to the aperture D, the transmission pathway is completely separated from any portions other than the region of the optical window 3290 corresponding to the aperture D.

Such complete separation of the transmission pathway enables prevention of lasers steered by the transmission optical assembly from being delivered to the reception optical assembly after being reflected from the optical window.

However, the adapter 3250 according to an embodiment configured to include both the first optical pathway 3281 and the second optical pathway 3282 may be a configuration that more effectively blocks light that escapes through minute gaps and causes problems.

Therefore, although the present specification has described an adapter 3250 on the basis that it includes both a first optical pathway 3281 and a second optical pathway 3282, the technical idea described through the present specification includes adapters according to modified embodiments including only one optical pathway.

### Problems of LiDAR Device Including Adapter According to One Embodiment

In the case of a LiDAR device including an adapter according to an embodiment described with reference to FIGS. 20 to 22, the field of view of the LiDAR device may be limited due to the adapter.

FIG. 23 is a diagram illustrating problems that may occur in a LiDAR device including an adapter according to an embodiment.

Referring to FIG. 23, a LiDAR device 3300 including an adapter according to an embodiment comprises a laser output element array 3310, a detecting element array 3320, a transmission optical assembly 3330, a reception optical assembly 3340, and an adapter 3350, and since the above-described matters may be applied regarding each configuration, redundant descriptions are omitted

Relationship Between Adapter and Field of View of LiDAR [symbol] Identification of Potential Problems

Referring again to FIG. 23, a phenomenon may occur in which at least some lasers 3360 among the lasers output from the laser output element array 3310 and steered by the transmission optical assembly 3330 in a LiDAR device 3300 including an adapter according to an embodiment are blocked by the adapter 3350 before reaching the optical window 3390.

That is, among the lasers output from the laser output element array 3310 and steered by the transmission optical assembly 3330, at least some lasers 3360 may be blocked by a first sidewall defining a first optical pathway of the adapter 3350 and may not reach the optical window 3390.

Therefore, in the case of the LiDAR device 3300 including an adapter according to an embodiment, a problem that the field of view of a laser emission region is limited due to the adapter 3350 may occur.

Further, referring again to FIG. 23, among the light incident on the reception optical assembly 3340 and to be focused onto the detecting element array 3320 in the LiDAR device 3300 including an adapter according to an embodiment, a phenomenon in which at least some light 3370 is blocked by the adapter 3350 before reaching the reception optical assembly 3340 may occur.

That is, among the light incident on the reception optical assembly 3340 and to be focused onto the detecting element array 3320, at least some light 3370 may be blocked by a second sidewall defining a second optical pathway of the adapter 3350 and may not reach the reception optical assembly 3340.

Therefore, in the case of the LiDAR device 3300 including an adapter according to an embodiment, a problem that the field of view of a light detection region is limited due to the adapter 3350 may occur.

As a result, in the case of the LiDAR device 3300 including an adapter according to an embodiment, a problem that the field of view of a LiDAR device is limited due to the adapter 3350 may occur.

Therefore, in designing the adapter 3350, there is a need to design the adapter not to limit the field of view of a laser emission region and the field of view of a light detection region of the LiDAR device 3310, and an adapter for solving this and a LiDAR device including the adapter for solving this are described in more detail below.

### IV. LiDAR Device Including Adapter According to Another Embodiment

### [Configuration of LiDAR Device Including Adapter]

A LiDAR device including an adapter according to an embodiment includes a laser output element array, a detecting element array, a transmission optical assembly, a reception optical assembly, and an adapter. In this case, since the above-described matters may be applied regarding the laser output element array, the detecting element array, the transmission optical assembly, and the reception optical assembly, redundant descriptions are omitted.

Further, in this case, the adapter is designed to solve the problems caused by the adapter described with reference to FIGS. 20 to 22, and more specific details are described below.

### [Adapter]

FIG. 24 is a diagram illustrating the structure of an adapter according to an embodiment.

### Structure of Bottom Side of Adapter

FIG. 24A is a diagram illustrating the structure of the bottom side of an adapter according to one embodiment.

Referring to FIG. 24A, a bottom side 3410 of an adapter 3400 according to an embodiment comprises a first aperture 3411 and a second aperture 3412.

In this case, since the above-described matters may be applied regarding the shapes and sizes of the first aperture 3411 and the second aperture 3412, redundant descriptions are omitted.

### Structure of Top Side of Adapter

FIG. 24B is a diagram illustrating the structure of the top side of an adapter according to one embodiment.

More specifically, FIG. 24B is a diagram illustrating an adapter obtained by rotating the adapter illustrated in FIG. 24A by 180 degrees about the y-axis.

Referring to FIG. 24B, a top side 3420 of an adapter 3400 according to an embodiment includes a third aperture 3421 and a fourth aperture 3422.

In this case, the above-described aperture may mean a space surrounded and defined by a side surface, and may comprise a concept commonly understood as an aperture.

Further, in this case, the third aperture 3421 and the fourth aperture 3422 are configured to have a predetermined relationship with the first aperture 3411 and the second aperture 3412 in order to solve the above-described problems.

Details thereof are described in more detail below through separate sections.

### Structure of First Optical Pathway and Second Optical Pathway of Adapter

FIG. 24C is a diagram illustrating a first optical pathway and a second optical pathway of an adapter according to an embodiment.

More specifically, FIG. 24C is a diagram illustrating a cross-section of an adapter obtained by rotating the adapter illustrated in FIG. 24A by 90 degrees about the x-axis such that the bottom side of the adapter is positioned below and the top side is positioned above.

Referring to FIG. 24C, an adapter 3400 according to an embodiment may include a first optical pathway 3430 and a second optical pathway 3440.

In this case, the above-described optical pathway may refer to a space surrounded and defined by at least one side surface, through which light enters and exits, and may comprise a concept commonly understood as an optical pathway.

For example, the first optical pathway 3430 may be a space in which a first space surrounded by a first sidewall 3431 forming a first side surface and a second space surrounded by a second sidewall 3432 forming a second side surface are connected, and may be a pathway through which light enters through an inlet and exits through an outlet.

Further, for example, the second optical pathway 3440 may be a space in which a third space surrounded by a third sidewall 3441 forming a third side surface and a fourth space surrounded by a fourth sidewall 3442 forming a fourth side surface are connected, and may be a pathway through which light enters through an inlet and exits through an outlet.

In this case, at least one sidewall surrounding the first optical pathway 3430 does not allow light that has entered the first optical pathway 3430 of the adapter 3400 to exit to any portions other than the inlet or the outlet of the first optical pathway 3430, and does not allow light to enter the first optical pathway 3430 through any portions other than the inlet or the outlet of the first optical pathway 3430.

Further, in this case, at least one sidewall surrounding the second optical pathway 3440 does not allow light that has entered the second optical pathway 3440 of the adapter 3400 to exit to any portions other than the inlet or the outlet of the second optical pathway 3440, and does not allow light to enter the second optical pathway 3440 through any portions other than the inlet or the outlet of the second optical pathway 3440.

Therefore, the first optical pathway 3430 of the adapter 3400 is surrounded by at least one sidewall and is separated from the second optical pathway 3440, and the second optical pathway 3440 of the adapter 3400 is surrounded by at least one sidewall and is separated from the first optical pathway 3430.

In this case, the first aperture 3411 of the adapter 3400 can function as the inlet of the first optical pathway 3430, and the third aperture 3421 can function as the outlet of the first optical pathway 3430.

Further, the second aperture 3412 of the adapter 3400 can function as the outlet of the second optical pathway 3440, and the fourth aperture 3422 can function as the inlet of the second optical pathway 3440.

Therefore, light entering the first optical pathway 3430 of the adapter 3400 can enter only through the first aperture 3411 or the third aperture 3421, and light exiting from the first optical pathway 3430 can exit only through the first aperture 3411 or the third aperture 3421.

Further, light entering the second optical pathway 3440 of the adapter 3400 can enter only through the second aperture 3412 or the fourth aperture 3422, and light exiting from the second optical pathway 3440 can exit only through the second aperture 3412 or the fourth aperture 3422.

In this case, the inlet and the outlet of the optical pathways of the adapter 3400 are described on the basis of the direction of a laser when the LiDAR device including the adapter 3400 operates, merely for the convenience of description, and do not mean that light cannot exit through the inlet of the optical pathways or cannot enter through the outlet of the optical pathways.

### Material of Adapter

Since the above-described matters may be applied regarding the material of the adapter 3400, redundant descriptions are omitted.

[Mounting Structure Between Transmission and Reception Optical Assemblies and Adapter, and Design of Length of Aperture Positioned on Top Side of Adapter in First-Axis (X-Axis) Direction and Length of Adapter in Second-Axis (Z-Axis) Direction for Solving Above-Described Problems

FIG. 25 is a diagram illustrating a LiDAR device including an adapter according to an embodiment.

### Description of Reference Numerals and Terms for Convenience of Description

Referring to FIG. 25, a LiDAR device 3500 including an adapter according to an embodiment includes a laser output element array 3510, a detecting element array 3520, a transmission optical assembly 3530, a reception optical assembly 3540, and an adapter 3400.

In this case, since the above-described matters may be applied regarding the laser output element array 3510, the detecting element array 3520, the transmission optical assembly 3530, and the reception optical assembly 3540, redundant descriptions are omitted.

Further, in this case, the reference numerals illustrated in FIG. 24 and the matters described with reference to FIG. 24 may be applied regarding the adapter 3400.

Further, in this case, although FIG. 25 omits some of the reference numerals illustrated in FIG. 24 to ensure visibility of the figure, FIG. 25 may be described using, together, the reference numerals illustrated in FIG. 24 for the convenience of description.

Referring again to FIG. 25, the transmission optical assembly 3530 has a first optical axis 3531 and has a first entrance pupil 3532.

In this case, the first entrance pupil 3532 of the transmission optical assembly 3530 may be defined by points at which the first optical axis 3531 intersects an extension of the object-side propagation direction of chief rays of lasers output from the laser output element array 3510 and steered by the transmission optical assembly 3530, the extension being made in a direction opposite to the propagation direction of the chief rays (where the object side refers to a side opposite to a side on which the laser output element array 3510 is positioned with respect to the transmission optical assembly 3530), and may refer to a point generally defined as an entrance pupil of an optical assembly.

Referring again to FIG. 25, the reception optical assembly 3540 has a second optical axis 3541 and has a second entrance pupil 3542.

In this case, the second entrance pupil 3542 of the reception optical assembly 3540 may be defined by points at which the second optical axis 3541 intersects an extension of the propagation direction of light that is focused by the reception optical assembly 3540 and delivered to the detecting element array 3520, and may refer to a point generally defined as an entrance pupil of an optical assembly.

Referring again to FIG. 25, the bottom side of the adapter 3400 comprises a first aperture 3411 and a second aperture 3412, and the top side of the adapter 3400 comprises a third aperture 3421 and a fourth aperture 3422.

Referring again to FIG. 25, the field of view of the laser emission region of the LiDAR device 3500 in the first-axis (x-axis) direction is k degrees, and the field of view of the light detection region of the LiDAR device 3500 in the first-axis (x-axis) direction is 1 degrees.

In this case, FIG. 25 illustrates a center 3451 of the first aperture 3411 and illustrates a center 3452 of the second aperture 3412.

Further, referring to FIGS. 24 and 25, FIG. 25 illustrates a first end portion 3471 and a second end portion 3472 of a second sidewall 3432 forming a portion of a first optical pathway 3430 of the adapter 3400, and illustrates a third end portion 3473 and a fourth end portion 3474 of a fourth sidewall 3442 forming a portion of a second optical pathway 3440 of the adapter 3400.

Further, for the convenience of description, lengths and distances necessary to describe FIG. 25 are defined and described as follows.

First length 3461: the length 3461 of the first aperture 3411 of the adapter 3400 in the first-axis (x-axis) direction.

Second length 3462: the length 3462 of the second aperture 3412 of the adapter 3400 in the first-axis (x-axis) direction.

Third length 3480: the length 3480 of the third aperture 3421 of the adapter 3400 in the first-axis (x-axis) direction.

Fourth length 3490: the length 3490 of the fourth aperture 3422 of the adapter 3400 in the first-axis (x-axis) direction.

First distance 3463: the distance 3463 between the first aperture 3411 and the second aperture 3412 of the adapter 3400 in the first-axis (x-axis) direction.

Second distance 3481: the distance 3481 between the first optical axis 3531 of the transmission optical assembly 3530 and the first end portion 3471 of the second sidewall 3432 of the adapter 3400 in the first-axis (x-axis) direction.

Third distance 3482: the distance between the first optical axis 3531 of the transmission optical assembly 3530 and the second end portion 3472 of the second sidewall 3432 of the adapter 3400 in the first-axis (x-axis) direction.

Fourth distance 3491: the distance 3491 between the second optical axis 3541 of the reception optical assembly 3540 and the third end portion 3473 of the fourth sidewall 3442 of the adapter 3400 in the first-axis (x-axis) direction.

Fifth distance 3492: the distance 3492 between the second optical axis 3541 of the reception optical assembly 3540 and the fourth end portion 3474 of the fourth sidewall 3442 of the adapter 3400 in the first-axis (x-axis) direction.

Sixth distance 3551: the distance 3551 between the first entrance pupil 3532 of the transmission optical assembly 3530 and the first end portion 3471 of the second sidewall 3432 of the adapter 3400 in the second-axis (z-axis) direction.

(In some cases, since the position of a plane in which the first entrance pupil 3532 of the transmission optical assembly 3530 is positioned and the position of the bottom side of the adapter 3400 may not be significantly different and a design margin may be allowed, the sixth distance 3551 may be replaced with the distance between the bottom side of the adapter 3400 and the first end portion 3471 of the second sidewall 3432 in the second-axis (z-axis) direction.)

Seventh distance 3552: the distance 3552 between the second entrance pupil 3542 of the reception optical assembly 3540 and the third end portion 3473 of the fourth sidewall 3442 of the adapter 3400 in the second-axis (z-axis) direction.

(In some cases, since the position of a plane in which the second entrance pupil 3542 of the reception optical assembly 3540 is positioned and the position of the bottom side of the adapter 3442 may not be significantly different and a design margin may be allowed, the seventh distance 3552 may be replaced with the distance between the bottom side of the adapter 3400 and the third end portion 3473 of the fourth sidewall 3442 in the second-axis (z-axis) direction.)

### Mounting Structure Between Transmission and Reception Optical Assemblies and Adapter

Referring again to FIG. 25, the transmission optical assembly 3530 is inserted into the first aperture 3411 of the adapter 3400, and the reception optical assembly 3540 is inserted into the second aperture 3412 of the adapter 3400.

In this case, since the shape of the first aperture 3411 corresponds to the shape of the transmission optical assembly 3530, the first optical axis 3531 of the transmission optical assembly 3530 passes through the center 3451 of the first aperture 3411.

Further, in this case, since the shape of the second aperture 3412 corresponds to the shape of the reception optical assembly 3540, the second optical axis 3541 of the reception optical assembly 3540 passes through the center 3452 of the second aperture 3412.

Further, accordingly, the first optical pathway 3430 of the adapter 3400 is used as a transmission pathway of the LiDAR device 3500, and the second optical pathway 3440 of the adapter 3400 is used as a reception pathway of the LiDAR device 3500.

In this case, the transmission pathway of the LiDAR device 3500 may refer to a pathway through which lasers output from the laser output element array 3510 of the LiDAR device 3500 and steered through the transmission optical assembly 3530 pass.

Further, in this case, the reception pathway of the LiDAR device 3500 may refer to a pathway through which light incident on the reception optical assembly 3540 of the LiDAR device 3500 and delivered to the detecting element array 3520 passes.

Further, since the first optical pathway 3430 of the adapter 3430 is used as a transmission pathway of the LiDAR device 3500, the first aperture 3411 of the adapter 3400 functions as an inlet of the transmission pathway, and the third aperture 3421 functions as an outlet of the transmission pathway.

Further, since the second optical pathway 3440 of the adapter 3400 is used as a reception pathway of the LiDAR device 3500, the second aperture 3412 of the adapter 3400 functions as an outlet of the reception pathway, and the fourth aperture 3422 functions as an inlet of the reception pathway.

Further, since the first optical pathway 3430 of the adapter 3400 is surrounded by at least one sidewall and separated from the second optical pathway 3440, and the second optical pathway 3440 of the adapter 3400 is surrounded by at least one sidewall and separated from the first optical pathway 3430, the transmission pathway and the reception pathway of the LiDAR device 3500 may be separated.

### Length Design in First-Axis (X-axis) Direction of Aperture Positioned on Top Side of Adapter and Length Design in Second-Axis (Z-axis) Direction of Adapter for Solving Above-Described Problems

First, the third length 3480, which is the length in the first-axis (x-axis) direction of the third aperture 3421 positioned on the top side of the adapter 3400, is designed to be longer than the first length 3461 that is the length in the first-axis (x-axis) direction of the first aperture 3411 positioned on the bottom side of the adapter 3400, so as not to limit the field of view in the first-axis (x-axis) direction of the laser emission region of the LiDAR device 3500.

Further, in order to solve the above-described problems, the length in the first-axis (x-axis) direction of the third aperture 3421 positioned on the top side of the adapter 3400 is designed in consideration of the field of view in the first-axis (x-axis) direction of the laser emission region of the LiDAR device 3500.

More specifically, the second distance 3481 that is the distance in the first-axis (x-axis) direction between the first optical axis 3531 of the transmission optical assembly 3530 and the first end portion 3471 of the second sidewall 3432 of the adapter 3400, the sixth distance 3551 that is the distance in the second-axis (z-axis) direction between the first entrance pupil 3532 of the transmission optical assembly 3530 and the first end portion 3471 of the second sidewall 3432 of the adapter 3400, and k degrees that is the field of view in the first-axis (x-axis) direction of the laser emission region of the LiDAR device 3500 satisfy the following Relationship 2.

$$second distance ( 3481 ) / sixth distance ( 3551 ) > tan ( k degrees / 2 ) \qquad [ Relationship 2 ]$$

This is a Relationship for preventing an outermost laser in the first-axis (x-axis) direction of the laser emission region of the LiDAR device 3500 from being limited by the adapter 3400, and is a Relationship for designing the distance in the first-axis (x-axis) direction between the first optical axis 3531 and the first end portion 3471 with respect to the distance in the second-axis (z-axis) direction between the first entrance pupil 3532 and the first end portion 3471 of the second sidewall 3432.

In this case, when a LiDAR device is located in a space having an optical window on one side, the distance in the second-axis (z-axis) direction between the first entrance pupil 3532 and the first end portion 3471 of the second sidewall 3432 is a factor corresponding to the distance from the LiDAR device to the optical window.

Further, in this case, the distance in the first-axis (x-axis) direction between the first optical axis 3531 and the first end portion 3471 is a factor corresponding to the length in the first-axis (x-axis) direction of the third aperture 3421.

Therefore, Relationship 2 may be understood, given that the distance between a LiDAR device and an optical window is determined, as a Relationship regarding the minimum length in the first-axis (x-axis) direction of the third aperture 3421 that prevents the adapter 3400 from limiting the field of view of the laser emission region of the LiDAR device.

In this case, since the length in the second-axis (z-axis) direction from the bottom side of the adapter to the top side of the adapter is designed on the basis of the distance between the LiDAR device and the optical window, Relationship 2 may be understood as (the length in the first-axis (x-axis) direction of the third aperture 3421)/(2*(the length in the second-axis (z-axis) direction from the bottom side 3410 of the adapter 3400 to the top side 3420 of the adapter 3400))>tan (k degrees/2).

Further, more specifically, the third distance 3482 that is the distance in the first-axis (x-axis) direction between the first optical axis 3531 of the transmission optical assembly 3530 and the second end portion 3472 of the second sidewall 3432 of the adapter 3400, the eighth distance (not shown) that is the distance in the second-axis (z-axis) direction between the first entrance pupil 3532 of the transmission optical assembly 3530 and the second end portion 3472 of the second sidewall 3432 of the adapter 3400, and k degrees that is the field of view in the first-axis (x-axis) direction of the laser emission region of the LiDAR device 3500 satisfy the following Relationship 3.

$$third distance ( 3482 ) / eighth distance ( not shown ) > tan ( k degrees / 2 ) \qquad [ Relationship 3 ]$$

This is a Relationship for preventing an outermost laser in the first-axis (x-axis) direction of the laser emission region of the LiDAR device 3500 from being limited by the adapter 3400, and is a Relationship for designing the distance in the first-axis (x-axis) direction between the first optical axis 3531 and the second end portion 3472 with respect to the distance in the second-axis (z-axis) direction between the first entrance pupil 3532 and the second end portion 3472 of the second sidewall 3432.

In this case, when a LiDAR device is located in a space having an optical window on one side, the distance in the second-axis (z-axis) direction between the first entrance pupil 3532 and the second end portion 3472 of the second sidewall 3432 is a factor corresponding to the distance from the LiDAR device to the optical window.

Further, in this case, the distance in the first-axis (x-axis) direction between the first optical axis 3531 and the second end portion 3472 is a factor corresponding to the length in the first-axis (x-axis) direction of the third aperture 3421.

Therefore, Relationship 3 may be understood, given that the distance between a LiDAR device and an optical window is determined, as a Relationship regarding the minimum length in the first-axis (x-axis) direction of the third aperture 3421 that prevents the adapter 3400 from limiting the field of view of the laser emission region of the LiDAR device.

In this case, since the length in the second-axis (z-axis) direction from the bottom side of the adapter to the top side of the adapter is designed on the basis of the distance between the LiDAR device and the optical window, Relationship 3 may be understood as (the length in the first-axis (x-axis) direction of the third aperture 3421)/(2*(the length in the second-axis (z-axis) direction from the bottom side 3410 of the adapter 3400 to the top side 3420 of the adapter 3400))>tan (k degrees/2).

Further, the fourth length 3490, which is the length in the first-axis (x-axis) direction of the fourth aperture 3422 positioned on the top side of the adapter 3400, is designed to be longer than the second length 3462 that is the length in the first-axis (x-axis) direction of the second aperture 3412 positioned on the bottom side of the adapter 3400, so as not to limit the field of view in the first-axis (x-axis) direction of the laser emission region of the LiDAR device 3500.

Further, in order to solve the above-described problems, the length in the first-axis (x-axis) direction of the fourth aperture 3422 positioned on the top side of the adapter 3400 is designed in consideration of the field of view in the first-axis (x-axis) direction of the light detection region of the LiDAR device 3500.

More specifically, the fourth distance 3491 that is the distance in the first-axis (x-axis) direction between the second optical axis 3541 of the reception optical assembly 3540 and the third end portion 3473 of the fourth sidewall 3442 of the adapter 3400, the seventh distance 3552 that is the distance in the second-axis (z-axis) direction between the second entrance pupil 3542 of the reception optical assembly 3540 and the third end portion 3473 of the fourth sidewall 3442 of the adapter 3400, and I degrees that is the field of view in the first-axis (x-axis) direction of the light detection region of the LiDAR device 3500 satisfy the following Relationship 4.

$$fourth distance ( 3491 ) / seventh distance ( 3552 ) > tan ( I degrees / 2 ) \qquad [ Relationship 4 ]$$

This is a Relationship for preventing light coming from an outermost side in the first-axis (x-axis) direction of the light detection region of the LiDAR device 3500 from being limited by the adapter 3400, and is a relationship for designing the distance in the first-axis (x-axis) direction between the second optical axis 3541 and the third end portion 3473 with respect to the distance in the second-axis (z-axis) direction between the second entrance pupil 3542 and the third end portion 3473 of the fourth sidewall 3442.

In this case, when a LiDAR device is located in a space having an optical window on one side, the distance in the second-axis (z-axis) direction between the second entrance pupil 3542 and the third end portion 3473 of the fourth sidewall 3442 is a factor corresponding to the distance from the LiDAR device to the optical window.

Further, in this case, the distance in the first-axis (x-axis) direction between the second optical axis 3531 and the third end portion 3473 is a factor corresponding to the length in the first-axis (x-axis) direction of the fourth aperture 3422.

Therefore, Relationship 4 may be understood, given that the distance between a LiDAR device and an optical window is determined, as a Relationship regarding the minimum length in the first-axis (x-axis) direction of the fourth aperture 3422 that prevents the adapter 3400 from limiting the field of view of the light detection region of the LiDAR device.

In this case, since the length in the second-axis (z-axis) direction from the bottom side of the adapter to the top side of the adapter is designed on the basis of the distance between the LiDAR device and the optical window, Relationship 4 may be understood as (the length in the first-axis direction of the fourth aperture)/(2*(the length in the second-axis direction from the bottom side of the adapter to the top side of the adapter))>tan (I degrees/2).

Further, more specifically, the fifth distance 3492 that is the distance in the first-axis (x-axis) direction between the second optical axis 3541 of the reception optical assembly 3540 and the fourth end portion 3474 of the fourth sidewall 3442 of the adapter 3400, the ninth distance (not shown) that is the distance in the second-axis (z-axis) direction between the second entrance pupil 3542 of the reception optical assembly 3540 and the fourth end portion 3474 of the fourth sidewall 3442 of the adapter 3400, and I degrees that is the field of view in the first-axis (x-axis) direction of the light detection region of the LiDAR device 34500 satisfy the following Relationship 5.

$$fifth distance ( 34 \; 92 ) / ninth distance ( not shown ) > tan ( I degrees / 2 ) \qquad [ Relationship 5 ]$$

This is a Relationship for preventing light coming from an outermost side in the first-axis (x-axis) direction of the light detection region of the LiDAR device 3500 from being limited by the adapter 3400, and is a relationship for designing the distance in the first-axis (x-axis) direction between the second optical axis 3541 and the fourth end portion 3474 with respect to the distance in the second-axis (z-axis) direction between the second entrance pupil 3542 and the fourth end portion 3474 of the fourth sidewall 3442.

In this case, when a LiDAR device is located in a space having an optical window on one side, the distance in the second-axis (z-axis) direction between the second entrance pupil 3542 and the fourth end portion 3474 of the fourth sidewall 3442 is a factor corresponding to the distance from the LiDAR device to the optical window.

Further, in this case, the distance in the first-axis (x-axis) direction between the second optical axis 3531 and the fourth end portion 3474 is a factor corresponding to the length in the first-axis (x-axis) direction of the fourth aperture 3422.

Therefore, Relationship 5 may be understood, given that the distance between a LiDAR device and an optical window is determined, as a Relationship regarding the minimum length in the first-axis (x-axis) direction of the fourth aperture 3422 that prevents the adapter 3400 from limiting the field of view of the light detection region of the LiDAR device.

In this case, since the length in the second-axis (z-axis) direction from the bottom side of the adapter to the top side of the adapter is designed on the basis of the distance between the LiDAR device and the optical window, Relationship 5 may be understood as (the length in the first-axis direction of the fourth aperture)/(2*(the length in the second-axis direction from the bottom side of the adapter to the top side of the adapter))>tan (I degrees/2).

In this case, when the adapter 3400 is designed to satisfy the Relationships described above, the adapter 3400 does not limit the field of view in the first-axis direction of the laser emission region of the LiDAR device 3500 and the field of view in the first-axis direction of the light detection region.

That is, when the adapter 3400 is designed to satisfy the Relationships described above, the adapter 3400 is not positioned on the laser path between the transmission optical assembly and the optical window, whereby it does not limit the field of view in the first-axis (x-axis) direction of the laser emission region. Further, in this case, the adapter is not positioned on the light path between the reception optical assembly and the optical window, whereby it does not limit the field of view in the first-axis (x-axis) direction of the light detection region.

However, when the adapter 3400 is formed to include both the first optical pathway 3430 and the second optical pathway 3440, the lengths that the third distance 3482 and the fifth distance 3492 are inevitably limited.

In the case of an adapter designed in this limited situation, the size of the aperture positioned on the top side and the size of the aperture positioned on the bottom side have a predetermined relationship.

Therefore, hereinafter, preset relationships between the size of an aperture positioned on the top side of an adapter and the size of an aperture positioned on the bottom side of the adapter according to various embodiments are described in more detail.

Of course, the embodiments described below may satisfy all the relationships described in Relationship 2 to Relationship 5.

### [Various Preset Relationships Regarding Sizes in First-Axis (X-Axis) Direction of Apertures Positioned on Top and Bottom Sides of Adapter]

FIG. 26 is a diagram illustrating preset relationships between the size of an aperture positioned on the top side of an adapter and the size of an aperture positioned on the bottom side of the adapter according to various embodiments.

Before describing FIG. 26, for the convenience of description, the reference numerals and terms used in FIGS. 24 and 25 are used as they are in the description of FIG. 26.

### Preset Relationship Between Size of Aperture Positioned on Top Side of Adapter and Size of Aperture Positioned on Bottom Side According to First Embodiment

FIG. 26A is a diagram illustrating a preset relationship between the size of an aperture positioned on the top side of an adapter and the size of an aperture positioned on the bottom side according to the first embodiment.

Referring to FIG. 26A together with FIGS. 24 and 25, the adapter 3400 according to the first embodiment is mounted to the transmission optical assembly 3530 of the LiDAR device 3500 such that the first optical axis 3531 of the transmission optical assembly 3530 passes through the center 3453 of the third aperture 3421.

In this case, the length 3461 of the first aperture 3411 of the adapter 3400 in the first-axis (x-axis) direction and the length 3480 of the third aperture 3421 in the first-axis (x-axis) direction satisfy the following Relationships.

$$length ( 3480 ) of third aperture ( 3421 ) in first - axis ( x - axis ) direction > length ( 3461 ) of first aperture ( 3411 ) in first - axis ( x - axis ) direction \qquad [ Relationship 6 ]$$

$$length ( 3480 ) of third aperture ( 3421 ) in first - axis ( x - axis ) direction \leq length ( 3461 ) of first aperture ( 3411 ) in first - axis ( x - axis ) direction + distance ( 3463 ) in first - axis ( x - axis ) direction between first aperture ( 3411 ) and second aperture ( 3412 ) of adapter ( 3400 ) \qquad [ Relationship 7 ]$$

Referring to FIG. 26A together with FIGS. 24 and 25, the adapter 3400 according to the first embodiment is mounted to the reception optical assembly 3540 of the LiDAR device 3500 such that the second optical axis 3541 of the reception optical assembly 3540 passes through the center 3454 of the fourth aperture 3422.

In this case, the length 3462 of the second aperture 3412 of the adapter 3400 in first-axis (x-axis) direction and the length 3490 of the fourth aperture 3422 of the adapter 3400 in the first-axis (x-axis) direction satisfy the following Relationships.

$$length ( 3490 ) of fourth aperture ( 3422 ) in first - axis ( x - axis ) direction > length ( 3462 ) of second aperture ( 3412 ) in first - axis ( x - axis ) direction \qquad [ Relationship 8 ]$$

$$length ( 3490 ) of fourth aperture ( 3422 ) in first - axis ( x - axis ) direction \leq length ( 3462 ) of first aperture ( 3412 ) in first - axis ( x - axis ) direction + distance ( 3463 ) in first - axis ( x - axis ) direction between first aperture ( 3411 ) and second aperture ( 3412 ) of adapter ( 3400 ) \qquad [ Relationship 9 ]$$

Preset Relationship Between Size of Aperture Positioned on Top Side of Adapter and Size of Aperture Positioned on Bottom Side According to Second Embodiment

FIG. 26B is a diagram illustrating a preset relationship between the size of an aperture positioned on the top side of an adapter and the size of an aperture positioned on the bottom side according to the second embodiment.

Referring to FIG. 26B together with FIGS. 24 and 25, the adapter 3400 according to the second embodiment is mounted to the reception optical assembly 3530 such that the center 3453 of the third aperture 3421 is moved away from the first optical axis 3531 of the transmission optical assembly 3530 of the LiDAR device 3500 in the direction in which the fourth aperture 3422 is positioned.

In this case, the length 3461 of the first aperture 3411 of the adapter 3400 in the first-axis (x-axis) direction and the length 3480 of the third aperture 3421 in the first-axis (x-axis) direction satisfy the following Relationships.

$$length ( 3480 ) of third aperture ( 3421 ) in first - axis ( x - axis ) direction > length ( 3461 ) of first aperture ( 3411 ) in first - axis ( x - axis ) direction \qquad [ Relationship 10 ]$$

$$length ( 3480 ) of third aperture ( 3421 ) in first - axis ( x - axis ) direction \leq length ( 3461 ) of first aperture ( 3411 ) in first - axis ( x - axis ) direction + distance ( 3463 ) in first - axis ( x - axis ) direction between first aperture ( 3411 ) and second aperture ( 3412 ) of adapter ( 3400 ) \qquad [ Relationship 11 ]$$

Referring to FIG. 26B together with FIGS. 24 and 25, the adapter 3400 according to the second embodiment is mounted to the reception optical assembly 3540 such that the center 3454 of the fourth aperture 3422 is moved away from the second optical axis 3541 of the reception optical assembly 3540 of the LiDAR device 3500 in the direction in which the third aperture 3421 is positioned.

In this case, the length 3462 of the second aperture 3412 of the adapter 3400 in first-axis (x-axis) direction and the length 3490 of the fourth aperture 3422 of the adapter 3400 in the first-axis (x-axis) direction satisfy the following Relationships.

$$length ( 3490 ) of fourth aperture ( 3422 ) in first - axis ( x - axis ) direction > length ( 3462 ) of second aperture ( 3412 ) in first - axis ( x - axis ) direction \qquad [ Relationship 12 ]$$

$$length ( 3490 ) of fourth aperture ( 3422 ) in first - axis ( x - axis ) direction \leq length ( 3462 ) of first aperture ( 3412 ) in first - axis ( x - axis ) direction + distance ( 3463 ) in first - axis ( x - axis ) direction between first aperture ( 3411 ) and second aperture ( 3412 ) of adapter ( 3400 ) \qquad [ Relationship 13 ]$$

### Preset Relationship Between Size of Aperture Positioned on Top Side of Adapter and Size of Aperture Positioned on Bottom Side According to Third Embodiment

FIG. 26C is a diagram illustrating a preset relationship between the size of an aperture positioned on the top side of an adapter and the size of an aperture positioned on the bottom side according to the third embodiment.

Referring to FIG. 26C together with FIGS. 24 and 25, the adapter 3400 according to the third embodiment is mounted to the transmission optical assembly 3530 such that the center 3453 of the third aperture 3421 is moved away from the first optical axis 3531 of the transmission optical assembly 3530 of the LiDAR device 3500 in the opposite direction to the direction in which the fourth aperture 3422 is positioned.

In this case, the length 3461 of the first aperture 3411 of the adapter 3400 in the first-axis (x-axis) direction and the length 3480 of the third aperture 3421 in the first-axis (x-axis) direction satisfy the following Relationships.

$$length ( 3480 ) of third aperture ( 3421 ) in first - axis ( x - axis ) direction > length ( 3461 ) of first aperture ( 3411 ) in first - axis ( x - axis ) direction \qquad [ Relationship 14 ]$$

$$length ( 3480 ) of third aperture ( 3421 ) in first - axis ( x - axis ) direction \leq length ( 3461 ) of first aperture ( 3411 ) in first - axis ( x - axis ) direction + distance ( 3463 ) in first - axis ( x - axis ) direction between first aperture ( 3411 ) and second aperture ( 3412 ) of adapter ( 3400 ) \qquad [ Relationship 15 ]$$

Referring to FIG. 26C together with FIGS. 24 and 25, the adapter 3400 according to the third embodiment is mounted to the reception optical assembly 3540 such that the center 3454 of the fourth aperture 3422 is moved away from the second optical axis 3541 of the reception optical assembly 3540 of the LiDAR device 3500 in the opposite direction to the direction in which the third aperture 3421 is positioned.

In this case, the length 3462 of the second aperture 3412 of the adapter 3400 in first-axis (x-axis) direction and the length 3490 of the fourth aperture 3422 of the adapter 3400 in the first-axis (x-axis) direction satisfy the following Relationships.

$$length ( 3490 ) of fourth aperture ( 3422 ) in first - axis ( x - axis ) direction > length ( 3462 ) of second aperture ( 3412 ) in first - axis ( x - axis ) direction \qquad [ Relationship 16 ]$$

$$length ( 3490 ) of fourth aperture ( 3422 ) in first - axis ( x - axis ) direction \leq length ( 3462 ) of first aperture ( 3412 ) in first - axis ( x - axis ) direction + distance ( 3463 ) in first - axis ( x - axis ) direction between first aperture ( 3411 ) and second aperture ( 3412 ) of adapter ( 3400 ) \qquad [ Relationship 17 ]$$

### Combinations of Preset Relationships Between Sizes of Apertures Positioned on Top Side of Adapter and Sizes of Apertures Positioned on Bottom Side According to First to Third Embodiments

The preset relationships between the sizes of the apertures positioned on the top side of the adapter and the sizes of an apertures positioned on the bottom side according to the first to third embodiments described through FIGS. 26A to 26C may be combined with each other.

More specifically, the relationships between the first aperture 3411 and the third aperture 3421 of each of the adapters according to the first to third embodiments may be combined with the relationships between the second aperture 3412 and the fourth aperture 3422 of each of the adapters according to the first to third embodiments.

For example, the relationship between the first aperture 3411 and the third aperture 3421 of the adapter according to the first embodiment may be combined with the relationship between the second aperture 3412 and the fourth aperture 3422 of the adapter according to the first, second, or third embodiment.

Further, for example, the relationship between the first aperture 3411 and the third aperture 3421 of the adapter according to the second embodiment may be combined with the relationship between the second aperture 3412 and the fourth aperture 3422 of the adapter according to the first, second, or third embodiment.

Further, for example, the relationship between the first aperture 3411 and the third aperture 3421 of the adapter according to the third embodiment may be combined with the relationship between the second aperture 3412 and the fourth aperture 3422 of the adapter according to the first, second, or third embodiment.

### Another Method of Specifying First to Third Embodiments

The adapters according to the first to third embodiments described above through FIGS. 26A to 26C have been described by specifying the first to third embodiments using a transmission optical assembly and a reception optical assembly of a LiDAR device.

However, the adapters according to the first to third embodiments may be specified without using a transmission optical assembly and a reception optical assembly.

For example, the adapter according to the first embodiment described above through FIG. 26A may be specified as an embodiment in which a virtual line connecting the center 3451 of the first aperture 3411 and the center 3453 of the third aperture 3421 is parallel to the second axis (z-axis), and in this case, the second axis (z-axis) may refer to the axis extending from the bottom side to the top side of the adapter.

For example, the adapter according to the first embodiment described above through FIG. 26A may be specified as an embodiment in which a virtual line connecting the center 3452 of the second aperture 3412 and the center 3454 of the fourth aperture 3422 is parallel to the second axis (z-axis), and in this case, the second axis (z-axis) may refer to the axis extending from the bottom side to the top side of the adapter.

Further, for example, the adapter according to the second embodiment described above through FIG. 26B may be specified as an embodiment in which the virtual line connecting the center 3451 of the first aperture 3411 and the center 3453 of the third aperture 3421 is not parallel to the second axis (z-axis), and the center 3453 of the third aperture 3421 has been moved in the +x direction relative to the center 3451 of the first aperture 3411. In this case, the +x direction may be the direction in which the center 3451 of the first aperture 3411 faces the center 3452 of the second aperture 3412.

Further, for example, the adapter according to the second embodiment described above through FIG. 26B may be specified as an embodiment in which the virtual line connecting the center 3452 of the second aperture 3412 and the center 3454 of the fourth aperture 3422 is not parallel to the second axis (z-axis), and the center 3454 of the fourth aperture 3422 has been moved in the −x direction relative to the center 3452 of the second aperture 3412. In this case, the −x direction may be the direction in which the center 3452 of the second aperture 3412 faces the center 3451 of the first aperture 3411.

Further, for example, the adapter according to the third embodiment described above through FIG. 26C may be specified as an embodiment in which the virtual line connecting the center 3451 of the first aperture 3411 and the center 3453 of the third aperture 3421 is not parallel to the second axis (z-axis), and the center 3453 of the third aperture 3421 has been moved in the −x direction relative to the center 3451 of the first aperture 3411. In this case, the −x direction may be the direction in which the center 3452 of the second aperture 3412 faces the center 3451 of the first aperture 3411.

Further, for example, the adapter according to the third embodiment described above through FIG. 26C may be specified as an embodiment in which the virtual line connecting the center 3452 of the second aperture 3412 and the center 3454 of the fourth aperture 3422 is not parallel to the second axis (z-axis), and the center 3454 of the fourth aperture 3422 has been moved in the +x direction relative to the center 3452 of the second aperture 3412. In this case, the +x direction may be the direction in which the center 3451 of the first aperture 3411 faces the center 3452 of the second aperture 3412.

The preset relationships between the sizes in the first-axis (x-axis) direction of the apertures positioned on the top side of the adapter and the size in the first-axis (x-axis) direction of the apertures positioned on the bottom side have been described above.

Hereinafter, the preset relationships between the size in the third-axis (y-axis) direction of an aperture positioned on the top side of an adapter and the size in the second-axis (y-axis) direction of an aperture positioned on the bottom side are described in more detail.

### [Various Preset Relationships Regarding Sizes in Third-Axis (Y-Axis) Direction of Apertures Positioned on Top and Bottom Sides of Adapter]

FIG. 27 is a diagram illustrating various preset relationships between the sizes in the third-axis (y-axis) direction of apertures positioned on the top side of an adapter and the sizes in the third-axis (y-axis) direction of apertures positioned on the bottom side of the adapter according to an embodiment.

Referring to FIG. 27, an adapter 3600 according to an embodiment includes a bottom side 3610 and a top side 3620, in which the bottom side 3610 of the adapter 3600 comprises a first aperture 3611 and a second aperture 3612, and the top side 3620 of the adapter 3600 comprises a third aperture 3621 and a fourth aperture 3622.

In this case, since the above-described matters may be applied regarding the adapter 3600, the bottom side 3610 of the adapter 3600, the top side 3620 of the adapter 3600, the first aperture 3611, the second aperture 3612, the third aperture 3621, and the fourth aperture 3622, redundant descriptions are omitted.

In this case, the length 3631 of the first aperture 3611 in the third axis (y-axis) direction and the length 3641 of the third aperture 3621 in the third axis (y-axis) direction may satisfy the following Relationship 18.

$$length ( 3641 ) of third aperture ( 3621 ) in first - axis ( x - axis ) direction > length ( 3631 ) of first aperture ( 3611 ) in first - axis ( x - axis ) direction \qquad [ Relationship 18 ]$$

This may be for reducing noise caused by external light such as stray light when the first aperture 3611 positioned on the bottom side 3610 of the adapter 3600 must be designed to correspond to the size of the transmission optical assembly, while the laser output element array and the detecting element array of a LiDAR device are designed to be longer in the first axis (x-axis) direction than in the third axis (y-axis) direction.

Further, in this case, the length 3632 of the second aperture 3612 in the third axis (y-axis) direction and the length 3642 of the fourth aperture 3622 in the third axis (y-axis) direction may satisfy the following Equation 19.

$$length ( 3642 ) of fourth aperture ( 3622 ) in first - axis ( x - axis ) direction > length ( 3632 ) of second aperture ( 3612 ) in first - axis ( x - axis ) direction \qquad [ Relationship 19 ]$$

This may be for reducing noise caused by external light and the like when the second aperture 3612 positioned on the bottom side 3610 of the adapter 3600 must be designed to correspond to the size of the transmission optical assembly, while the laser output element array and the detecting element array of a LiDAR device are designed to be longer in the first axis (x-axis) direction than in the third axis (y-axis) direction.

Of course, Equation 18 and Equation 19 may not be satisfied for the convenience of design.

That is, the length 3641 of the third aperture 3621 in the third axis (y-axis) direction may be equal to or greater than the length 3631 of the first aperture 3611 in the third axis (y-axis) direction, and the length 3642 of the fourth aperture 3622 in the third axis (y-axis) direction may be equal to or greater than the length 3632 of the second aperture 3612 in the third axis (y-axis) direction.

### [Various Designs of Sidewalls Defining Optical Pathway of Adapter]

The design of an adapter for solving problems has been described above.

Hereinafter, various designs of sidewalls of an adapter that satisfy the design of an adapter for solving the above-described problems are described.

In this case, before describing various designs of sidewalls of an adapter, each sidewall of the adapter necessary for description are defined and described first.

FIG. 28 is a diagram illustrating each sidewall of an adapter that is needed to describe various designs of sidewalls of the adapter.

Referring to FIG. 28, an adapter 3700 according to an embodiment includes a first optical pathway 3710, and the first optical pathway 3710 is composed of a first space 3711 surrounded by a first sidewall 3731 and a second sidewall 3732, and a second space 3712 surrounded by a third sidewall 3733 and a fourth sidewall 3734.

In this case, the first space 3711 is a space close to the bottom side of the adapter 3700, and the second space 3712 is a space close to the top side of the adapter 3700.

Further, in this case, the first space 3711 and the second space 3712 may be expressed as a first hole and a second hole.

Further, in this case, the first sidewall 3731 refers to a sidewall that defines the first space 3711 close to the bottom side and is positioned closest to the second optical pathway 3720 among sidewalls defining the first optical pathway 3710, the second sidewall 3732 refers to a sidewall that defines the first space 3711 close to the bottom side and is positioned farthest from the second optical pathway 3720 among the sidewalls defining the first optical pathway 3710, the third sidewall 3733 refers to a sidewall that defines the second space 3712 close to the top side and is positioned closest to the second optical pathway 3720 among the sidewalls defining the first optical pathway 3710, and the fourth sidewall 3734 refers to a sidewall that defines the second space 3712 close to the top side and is positioned farthest from the second optical pathway 3720 among the sidewalls defining the first optical pathway 3710.

However, the meanings of the first to fourth sidewalls 3731 to 3734 are merely defined for the convenience of description, and do not exclude the definitions understood as the first to fourth sidewalls 3731 to 3734 through FIG. 28.

Referring again to FIG. 28, the adapter 3700 according to an embodiment includes a second optical pathway 3720, and the second optical pathway 3720 is composed of a third space 3721 surrounded by a fifth sidewall 3741 and a sixth sidewall 3742, and a fourth space 3722 surrounded by a seventh sidewall 3743 and an eighth sidewall 3744.

In this case, the third space 3721 is a space close to the bottom side of the adapter 3700, and the fourth space 3722 is a space close to the top side of the adapter 3700.

Further, in this case, the third space 3721 and the fourth space 3722 may be expressed as a third hole and a fourth hole.

Further, in this case, the fifth sidewall 3741 refers to a sidewall that defines the third space 3721 close to the bottom side and is positioned closest to the first optical pathway 3710 among sidewalls defining the second optical pathway 3720, the sixth sidewall 3742 refers to a sidewall that defines the third space 3721 close to the bottom side and is positioned farthest from the first optical pathway 3740 among the sidewalls defining the second optical pathway 3720, the seventh sidewall 3743 refers to a sidewall that defines the fourth space 3722 close to the top side and is positioned closest to the first optical pathway 3710 among the sidewalls defining the second optical pathway 3720, and the eighth sidewall 3744 refers to a sidewall that defines the fourth space 3722 close to the top side and is positioned farthest from the first optical pathway 3710 among the sidewalls defining the second optical pathway 3720.

However, the meanings of the fifth to eighth sidewalls 3741 to 3744 are merely defined for the convenience of description, and do not exclude the definitions understood as the fifth to eighth sidewalls 3741 to 3744 through FIG. 28.

Further, since the above-described matters may be applied regarding the adapter 3700, the first optical pathway 3710, and the second optical pathway 3720, redundant descriptions are omitted.

Hereinafter, various designs of sidewalls of an adapter are described using the first to eighth sidewalls 3731 to 3734 and 3741 to 3744 described above.

FIGS. 29 and 30 are diagrams illustrating various designs of sidewalls of an adapter according to an embodiment.

Referring to FIG. 29A, the first to eighth sidewalls 3731 to 3734 and 3741 to 3744 on a cross-section cut along an x-z plane of an adapter according to an embodiment may all be parallel to a second axis (z-axis).

Further, referring to FIG. 29B, the first sidewall 3731 and the second sidewall 3732 on a cross-section cut along an x-z plane of an adapter according to an embodiment may both be parallel to a second axis (z-axis), while the third sidewall 3733 and the fourth sidewall 3734 may not be parallel to each other.

More specifically, the third sidewall 3733 may be parallel to the second axis (z-axis), while the fourth sidewall 3734 may not be parallel to the second axis (z-axis).

That is, in this case, the fourth sidewall 3734 may be formed to have an inclination with respect to the second axis (z-axis).

Further, referring to FIG. 29B, the fifth sidewall 3741 and the sixth sidewall 3742 on the cross-section cut along the x-z plane of the adapter according to an embodiment may both be parallel to the second axis (z-axis), while the seventh sidewall 3743 and the eighth sidewall 3744 may not be parallel to each other.

More specifically, the seventh sidewall 3743 may be parallel to the second axis (z-axis), while the eighth sidewall 3744 may not be parallel to the second axis (z-axis).

That is, in this case, the eighth sidewall 3744 may be formed to have an inclination with respect to the second axis (z-axis).

Further, referring to FIG. 29C, the first sidewall 3731 and the second sidewall 3732 on a cross section cut along an x-z plane of an adapter according to an embodiment may both be parallel to a second axis (z-axis), while the third sidewall 3733 and the fourth sidewall 3734 may both not be parallel to the second axis (z-axis).

That is, in this case, the third sidewall 3733 and the fourth sidewall 3734 may be formed to have an inclination with respect to the second axis (z-axis).

In this case, directions of the inclinations that the third sidewall 3733 and the fourth sidewall 3734 have with respect to the second axis (z-axis) may be different from each other.

Further, referring to FIG. 29C, the fifth sidewall 3741 and the sixth sidewall 3742 on the cross-section cut along the x-z plane of the adapter according to an embodiment may both be parallel to the second axis (z-axis), while the seventh sidewall 3743 and the eighth sidewall 3744 may both not be parallel to the second axis (z-axis).

That is, in this case, the seventh sidewall 3743 and the eighth sidewall 3744 may be formed to have an inclination with respect to the second axis (z-axis).

In this case, directions of the inclinations that the seventh sidewall 3743 and the eighth sidewall 3744 have with respect to the second axis (z-axis) may be different from each other.

Further, referring to FIG. 30A, the first sidewall 3731 and the fifth sidewall 3741 of an adapter according to an embodiment may be formed separately from each other, while the third sidewall 3733 and the seventh sidewall 3743 may be integrally formed with each other.

This may be for reflecting that, as described above, the length of the third aperture of the adapter in the first-axis (x-axis) direction must be longer than the length of the first aperture in the first-axis (x-axis) direction, and the length of the fourth aperture in the first-axis (x-axis) direction must be longer than the length of the second aperture in the first-axis (x-axis) direction.

Further, referring to FIG. 30B, the first sidewall 3731 and the fifth sidewall 3741 of an adapter according to an embodiment may be integrally formed with each other, and the third sidewall 3733 and the seventh sidewall 3743 may be integrally formed with each other.

Further, referring to FIG. 30C, the first sidewall 3731 and the fifth sidewall 3741 of an adapter according to an embodiment may be formed separately from each other, and the third sidewall 3733 and the seventh sidewall 3743 may be formed separately from each other.

In this case, the distance between the third sidewall 3733 and the seventh sidewall 3743 is designed to be smaller than the distance between the first sidewall 3731 and the fifth sidewall 3741.

This may be for reflecting that, as described above, the length of the third aperture of the adapter in the first-axis (x-axis) direction must be longer than the length of the first aperture in the first-axis (x-axis) direction, and the length of the fourth aperture in the first-axis (x-axis) direction must be longer than the length of the second aperture in the first-axis (x-axis) direction.

### [Design of Top Side of Adapter to Adapt to Shape of Optical Window]

Designs and design conditions of an adapter for solving problems occurring when a LiDAR device is located in a space having an optical window on one side have been described in detail above.

However, as described above, industrial fields in which a LiDAR device is used are very diverse, and the shapes of a space in which a LiDAR device is located and the shapes of an optical window are also very diverse.

Therefore, hereinafter, a design of the top side of an adapter for adapting to the shape of an optical window is described in more detail when a LiDAR device is located in a space having an optical window on one side.

According to an embodiment, in a LiDAR device including an adapter, the shape of the top side of the adapter may be determined in consideration of the shape of an optical window of a space in which the LiDAR device including the adapter is located and the relative positional relationship between the optical window and the LiDAR device.

More specifically, in a LiDAR device including an adapter, the shape of the top side of the adapter may be formed to have an inclination or to correspond to a curvature in consideration of the shape of an optical window and the relative positional relationship between the optical window and the LiDAR device.

Several exemplary situations thereof are illustrated in FIG. 31.

FIG. 31 is a diagram illustrating exemplary shapes of the top side of an adapter of a LiDAR device including the adapter according to an embodiment.

FIG. 31A is a diagram illustrating an exemplary shape of a top side 3820 of an adapter 3800 when an optical window 3910 is flat and a LiDAR device is located such that a plane 3830 in which a laser output element array and a detecting element array of the LiDAR device are disposed and the optical window 3910 are parallel.

Referring to FIG. 31A, a bottom side 3810 of the adapter 3800 according to an embodiment is flat, and the top side 3820 of the adapter 3800 is also flat.

In this case, the shape of the top side 3820 of the adapter 3800 is formed to correspond to the optical window 3910.

Further, in this case, since the plane 3830 in which the laser output element array and the detecting element array of the LiDAR device are disposed and the bottom side 3810 of the adapter 3800 are parallel to each other, and the plane 3830 in which the laser output element array and the detecting element array of the LiDAR device are disposed and the optical window 3910 are parallel to each other, so the top side 3820 of the adapter 3800 is parallel to the bottom side 3810 of the adapter 3800.

That is, in this case, the distance from the bottom side 3810 of the adapter 3800 to the top side 3820 of the adapter 3800 may be uniform.

FIG. 31B is a diagram illustrating an exemplary shape of the top side 3820 of the adapter 3800 when an optical window 3920 is flat and a LiDAR device is located such that the optical window 3920 has an inclination with respect to the plane 3830 in which the laser output element array and the detecting element array of a LiDAR device are disposed.

Referring to FIG. 31B, the bottom side 3810 of the adapter 3800 according to an embodiment is flat, and the top side 3820 of the adapter 3800 is also flat.

In this case, the shape of the top side 3820 of the adapter 3800 is formed to correspond to the optical window 3910.

However, since the plane 3830 in which the laser output element array and the detecting element array of the LiDAR device are disposed and the bottom side 3810 of the adapter 3800 are parallel to each other, while the optical window 3910 has an inclination with respect to the plane 3830 in which the laser output element array and the detecting element array of the LiDAR device are disposed, so the top side 3820 of the adapter 3800 has an inclination with respect to the bottom side 3810 of the adapter 3800.

That is, in this case, the distance from the bottom side 3810 of the adapter 3800 to the top side 3820 of the adapter 3800 may not be uniform.

FIG. 31C is a diagram illustrating an exemplary shape of the top side 3820 of the adapter 3800 when an optical window 3930 is provided to have a curvature.

Referring to FIG. 31C, the bottom side 3810 of the adapter 3800 according to an embodiment is flat, and the top side 3820 of the adapter 3800 has a curvature corresponding to the curvature of the optical window 3930.

It has been described above through FIG. 31 that, in a LiDAR device including an adapter, the shape of the top side of the adapter may be formed to have an inclination or to correspond to a curvature in consideration of the shape of an optical window and the relative positional relationship between the optical window and the LiDAR device.

However, since the relationships described through the present specification must be satisfied even in the examples described with reference to FIG. 31 in order to solve problems occurring when a LiDAR device is located in a space having an optical window on one side, the Relationships described through the present specification are also applied to the examples described with reference to FIG. 31.

### V. LiDAR System Applied to Vehicle (LiDAR System Including Plurality of LiDAR Devices Including Adapter)

### [Introduction of LiDAR System]

In the case of an autonomous vehicle, a plurality of LiDAR devices may be disposed at different positions in the autonomous vehicle in order to detect potential risks around the autonomous vehicle.

For example, a LiDAR device may be disposed near a windshield of an autonomous vehicle, LiDAR devices may be respectively disposed in a right headlight and a left headlight, and a LiDAR device may be disposed near a backlight.

As described above, a configuration in which a plurality of LiDAR devices is disposed in one vehicle or the like to constitute one system is described in the present specification as a LiDAR system.

### [Combination of Plurality of LiDAR Devices Included in LiDAR System]

FIG. 32 is a diagram illustrating a LiDAR system according to an embodiment.

Referring to FIG. 32, a LiDAR system 4000 according to an embodiment may comprise a first LiDAR device 4010 disposed near a windshield of an autonomous vehicle, a second LiDAR device 4020 disposed near a left headlight of the autonomous vehicle, a third LiDAR device 4030 disposed near a right headlight of the autonomous vehicle, and a fourth LiDAR device 4040 disposed near a backlight of the autonomous vehicle.

In this case, the LiDAR system 4000 according to an embodiment may be configured by combining a plurality of LiDAR devices each having specifications required at respective positions.

In this case, specifications mean performance indicators of a LiDAR device, such as the field of view of the LiDAR device, the field of view of a laser emission region, the field of view of a light detection region, a maximum measurement distance, a minimum measurement distance, angular resolution, laser output power, a frame rate, and a laser output wavelength.

For example, the LiDAR system 4000 according to an embodiment may be configured such that the first LiDAR device 4010 having first specifications is disposed near a windshield of a vehicle, the second LiDAR device 4020 having second specifications is disposed near a left headlight of the vehicle, the third LiDAR device 4030 having the second specifications is disposed near a right headlight of the vehicle, and the fourth LiDAR device 4040 having third specifications is disposed near a backlight of the vehicle.

### [Design of Adapters of Plurality of LiDAR Devices Included in LiDAR System]

Referring again to FIG. 32, each of a plurality of LiDAR devices included in the LiDAR system 4000 according to an embodiment comprises an adapter.

For example, the first LiDAR device 4010 comprises a first adapter 4011, the second LiDAR device 4020 comprises a second adapter 4021, the third LiDAR device 4030 comprises a third adapter 4031, and the fourth LiDAR device 4040 comprises a fourth adapter 4041.

In this case, the shape of the adapter of each of the plurality of LiDAR devices is designed in consideration of the configuration of each of the plurality of LiDAR devices and the position at which each of the plurality of LiDAR devices is disposed.

In this case, the shape of an adapter includes the size of an aperture, the distance between apertures, an inclination, a size, etc.

More specifically, the shapes of the bottom sides of adapters of LiDAR devices having identical specifications are identical to each other.

For example, the shape of the bottom side of the second adapter 4021 of the second LiDAR device 4020 having the second specifications and the shape of the bottom side of the third adapter 4031 of the third LiDAR device 4030 having the second specifications may be identical to each other.

Further, more specifically, the shapes of the bottom sides of the adapters of LiDAR devices having different specifications are different from each other.

For example, the shapes of the bottom sides of the first adapter 4011 of the first LiDAR device 4010 and the shape of the bottom side of the second adapter 4021 of the second LiDAR device 4020, which have different specifications, are different from each other.

Further, for example, the shapes of the bottom sides of the first adapter 4011 of the first LiDAR device 4010 and the shape of the bottom side of the forth adapter 4041 of the forth LiDAR device 4040, which have different specifications, are different from each other.

Further, more specifically, even though the adapters of LiDAR devices have identical specifications, if the positions at which the LiDAR devices are disposed are different, the shapes of the top sides are different from each other.

For example, the shape of the top side of the second adapter 4021 of the second LiDAR device 4020 disposed near a left headlight and the shape of the top side of the third adapter 4031 of the third LiDAR device 4030 disposed near a right headlight, which have identical specifications, are different from each other.

Further, for example, even if the second specifications and the third specifications are identical to each other, the shapes of the top sides of the second adapter 4021 of the second LiDAR device 4020 disposed near a left headlight, the third adapter 4031 of the third LiDAR device 4030 disposed near a right headlight, and the fourth adapter 4041 of the fourth LiDAR device 4040 disposed near a backlight are different from each other.

Further, more specifically, when LiDAR devices having different specifications are disposed at different positions, the shapes of the top sides of the adapters of the LiDAR devices are different from each other.

For example, the shapes of the top sides of the first adapter 4011 of the first LiDAR device 4010 disposed near a windshield and the second adapter 4021 of the second LiDAR device 4020 disposed near a left headlight, which have different specifications, are different from each other.

The matters described above through FIG. 32 relate to a LiDAR system 4000 according to an embodiment that is applied to an autonomous vehicle, but the technical idea that the shape of the bottom side of each adapter is determined depending on whether the specifications of a plurality of LiDAR devices included in the LiDAR system 4000 according to an embodiment are identical, and the shape of the top side of the adapter is determined depending on the position at which each of the plurality of LiDAR devices is disposed, may be equally applied not only to autonomous vehicles but also to a LiDAR system composed of a plurality of LiDAR devices comprising an adapter.

The method according to an embodiment may be implemented in a program that may be executed by various computers and may be recorded on computer-readable media. The computer-readable media may include program commands, data files, and data structures individually or in combinations thereof. The program commands that are recorded on the media may be those specifically designed and configured for the present invention or may be those available and known to those engaged in computer software in the art. The computer-readable recording media comprise magnetic media such as hard disks, floppy disks, and magnetic media such as a magnetic tape, optical media such as CD-ROMs and DVDs, magneto-optical media such as floptical disks, and hardware devices specifically configured to store and execute program commands, such as ROM, RAM, and flash memory. The program commands comprise not only machine language codes compiled by a compiler, but also high-level language code that may be executed by a computer using an interpreter etc. The hardware device may be configured to operate as one or more software modules to perform the operation of the present invention, and vice versa.

Embodiments were described above with reference to the limited examples and drawings, but they may be changed and modified in various ways by those skilled in the art. For example, the described technologies may be performed in order different from the described method, and/or even if components such as the described system, structure, device, and circuit are combined or associated in different ways from the description or replaced by other components or equivalents, appropriate results may be accomplished.

Therefore, other implements, other embodiments, and equivalents to the claims are included in the following claims.

### MODE FOR INVENTION

As described above, matters related in the best mode for carrying out the prevent disclosure have been described.

What is claimed is:

1. A LiDAR device, comprising:
a laser emitting element array comprising a plurality of laser emitting elements;
a transmission optical assembly configured to steer laser output from the plurality of laser emitting elements;
a detecting element array comprising a plurality of detecting elements;
a reception optical assembly,
wherein the reception optical assembly is configured to focus light incident on the reception optical assembly onto the detecting element array,
wherein the reception optical assembly is positioned to be spaced apart from the transmission optical assembly in a first-axis direction, and
wherein a minimum distance between the reception optical assembly and the transmission optical assembly in the first-axis direction is a first distance; and
an adapter comprising a first optical pathway and a second optical pathway,
wherein a first aperture and a second aperture separated from the first aperture are positioned on a bottom side of the adapter,
wherein a third aperture and a fourth aperture separated from the third aperture are positioned on a top side of the adapter,
wherein the first optical pathway is a pathway from the first aperture to the third aperture,
wherein the second optical pathway is a pathway from the second aperture to the fourth aperture,
wherein the first optical pathway is surrounded by at least one sidewall such that the first optical pathway is separated from the second optical pathway,
wherein the second optical pathway is surrounded by at least one sidewall such that the second optical pathway is separated from the first optical pathway,
wherein the transmission optical assembly is inserted into the first aperture such that the transmission optical assembly is mounted to the adapter,
wherein the transmission optical assembly is inserted into the first aperture such that an optical axis of the transmission optical assembly passes through a center of the first aperture,
wherein the reception optical assembly is inserted into the second aperture such that the reception optical assembly is mounted to the adapter, and
wherein the reception optical assembly is inserted into the second aperture such that an optical axis of the reception optical assembly passes through a center of the second aperture,
a length of the third aperture in the first-axis direction and a length of the first aperture in the first-axis direction satisfy Relationship 1, and
a length of the fourth aperture in the first-axis direction and a length of the second aperture in the first-axis direction satisfy Relationship 2,
$$the length of the first aperture in the first - axis direction < the length of the third aperture in the first - axis direction \leq ( the length of the first aperture in the first - axis direction + the first distance ) , \qquad [ Relationship 1 ]$$
$$the length of the second aperture in the first - axis direction < the length of the fourth aperture in the first - axis direction \leq ( the length of the second aperture in the first - axis direction + the first distance ) . \qquad [ Relationship 2 ]$$

2. The LiDAR device of claim 1,
wherein a direction from the bottom side of the adapter toward the top side of the adapter is defined as a second-axis direction, and
wherein, when a field of view of a laser emission region of the LiDAR device in the first-axis direction is k degrees, a length of the third aperture in the first-axis direction and a length from the bottom side of the adapter to the top side of the adapter in the second-axis direction satisfy Relationship 3,
$$( the length of the third aperture in the first - axis direction ) / ( 2 * ( the length from the bottom side of the adapter to the top side of the adapter in the second - axis direction ) ) > tan ( k degrees / 2 ) . \qquad [ Relationship 3 ]$$

3. The LiDAR device of claim 2,
wherein, when a field of view of a light detection region of the LiDAR device in the first-axis direction is 1 degrees, a length of the fourth aperture in the first-axis direction and a length from the bottom side of the adapter to the top side of the adapter in the second-axis direction satisfy Relationship 4,
$$( the length of the fourth aperture in the first - axis direction ) / ( 2 \times ( the length from the bottom side of the adapter to the top side of the adapter in the second - axis direction ) ) > tan ( 1 degrees / 2 ) . \qquad [ Relationship 4 ]$$

4. The LiDAR device of claim 1,
wherein the first optical pathway comprises a first hole surrounded by a first sidewall and a second hole surrounded by a second sidewall, and
wherein the second optical pathway comprises a third hole surrounded by a third sidewall and a fourth hole surrounded by a fourth sidewall.

5. The LiDAR device of claim 4,
wherein the first hole is positioned closer to the bottom side of the adapter than the second hole,
wherein the second hole is positioned closer to the top side of the adapter than the first hole,
wherein the third hole is positioned closer to the bottom side of the adapter than the fourth hole, and
wherein the fourth hole is positioned closer to the top side of the adapter than the third hole.

6. The LiDAR device of claim 5,
wherein the transmission optical assembly is inserted into the first hole, and
wherein the reception optical assembly is inserted into the third hole.

7. The LiDAR device of claim 5,
wherein the second sidewall forms a first side surface adjacent to the fourth sidewall and a second side surface disposed to be opposite the first side surface,
wherein the first side surface is parallel to an optical axis of the transmission optical assembly, and
wherein the second side surface is not parallel to the optical axis of the transmission optical assembly.

8. The LiDAR device of claim 5,
wherein the first sidewall is physically separated from the third sidewall, and
wherein the second sidewall is integrally formed with the fourth sidewall.

9. A LiDAR device, comprising:
a laser emitting element array comprising a plurality of laser emitting elements;
a transmission optical assembly configured to steer laser output from the plurality of laser emitting elements;
a detecting element array comprising a plurality of detecting elements;
a reception optical assembly,
wherein the reception optical assembly is configured to focus light incident on the reception optical assembly onto the detecting element array,
wherein the reception optical assembly is positioned to be spaced apart from the transmission optical assembly in a first-axis direction, and
wherein a minimum distance between the reception optical assembly and the transmission optical assembly in the first-axis direction is a first distance; and
an adapter comprising a first optical pathway and a second optical pathway,
wherein a first aperture and a second aperture separated from the first aperture are positioned on a bottom side of the adapter,
wherein a third aperture and a fourth aperture separated from the third aperture are positioned on a top side of the adapter,
wherein the first optical pathway is a pathway from the first aperture to the third aperture,
wherein the second optical pathway is a pathway from the second aperture to the fourth aperture,
wherein the first optical pathway is surrounded by at least one sidewall such that the first optical pathway is separated from the second optical pathway,
wherein the second optical pathway is surrounded by at least one sidewall such that the second optical pathway is separated from the first optical pathway,
wherein the transmission optical assembly is inserted into the first aperture such that the transmission optical assembly is mounted to the adapter,
wherein the reception optical assembly is inserted into the second aperture such that the reception optical assembly is mounted to the adapter,
wherein, when a length of the third aperture in the first-axis direction is greater than a sum of a length of the first aperture in the first-axis direction and the first distance, a distance between an optical axis of the transmission optical assembly and a center of the third aperture is greater than a distance between the optical axis of the transmission optical assembly and a center of the first aperture, and
wherein, when a length of the fourth aperture in the first-axis direction is greater than a sum of a length of the second aperture in the first-axis direction and the first distance, a distance between an optical axis of the reception optical assembly and a center of the fourth aperture is greater than a distance between the optical axis of the reception optical assembly and a center of the second aperture.

10. The LiDAR device of claim 9,
wherein a direction from the bottom side of the adapter toward the top side of the adapter is defined as a second-axis direction, and
wherein, when a field of view of a laser emission region of the LiDAR device in the first-axis direction is k degrees, a length of the third aperture in the first-axis direction and a length from the bottom side of the adapter to the top side of the adapter in the second-axis direction satisfy Relationship 1,
$$( the length of the third aperture in the first - axis direction ) / ( 2 * ( the length from the bottom side of the adapter to the top side of the adapter in the second - axis direction ) ) > tan ( k degrees / 2 ) . \qquad [ Relationship 1 ]$$

11. The LiDAR device of claim 10,
wherein, when a field of view of a light detection region of the LiDAR device in the first-axis direction is 1 degrees, a length of the fourth aperture in the first-axis direction and a length from the bottom side of the adapter to the top side of the adapter in the second-axis direction satisfy Relationship 2,
$$( the length of the fourth aperture in the first - axis direction ) / ( 2 \times ( the length from the bottom side of the adapter to the top side of the adapter in the second - axis direction ) ) > tan ( 1 degrees / 2 ) . \qquad [ Relationship 2 ]$$

12. An adapter disposed between a LiDAR device located in a space having an optical window on one side and the optical window,
the adapter comprising:
a bottom side on which a first aperture and a second aperture separated from the first aperture are positioned;
a top side on which a third aperture and a fourth aperture separated from the third aperture are positioned;
a first optical pathway that is a pathway from the first aperture to the third aperture; and
a second optical pathway that is a pathway from the second aperture to the fourth aperture,
wherein the first optical pathway is surrounded by at least one sidewall such that the first optical pathway is separated from the second optical pathway,
wherein the second optical pathway is surrounded by at least one sidewall such that the second optical pathway is separated from the first optical pathway,
wherein the second aperture is spaced apart from the first aperture in a first-axis direction,
wherein a minimum distance between the first aperture and the second aperture in the first-axis direction is a first distance, and
wherein, when a first virtual line passing through a center of the first aperture and a center of the third aperture is parallel to a second virtual line passing through a center of the second aperture and a center of the fourth aperture,
a length of the third aperture in the first-axis direction and a length of the first aperture in the first-axis direction satisfy Relationship 1, and
a length of the fourth aperture in the first-axis direction and a length of the second aperture in the first-axis direction satisfy Relationship 2,
$$the length of the first aperture in the first - axis direction < the length of the third aperture in the first - axis direction \leq ( the length of the first aperture in the first - axis direction + the first distance ) , \qquad [ Relationship 1 ]$$
$$the length of the second aperture in the first - axis direction < the length of the fourth aperture in the first - axis direction \leq ( the length of the second aperture in the first - axis direction + the first distance ) . \qquad [ Relationship 2 ]$$

13. The adapter of claim 12,
wherein a shape of the top side of the adapter corresponds to a shape of the optical window.

14. The adapter of claim 13,
wherein, when the optical window comprises a curvature, a curvature of the top side of the adapter is corresponds to the curvature of the optical window.

15. An adapter disposed between a LiDAR device located in a space having an optical window on one side and the optical window,
the adapter comprising:
a bottom side on which a first aperture and a second aperture separated from the first aperture are positioned;
a top side on which a third aperture and a fourth aperture separated from the third aperture are positioned;
a first optical pathway that is a pathway from the first aperture to the third aperture; and
a second optical pathway that is a pathway from the second aperture to the fourth aperture,
wherein the first optical pathway is surrounded by at least one sidewall such that the first optical pathway is separated from the second optical pathway,
wherein the second optical pathway is surrounded by at least one sidewall such that the second optical pathway is separated from the first optical pathway,
wherein the second aperture is spaced apart from the first aperture in a first-axis direction,
wherein a minimum distance between the first aperture and the second aperture in the first-axis direction is a first distance, and
wherein, when a length of the third aperture in the first-axis direction is greater than a sum of a length of the first aperture in the first-axis direction and the first distance and a length of the fourth aperture in the first-axis direction is greater than a sum of a length of the second aperture in the first-axis direction and the first distance, a distance between a center of the third aperture and a center of the fourth aperture is greater than a distance between a center of the first aperture and a center of the second aperture.

16. The adapter of claim 15,
wherein a shape of the top side of the adapter corresponds to a shape of the optical window.

17. The adapter of claim 16,
wherein, when the optical window comprises a curvature, a curvature of the top side of the adapter corresponds to the curvature of the optical window.
